(19) United States
(12) Patent Application Publication
(10) Pub. No.: US 2011/0065082 A1
(43) Pub. Date: Mar. 17, 2011

(54) Device,system, and method of educational content generation

(76) Inventors: Michael Gal, Herzliya (IL); Michal Hendel, Tzur Moshe (IL)

(21) Appl. No.: 12/923,328

(22) Filed: Sep. 15, 2010

Related U.S. Application Data
(60) Provisional application No. 61/272,365, filed on Sep. 17, 2009.

(51) Int. Cl. G09B 25/00

(52) U.S. Cl. 434/365

(57) ABSTRACT

Device, system, and method of educational content generation. For example, a method of generating digital educational content comprises: (a) creating a digital learning object by: receiving user selection of a template from a repository of templates of digital learning objects, the template representing a composition of one or more digital educational content elements within a screen; receiving user selection of a layout from a repository of layouts of digital learning objects, the layout representing an on-screen arrangement of said one or more educational content elements within said screen; receiving user input of data for said template; receiving user input of parameters for said template; inserting the user input of data into said template; inserting the user input of parameters into said template; receiving user input of meta-data for said template; (b) applying said layout to said template containing therein (i) said user input of data and (ii) said user input of parameters and (iii) said user input of meta-data; (c) storing said digital learning object in a repository of digital learning objects.

### PRIOR APPLICATION DATA

This patent application claims priority and benefit from U.S. Provisional Patent Application No. 61/272,365, titled “Device, System, and Method of Educational Content Generation”, filed on Sep. 17, 2009, which is hereby incorporated by reference in its entirety.

### FIELD

Some embodiments are related to the field of electronic learning.

### BACKGROUND

Many professionals and service providers utilize computers in their everyday work. For example, engineers, programmers, lawyers, accountants, bankers, architects, physicians, and various other professionals spend several hours a day utilizing a computer.

In contrast, many teachers do not utilize computers for everyday teaching. In many schools, teachers use a “chalk and talk” teaching approach, in which the teacher conveys information to students by talking to them and by writing on a blackboard

### SUMMARY

Some embodiments include, for example, devices, systems, and methods of educational content generation

In some embodiments, for example, a method of generating digital educational content comprises: (a) creating a digital learning object by: receiving user selection of a template from a repository of templates of digital learning objects, the template representing a composition of one or more digital educational content elements within a screen; receiving user selection of a layout from a repository of layouts of digital learning objects, the layout representing an on-screen arrangement of said one or more educational content elements within said screen; receiving user input of data for said template; receiving user input of parameters for said template; inserting the user input of data into said template; inserting the user input of parameters into said template; receiving user input of meta-data for said template; (b) applying said layout to said template containing therein (i) said user input of data and (ii) said user input of parameters and (iii) said user input of meta-data; (c) storing said digital learning object in a repository of digital learning objects.

In some embodiments, receiving the user selection of the template comprises: receiving the user selection of the template from a group comprising at least (a) a first template having a single atomic digital educational content element, and (b) a second template having two or more atomic digital educational content elements.

In some embodiments, inserting the user input of data comprises one or more operations selected from the group consisting of: producing instructions for the digital educational content; producing questions for the digital educational content; producing possible answers for the digital educational content; producing written feedback options with regard to correctness or incorrectness of the possible answers, for the digital educational content; producing rubrics for assessment for the digital educational content; producing a hint for solving the digital educational content; producing an example helpful for solving the digital educational content; producing a file helpful for solving the digital educational content; producing a hyperlink helpful for solving the digital educational content; providing a media file associated with the digital educational content; providing an alternative modality for at least a portion of the digital educational content; importing an instance of an under-development digital educational content from an in-work storage unit; importing an instance of a published digital educational content from a storage unit for published content.

In some embodiments, the producing comprises performing an operation selected from the group consisting of: writing; copying; pointing to an item in an assets repository.

In some embodiments, inserting the user input of parameters comprises one or more operations selected from the group consisting of: producing metadata parameters; producing pedagogic metadata parameters; producing guidance parameters; producing interactions parameters; producing feedback parameters; producing advancing parameters; producing a parameter indicating a required student input as condition to advancing; producing scoring parameters; producing one or more rules for behavior of content elements on screen; producing one or more rules indicating a behavior of a first on-screen content element in upon a user's interaction with a second on-screen content element; producing parameters for a managerial component indicating one or more rules of handling a communication between two on-screen content elements.

In some embodiments, receiving the user selection of the layout comprises: receiving the user selection of the layout from a group comprising at least: (a) a first layout in which two or more atomic digital educational content elements are arranged in a first arrangement; and (b) a second layout in which said two or more atomic digital educational content elements are arranged in a second, different, arrangement

In some embodiments, the method comprises: modifying said layout in response to a user drag-and-drop input which moves one or more atomic digital educational content elements within said screen, to create a modified layout; and applying the modified layout to said template.

In some embodiments, the method comprises: modifying said template in response to a user input which adds an atomic digital educational content element into said screen, to create a modified template.

In some embodiments, said user input which adds said atomic digital educational content element into said screen comprises a user selection of a new atomic digital educational content element from a repository of atomic digital educational content elements available for adding into said template.

In some embodiments, the method comprises: modifying said layout in response to a user input which resizes one or more atomic digital educational content elements within said screen, to create a modified layout; and applying the modified layout to said template.

In some embodiments, the method comprises: setting one or more rules indicating an operational effect of a first on-screen content element on a second, different, on-screen content element.

In some embodiments, the method comprises: setting one or more rules indicating an operational effect of a user interaction on one or more content elements.

Some embodiments may include a computerized system for generation of digital educational content, wherein the computerized system implemented using at least one hardware component, wherein the computerized system comprises: a template selection module to select a template for the digital educational content; a layout selection module to select a layout for the digital educational content; an asset selection module to select one or more digital atomic content items from a repository of digital atomic content items; an editor module to edit a script, represented using a learning modeling language, the script indicating behavior of a first on-screen content element in response to one or more of: (a) user interaction; (b) action by a second on-screen content element.

In some embodiments, the computerized system comprises: an asset organizer module to spatially organize one or more of the selected digital atomic content items.

In some embodiments, the asset organizer module is to automatically (a) resize one or more of the selected digital atomic content items based on screen resolutions constraints, and (b) reorder one or more of the selected digital atomic content items based on pedagogical goals reflected in metadata associated with said one or more of the selected digital atomic content items.

In some embodiments, the computerized system comprises: a gradual exposure module to (a) initially expose on screen the first content element, and (b) subsequently expose on screen the second content element, based on a sequencing scheme associated with said first and second content elements.

In some embodiments, the computerized system comprises: a knowledge estimator to determine an educational need of a student, based on one or more of: (a) responses of the student in a pre-administered test; (b) a personal knowledge map which is associated with said student and is updated based on ongoing performance of said student; an automated content builder to automatically create educational content tailored for said student, based on output of the knowledge estimator, by utilizing an automatically-selected template, an automatically-selected layout, educational data and parameters obtained from an assets repository.

In some embodiments, the computerized system comprises: a wizard module (a) to guide a content developer step-by-step through a process of creating educational content, (b) to show to said content developer only selectable options which are relevant in view of pedagogical goals and rules, and (c) to hide from said content developer options which are irrelevant in view of pedagogical goals and rules.

In some embodiments, the pedagogical goals and rules are represented as metadata associated with education content items.

In some embodiments, the computerized system comprises: a flow control editor to define pedagogic rules for determining the behavior of an educational content element upon creation of a digital learning object based on a pedagogical need of a student.

In some embodiments, the computerized system comprises: a tagging module to create pedagogical metadata associated with educational content items; and an asset retrieval module (a) to retrieve content elements from an assets repository; and (b) to place the retrieved content elements in a learning flow based on pedagogical meta-data; wherein the pedagogical metadata (i) indicates relevancy of said retrieved content elements to a pedagogical goal, and (ii) indicates suitability of said retrieved content elements to a pedagogical context.

In some embodiments, the computerized system comprises: a dynamic layout modifier module (a) to determine that a digital learning object was originally intended to be executed on a first screen having a first resolution; (b) to determine that the digital learning object is requested to be executed on a second screen having a second, smaller, resolution; (c) to re-construct the digital learning object by re-organizing educational content elements according to (i) the second resolution and (ii) one or more pedagogical rules for determining interactive behavior of one or more of the educational content elements.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1A is a schematic illustration of a teaching/learning system, in accordance with some demonstrative embodiments.

FIG. 1B is a schematic block diagram illustration of another teaching/learning system in accordance with some demonstrative embodiments.

FIG. 1C is a schematic block diagram illustration of still another teaching/learning system in accordance with some demonstrative embodiments.

FIG. 2 is a schematic block diagram illustration of a teaching/learning data structure in accordance with some demonstrative embodiments.

FIG. 3A is a schematic block diagram illustration of yet another teaching/learning system in accordance with some demonstrative embodiments.

FIG. 3B is a schematic flow-chart of a method of automated or semi-automated content generation, in accordance with some demonstrative embodiments.

FIG. 4 is a schematic illustration of a process for creating a digital Learning Object (LO), in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Some embodiments may include a system for educational Content Generation (CG); for example, a set of CG Tools (CGT) for educational content developers, a set of tools for a user having editing rights (e.g., teachers), a set of tools for content conformation during publishing of imported content, and an automated module for adaptive CG. The system may further include, for example, managerial components to manage the workflow of CG, comprising: “in-work” storage, of “building blocks” (templates, layouts) and assets repositories; rights management for user to access “building blocks”, components and assets; management modules for the user to create, edit and use content elements according to his or her role; and management tools for the “publishing” process, namely, finalizing and exporting the finished educational content elements into a content repository or to the Digital Teaching Platform (e.g., Learning Management System (LMS)).

Some embodiments of the invention include, for example, devices, systems, and methods of adaptive teaching and learning.

Some embodiments include, for example, a teaching/learning system including a real-time class management module to selectively allocate first and second digital learning objects for performance, substantially in parallel, on first and second student stations, respectively.

In some embodiments, the real-time class management module is to select the first and second digital learning objects from a repository of digital learning objects.

In some embodiments, the real-time class management module is to receive from the first student station a signal indicating, substantially in real-time, successful performance of the first digital learning object.

In some embodiments, the real-time class management module is to receive from the first student station a signal indicating, substantially in real-time, incorrect performance of at least a portion of the first digital learning object.

In some embodiments, in response to the signal received from the first student station, the real-time class management module is to automatically allocate a third digital learning object for performance on the first student station.

In some embodiments, the system includes a teacher station associated with the first and second student stations; in response to the signal received from the first student station and further in response to a signal indicating approval received from the teacher station, the real-time class management module is to automatically allocate a third digital learning object for performance on the first student station.

In some embodiments, the real-time class management module is to determine substantially in real-time that at least a portion of the first digital object has been incorrectly performed, and to selectively allocate for performance on the first student station a third learning object including at least the incorrectly performed portion of the first digital learning object.

In some embodiments, at least a portion of the third learning object includes a modified version of at least a portion of the first digital learning object.

In some embodiments, a computing station includes: an interface to present to a student a first set of learning exercises for performance, to identify one or more of the exercises that are incorrectly performed by the student, to determine a common topic of the one or more incorrectly performed exercises, and to selectively present to the student a second set of exercises in the common topic.

In some embodiments, the second set of exercises includes at least one exercise including modified content of an exercise of the first set of exercises.

In some embodiments, prior to presenting the second set of exercises, the interface is to present a digital learning object in the common topic.

In some embodiments, a computing station includes: an interface to present to a student a first set of learning exercises for performance, to identify one or more of the exercises that are correctly performed by the student, to determine a common topic of the one or more correctly performed exercises, and to selectively present to the student a second set of exercises in the common topic.

In some embodiments, the second set of exercises includes at least one exercise including modified content of an exercise of the first set of exercises.

In some embodiments, a difficulty level of the second set of exercises is higher than a difficulty level of the first set of exercises.

In some embodiments, a method of adaptive teaching includes: generating a knowledge map associated with a student, the knowledge map including information reflecting knowledge levels of the student in a plurality of topics; based on the knowledge map, allocating to the student a digital learning activity for performance; and updating the knowledge map based on the performance results of the digital learning activity by the student.

In some embodiments, the digital learning activity relates to one or more topics, and updating the knowledge map includes: updating the knowledge map with information to reflect a level of the student in the one or more topics based on the performance of the student in the digital learning activity.

In some embodiments, the method includes: identifying in the knowledge map a topic in which the knowledge level of the student is below a pre-defined threshold; and allocating to the student a digital learning activity for performance in the identified topic.

In some embodiments, the method includes: identifying in the knowledge map a topic in which the knowledge level of the student is above a pre-defined threshold; and allocating to the student a digital learning activity for performance in the identified topic.

In some embodiments, the digital learning activity includes at least first and second portions, and the method includes: automatically modifying the second portion of the digital learning activity based on performance by the student of the first portion of the digital learning activity.

In some embodiments, a collaborative learning system includes: a plurality of student stations to allow substantially parallel performance of a digital learning activity; a teacher station to receive a first captured snapshot of the digital learning activity from a first student station of the student stations, and to receive a second, different, captured snapshot of the digital learning activity from a second student station of the student stations.

In some embodiments, the teacher station includes an input unit to select one or more captured snapshots from two or more received captured snapshots of the digital learning activity.

In some embodiments, the system includes a display unit to selectively display the selected captured snapshots.

In some embodiments, the system includes a display unit to selectively display scaled-down representations of the selected captured snapshots.

In some embodiments, the teacher station is to generate a snapshot of the digital learning activity, and the display unit is to selectively display the snapshot generated by the teacher station and one or more captured snapshots received from student stations.

In some embodiments, a system includes: a student station to allow a student to perform thereon one or more digital learning objects; and an assessment module to assess, substantially in real-time, a knowledge level of the student based on performance of the one or more digital learning objects on the student station.

In some embodiments, the assessment module is to monitor, substantially in real-time, one or more parameters reflecting results of performance of the one or more digital learning objects by the student, and to report, substantially in real-time, the one or more parameters to a teacher station.

In some embodiments, the assessment module is to dynamically calculate a ratio between a number of exercises performed correctly by the student and a total number of exercises performed by the student.

In some embodiments, the assessment module is to generate an alert substantially in real-time if the assessed knowledge level is below a pre-defined threshold.

In some embodiments, the system includes a teacher station to present the alert substantially in real-time.

In some embodiments, a system for facilitating teaching, learning and assessment includes: a lesson planning module to generate a lesson plan having one or more learning activities intended to be performed in accordance with a planned sequence; a real-time class management module to manage, substantially in real-time, teaching processes performed utilizing a teacher station and learning processes performed utilizing student stations; and an integrated assessment module to perform integrated assessment based on operations performed utilizing the student stations, the assessment integrated into the teaching processes and the learning processes.

In some embodiments, the lesson planning module is to modify the lesson plan based on input entered utilizing the teacher station substantially in real-time.

In some embodiments, the lesson planning module is to remove from the lesson plan a learning activity thereof, based on input entered utilizing the teacher station substantially in real-time.

In some embodiments, the lesson planning module is to replace in the lesson plan a first learning activity thereof with a second learning activity, based on input entered utilizing the teacher station substantially in real-time.

In some embodiments, the system is to divide students utilizing student stations into a plurality of groups based on multi-dimensional criteria.

In some embodiments, the system is to allocate a first learning activity to a first group of the groups, and to allocate a second learning activity to a second group of the groups; and the first and second learning activities to be performed substantially in parallel by the first and second groups, respectively.

In some embodiments, the system is to expose a subsequent learning activity to a student utilizing a student station if a pre-defined percentage of students utilizing student stations successfully completed a previously-exposed learning activity.

In some embodiments, a computing station includes: a lesson planning module to generate a lesson plan representing, in accordance with a pre-defined scripting language, one or more learning activities intended to be performed during a lesson, and a sequence in which the learning activities are intended to be performed.

In some embodiments, the lesson planning module is to perform a modification of the lesson plan based on input entered substantially in real-time during the lesson through a teacher station.

In some embodiments, the modification includes an operation selected from a group consisting of: removal of a learning activity from the lesson plan; replacement of a first learning activity in the lesson plan with a second, different, learning activity; insertion of a learning activity into the lesson plan; modification of the sequence of the learning activities; modification of a sequence of two or more lesson plans of a study unit; temporarily locking a learning activity to be unavailable to student stations; and unlocking a previously-locked learning activity.

In some embodiments, the computing station includes: a speech recognition module to receive an oral input, and to determine that the oral input represents a command to perform the modification.

In some embodiments, the computing station includes: a drag-and-drop interface to receive input representing a command to perform the modification.

In some embodiments, the lesson planning module is to dynamically perform a modification of the lesson plan, in accordance with one or more predefined rules, based on performance of one or more digital learning objects through one or more student stations.

In some embodiments, the modification includes an operation selected from a group consisting of: removal of a learning activity from the lesson plan; replacement of a first learning activity in the lesson plan with a second, different, learning activity; insertion of a learning activity into the lesson plan; modification of the sequence of the learning activities; temporarily locking a learning activity to be unavailable to student stations; and unlocking a previously-locked learning activity.

In some embodiments, a method of evaluating performance of a member of an education system includes: generating a plurality of knowledge maps associated with a plurality of students associated with the member, wherein each knowledge map includes information reflecting knowledge levels of a student in a plurality of topics; and assessing the performance of the member based on an aggregated analysis of the plurality of knowledge maps.

In some embodiments, the method includes: evaluating the performance of a first member of the education system relative to a second member of the education system, based on a comparison between knowledge maps of students associated with the first member and knowledge maps of students associated with the second member.

In some embodiments, the method includes: based on an analysis of operations performed by the member, determining that the member utilizes pre-provided lesson plans more than modified lesson plans or originally-created lesson plans; and evaluating the performance of the member based on an aggregated analysis of a plurality of knowledge maps associated with the member.

In some embodiments, the method includes: based on an analysis of operations performed by the member, determining that the member utilizes modified lesson plans more than pre-provided lesson plans or originally-created lesson plans; and evaluating the performance of the member based on an aggregated analysis of a plurality of knowledge maps associated with the member.

In some embodiments, the method includes: based on an analysis of operations performed by the member, determining that the member utilizes originally-created lesson plans more than pre-provided lesson plans or modified lesson plans; and evaluating the performance of the member based on an aggregated analysis of a plurality of knowledge maps associated with the member.

In some embodiments, a method for assessing knowledge of one or more students includes: generating a knowledge map associated with a student, the knowledge map including information reflecting at least one of: knowledge levels of the student in a plurality of topics; skills of the student; and competencies of the student.

In some embodiments, the method includes: presenting a graphical representation of the knowledge map to distinctively indicate, in accordance with pre-defined presentation rules, topics in which the student is strong and topics in which the student is weak.

In some embodiments, the method includes determining a knowledge gap between: actual knowledge of the student reflected in the knowledge map, and required knowledge in accordance with an education system requirements.

In some embodiments, the method includes: presenting a graphical representation of the knowledge map, the required knowledge, and the knowledge gap.

In some embodiments, a method of generating a techno-pedagogic solution to a pedagogic problem includes: determining an educational topic intended for teaching in a computerized environment; correlating between a set of characteristics of the computerized environment and one or more pedagogic goals; and determining a teaching process that utilizes at least a portion of the computerized environment to meet at least one of the pedagogic goals.

In some embodiments, determining a teaching process includes: determining an optimal teaching process that utilizes at least a portion of the computerized environment to meet a maximum number of pedagogic goals achievable with respect to the pedagogic problem.

In some embodiments, the method includes: generating a digital learning object that represents the optimal teaching process.

Some embodiments include, for example, devices, systems, and methods of automatic assessment of pedagogic parameters.

In some embodiments, for example, a method of computer-assisted assessment includes: creating a pre-defined ontology of pedagogic concepts; creating a log of interactions of a student with one or more learning activities, wherein the learning activities are concept-tagged based on said ontology; creating a pedagogic Bayesian network based on said log of interactions and based on said ontology; and based on said pedagogic Bayesian network, estimating a pedagogic parameter related to said student.

In some embodiments, for example, creating the pedagogic Bayesian network includes: determining a set of one or more observable pedagogic variables based on one or more observable task performance items reflected in the log of interactions.

In some embodiments, for example, creating the pedagogic Bayesian network further includes: determining a set of one or more hidden pedagogic variables related to said one or more observable pedagogic variables.

In some embodiments, for example, the hidden pedagogic variables include one or more pedagogic capabilities that the student is required to have in order to successfully accomplish a particular pedagogic task.

In some embodiments, for example, creating the pedagogic Bayesian network further includes: determining one or more dependencies among the one or more hidden pedagogic variables.

In some embodiments, for example, the method includes: creating a set of one or more conditional distribution functions corresponding to an estimation of the probability of possible values for substantially each one of the hidden pedagogic variables.

In some embodiments, for example, the set of one or more conditional distribution functions has at least three possible values corresponding to a strong value, a medium value, and a weak value; and the sum of the probabilities of the three possible values equals to substantially one.

In some embodiments, for example, the method includes: based on analysis of newly-received observable task performance items reflected in the log of interactions, modifying at least one of the probabilities of the possible values of the set of one or more conditional distribution functions.

In some embodiments, for example, the method includes: determining a weighted pedagogic score corresponding to said set of one or more conditional distribution functions, based on the sum of weights of scores corresponding to said possible values.

In some embodiments, for example, the method includes: generating a report indicating pedagogic progress of at least one of: a student, a group of students, and a class of students.

In some embodiments, for example, the method includes: generating an alert indicating a discrepancy between an expected pedagogic parameter of a student and an assessed pedagogic parameter of said student.

In some embodiments, for example, the pedagogic Bayesian network is further based on a teacher input indicating at least one of: a known strength of said student; and a known weakness of said student.

In some embodiments, for example, creating the pedagogic Bayesian network is included within an algorithm which creates one or more statistically evolving models based on relational concept mapping.

In some embodiments, for example, creating the pedagogic Bayesian network comprises creating a dynamic pedagogic Bayesian network; a plurality of copies of the dynamic pedagogic Bayesian network represent a model of said student at a plurality of interconnected time points; and estimating the pedagogic parameter is based on said dynamic pedagogic Bayesian network.

In some embodiments, for example, creating the pedagogic Bayesian network includes creating a hierarchical pedagogic Bayesian network including at least one dependency across two pedagogic domains.

In some embodiments, for example, one or more priors of the pedagogic Bayesian network are dynamically modified based on an analysis which takes into account: metadata of said student, metadata of said one or more learning activities, and activity log of said student.

In some embodiments, for example, the method includes: verifying the pedagogic Bayesian network by at least one of: utilization of controlled simulated student-related data; and utilization of input from a manual assessment process.

In some embodiments, for example, a system for adaptive learning and teaching includes: a repository to store a pre-defined ontology of pedagogic concepts; and a computer-aided assessment module to create a log of interactions of a student with one or more learning activities, wherein the learning activities are concept-tagged based on said ontology; to create a pedagogic Bayesian network based on said log of interactions and based on said ontology; and based on said pedagogic Bayesian network, to estimate a pedagogic parameter related to said student.

In some embodiments, for example, the computer-aided assessment module is to determine a set of one or more observable pedagogic variables based on one or more observable task performance items reflected in the log of interactions.

In some embodiments, for example, the computer-aided assessment module is to determine a set of one or more hidden pedagogic variables related to said one or more observable pedagogic variables.

In some embodiments, for example, the hidden pedagogic variables include one or more pedagogic capabilities that the student is required to have in order to successfully accomplish a particular pedagogic task.

In some embodiments, for example, the computer-aided assessment module is to determine one or more dependencies among the one or more hidden pedagogic variables.

In some embodiments, for example, the computer-aided assessment module is to create a set of one or more conditional distribution functions corresponding to an estimation of the probability of possible values for substantially each one of the hidden pedagogic variables.

In some embodiments, for example, the set of one or more conditional distribution functions has at least three possible values corresponding to a strong value, a medium value, and a weak value; and the sum of the probabilities of the three possible values equals to substantially one.

In some embodiments, for example, based on analysis of newly-received observable task performance items reflected in the log of interactions, the computer-aided assessment module is to modify at least one of the probabilities of the possible values of the set of one or more conditional distribution functions.

In some embodiments, for example, the computer-aided assessment module is to determine a weighted pedagogic score corresponding to said set of one or more conditional distribution functions, based on the sum of weights of scores corresponding to said possible values.

In some embodiments, for example, the system includes: a report generator to generate a report indicating pedagogic progress of at least one of: a student, a group of students, and a class of students.

In some embodiments, for example, the system includes: an alert generator to generate an alert indicating a discrepancy between an expected pedagogic parameter of a student and an assessed pedagogic parameter of said student.

In some embodiments, for example, the pedagogic Bayesian network is further based on a teacher input indicating at least one of: a known strength of said student; and a known weakness of said student.

In some embodiments, for example, the computer-aided assessment module is to create the pedagogic Bayesian network in conjunction with an algorithm which creates one or more statistically evolving models based on relational concept mapping.

In some embodiments, for example, the computer-aided assessment module is to create a dynamic pedagogic Bayesian network; wherein a plurality of copies of the dynamic pedagogic Bayesian network represent a model of said student at a plurality of interconnected time points; and wherein the computer-aided assessment module is to estimate the pedagogic parameter based on said dynamic pedagogic Bayesian network.

In some embodiments, for example, the computer-aided assessment module is to create a hierarchical pedagogic Bayesian network including at least one dependency across two pedagogic domains.

In some embodiments, for example, the computer-aided assessment module is to dynamically modify one or more priors of the pedagogic Bayesian network based on an analysis which takes into account: metadata of said student, metadata of said one or more learning activities, and activity log of said student.

In some embodiments, for example, the computer-aided assessment module is to verify the pedagogic Bayesian network by at least one of: utilization of controlled simulated student-related data; and utilization of input from a manual assessment process.

Some embodiments include, for example, devices, systems, and methods of adaptive teaching and learning utilizing smart digital learning objects.

In some embodiments, for example, a system for adaptive computerized teaching includes: a computer station to present to a student an interactive digital learning activity based on a structure representing a molecular digital learning object which includes one or more atomic digital learning objects, wherein at least one action within a first of the atomic digital learning objects modifies performance of a second of the atomic digital learning objects.

In some embodiments, for example, a first atomic digital learning object of said molecular digital learning object is to generate an output to be used as an input of a second atomic digital learning object of said molecular digital learning object.

In some embodiments, for example, a first atomic digital learning object of said molecular digital learning object is to generate an output which triggers activation of a second atomic digital learning object of said molecular digital learning object.

In some embodiments, for example, the molecular digital learning object includes a managerial component to handle one or more communications among two or more atomic digital learning objects of said molecular digital learning object.

In some embodiments, for example, the molecular digital learning object is a high-level molecular digital learning object including two or more molecular digital learning objects.

In some embodiments, for example, the system further includes: a computer-aided assessment module to dynamically assess one or more pedagogic parameters of said student, based on one or more logged interactions of said student via said computer station with one or more digital learning objects; and an educational content generation module to automatically generate the structure representing said molecular digital learning object, based on an output of said computer-aided assessment module.

In some embodiments, for example, the educational content generation module is to select, based on the output of said computer-aided assessment module, a digital learning object template, a digital learning object layout, and a learning design script; to create said molecular digital learning object from one or more atomic digital learning objects stored in a repository of educational content items; and to insert digital educational content into said molecular digital learning object.

In some embodiments, for example, the educational content generation module is to activate said molecular digital learning object in a correction cycle performed on said computer station associated with said student.

In some embodiments, for example, the educational content generation module is to automatically insert digital educational content into said molecular digital learning object based on estimated contribution of the inserted digital educational content to topic-related knowledge of said student.

In some embodiments, for example, the educational content generation module is to select said digital educational content based on tagging of atomic digital learning objects with tags of a concept-based ontology.

In some embodiments, for example, the educational content generation module is to select, based on concept-based ontology tags: a digital learning object template, a digital learning object layout, and a learning design script; to generate said molecular digital learning object; and to insert digital educational content into said molecular digital learning object based on estimated contribution of the inserted digital educational content to development of at least one of: a skill of said student, and a competency of said student.

In some embodiments, for example, an apparatus for adaptive computerized teaching includes: a live text module including a multi-layer presenter associated with a text layer and an index layer, wherein the index layer includes an index of said text layer, wherein the multi-layer presenter is further associated with one or more information layers associated with said text, wherein the multi-layer presenter is to selectively present at least a portion of said text layer based on said index layer and based on one or more parameters corresponding to said one or more information layers.

In some embodiments, for example, the live text module includes an atomic digital learning object, and wherein said atomic digital learning object and at least one more atomic digital learning object are included in a molecular digital learning object.

In some embodiments, for example, said atomic digital learning object is able to communicate with said at least one more atomic digital learning object.

In some embodiments, for example, said atomic digital learning object is to be managed by a managerial component of said molecular digital learning object.

In some embodiments, for example, said atomic digital learning object is tagged with one or more tags of a concept-based ontology, and said atomic digital learning object is inserted into said molecular digital learning object based on at least one of said tags.

In some embodiments, for example, the apparatus includes: a text engine to selectively present, using an emphasizing style, a portion of said text layer corresponding to a textual characteristic.

In some embodiments, for example, the apparatus includes: a linguistic navigator to present one or more cascading menus including selectable menu items, wherein at least one of the menu items corresponds to a linguistic phenomena.

In some embodiments, for example, the linguistic navigator is to present a menu including at least one of: a command to emphasize all words in said text layer which meet a selectable linguistic property; a command to emphasize all terms in said text layer which meet a selectable linguistic property; a command to emphasize all sentences in said text layer which meet a selectable linguistic property; a command to emphasize all paragraphs in said text layer which meet a selectable linguistic property; a command to emphasize all text-portions in said text layer which meet a selectable grammar-related property; and a command to emphasize all text-portions in said text layer which meet a selectable vocabulary-related property.

In some embodiments, for example, the linguistic navigator is to present a menu including at least one of: a command to emphasize verbs in said text layer, a command to emphasize nouns in said text layer, a command to emphasize adverbs in said text layer, a command to emphasize adjectives in said text layer, a command to emphasize questions in said text layer, a command to emphasize thoughts in said text layer, a command to emphasize feelings in said text layer, a command to emphasize actions in said text layer, a command to emphasize past-time portions in said text layer, a command to emphasize present-time portions in said text layer, and a command to emphasize future-time portions in said text layer.

In some embodiments, for example, the apparatus includes an interaction generator to generate an interaction between a student utilizing a student station and said text layer.

In some embodiments, for example, the interaction includes an interaction selected from the group consisting of: ordering of text portions, dragging and dropping of text portions, matching among text portions, moving a text portion into a type-in field, and moving into said text layer a text portion external to said text layer.

In some embodiments, for example, a method of adaptive computerized teaching includes: presenting to a student an interactive digital learning activity based on a structure representing a molecular digital learning object which includes one or more atomic digital learning objects, wherein an at least one action within a first of the atomic digital learning objects modifies performance of a second of the atomic digital learning objects.

In some embodiments, for example, a first atomic digital learning object of said molecular digital learning object is to generate an output to be used as an input of a second atomic digital learning object of said molecular digital learning object.

In some embodiments, for example, a first atomic digital learning object of said molecular digital learning object is to generate an output which triggers activation of a second atomic digital learning object of said molecular digital learning object.

In some embodiments, for example, the method includes: operating a managerial component of the molecular digital learning object to handle one or more communications among two or more atomic digital learning objects of said molecular digital learning object.

In some embodiments, for example, the molecular digital learning object is a high-level molecular digital learning object including two or more molecular digital learning objects.

In some embodiments, for example, the method includes: dynamically assessing one or more pedagogic parameters of said student, based on one or more logged interactions of said student via said computer station with one or more digital learning objects; and automatically generating the structure representing said molecular digital learning object, based on an output of said computer-aided assessment module.

In some embodiments, for example, the method includes: based on the results of the assessing, selecting a digital learning object template, a digital learning object layout, and a learning design script; creating said molecular digital learning object from one or more atomic digital learning objects stored in a repository of educational content items; and inserting digital educational content into said molecular digital learning object.

In some embodiments, for example, the method includes: activating said molecular digital learning object in a correction cycle performed on said computer station associated with said student.

In some embodiments, for example, the method includes: automatically inserting digital educational content into said molecular digital learning object based on estimated contribution of the inserted digital educational content to topic-related knowledge of said student.

In some embodiments, for example, the method includes: selecting said digital educational content based on tagging of atomic digital learning objects with tags of a concept-based ontology.

In some embodiments, for example, the method includes: based on concept-based ontology tags, selecting: a digital learning object template, a digital learning object layout, and a learning design script; generating said molecular digital learning object; and inserting digital educational content into said molecular digital learning object based on estimated contribution of the inserted digital educational content to development of at least one of: a skill of said student, and a competency of said student.

Some embodiments include, for example, devices, systems, and methods of knowledge acquisition.

In some embodiments, for example, a system for computerized knowledge acquisition includes: a knowledge level testing module to present to a student a first set of questions in a modality at one or more difficulty levels, to receive from the student answers to said first set of questions, and to update a knowledge map of said student based on said answers; a guided knowledge acquisition module to present to the student a second set of questions in said modality, wherein the second set of questions corresponds to educational items for which it is determined that the student's performance in the first set of questions is below a threshold value; and a recycler module to present to the student an interactive game and a third set of questions in said modality, wherein the third set of questions corresponds to educational items for which it is determined that the student's performance in the first set of questions is equal to or greater than said pre-defined threshold.

In some embodiments, for example, the modality includes a version of a digital learning activity adapted to accommodate a difficulty level appropriate to said student, and further adapted to accommodate at least one of: a learning preference associated with said student, and a weakness of said student.

In some embodiments, for example, the modality includes a version of the digital learning activity adapted by at least one of: addition of a feature of said digital learning activity; removal of a feature of said digital learning activity; modification of a feature of said digital learning activity; modification of a time limit associated with said digital learning activity; addition of audio narration; addition of a calculator tool; addition of a dictionary tool; addition of a on-mouse-over hovering bubble; addition of one or more hints; addition of a word-bank; and addition of subtitles.

In some embodiments, for example, the knowledge level test module is to perform, for each modality from a list of modalities associated with a learning subject, a first sub-test for a first difficulty level of said modality; and if the student's performance in said sub-test is equal to or greater than said threshold level, the knowledge level test module is to perform a second sub-test for a second, different, difficulty level of said modality.

In some embodiments, for example, the knowledge level test module is to modify status of at least one of the first set of questions into a value representing one of: pass, fail, skip, and untested.

In some embodiments, for example, the knowledge level test module is to dynamically generate said first set of questions based on: a discipline parameter (or a subject area parameter), a study unit parameter, a threshold parameter indicating a threshold value for advancement to an advanced difficulty level; and a batch size parameter indicating a maximum batch size for each level of difficulty.

In some embodiments, for example, the knowledge level test module is to dynamically generate the first set of questions further based on a parameter indicating whether to check the threshold value per set of questions or per modality.

In some embodiments, for example, the knowledge level test module is to dynamically generate the first set of questions further based on a level dependency parameter indicating whether or not to check the student's success in a previous difficulty level.

In some embodiments, for example, the knowledge level test module is to dynamically generate the first set of questions further based on data from a student profile indicating, for at least one discipline, at least one of: a pedagogic strength of the student, and a pedagogic weakness of the student.

In some embodiments, for example, the guided knowledge acquisition module is to check, for each difficulty level in a plurality of difficulty levels associated with said modality, whether or not the student's performance in said modality at said difficulty level is smaller than said threshold value; and if the check result is negative, to advance the student to a subsequent, increased, difficulty level for said modality.

In some embodiments, for example, the guided knowledge acquisition module is to advance the student from a first modality to a second modality according to an ordered list of modalities for said student in a pedagogic discipline.

In some embodiments, for example, the guided knowledge acquisition module is to present to the student a selectable option to receive a hint for at least one question of said second set of questions, based on a value of a parameter indicating whether or not to present hints to said student in said second set of questions.

In some embodiments, for example, the guided knowledge acquisition module is to present to the student a question in said second set of question, the question including two or more numerical values generated pseudo-randomly based on number of digits criteria.

In some embodiments, for example, the guided knowledge acquisition module is to present to the student two consecutive trials to correctly answer a question in said second set of questions, prior to presenting to the student a correct answer to said question.

In some embodiments, for example, the interactive game presented by the recycler module includes a game selected from the group consisting of: a memory game, a matching game, a spelling game, a puzzle game, and an assembly game.

In some embodiments, for example, the interactive game presented by the recycler module includes a combined list of vocabulary words, which is created by the recycler module based on: a first list of vocabulary words that the student mastered in a first time period ending at the creation of the combined list of vocabulary words, and a second list of vocabulary words that the student mastered in a second time period ending prior to the beginning of the first time period.

In some embodiments, for example, the recycler module is to create said combined list of vocabulary words based on: the first list of vocabulary words sorted based on respective recycling counters, and the second list of vocabulary words sorted based on respective recycling counters.

In some embodiments, for example, approximately half of vocabulary words in the combined list are included in the first list, and wherein approximately half of vocabulary words in the combined list are included in the second list.

In some embodiments, for example, a method of computerized knowledge acquisition includes: presenting to a student a first set of questions in a modality at one or more difficulty levels; receiving from the student answers to said first set of questions; updating a knowledge map of said student based on said answers; presenting to the student a second set of questions in said modality, wherein the second set of questions corresponds to educational items for which it is determined that the student's performance in the first set of questions is below a threshold value; presenting to the student an interactive game and a third set of questions in said modality, wherein the third set of questions corresponds to educational items for which it is determined that the student's performance in the first set of questions is equal to or greater than said pre-defined threshold.

In some embodiments, for example, the modality includes a version of a digital learning activity adapted to accommodate a difficulty level appropriate to said student, and further adapted to accommodate at least one of: a learning preference associated with said student, and a weakness of said student.

In some embodiments, for example, the modality includes a version of the digital learning activity adapted by at least one of: addition of a feature of said digital learning activity; removal of a feature of said digital learning activity; modification of a feature of said digital learning activity; modification of a time limit associated with said digital learning activity; addition of audio narration; addition of a calculator tool; addition of a dictionary tool; addition of a on-mouse-over hovering bubble; addition of one or more hints; addition of a word-bank; and addition of subtitles.

In some embodiments, for example, the method includes: performing, for each modality from a list of modalities associated with a learning subject, a first sub-test for a first difficulty level of said modality; and if the student's performance in said sub-test is equal to or greater than said threshold level, performing a second sub-test for a second, different, difficulty level of said modality.

In some embodiments, for example, the method includes: modifying status of at least one of the first set of questions into a value representing one of: pass, fail, skip, and untested.

In some embodiments, for example, the method includes: dynamically generating said first set of questions based on: a discipline parameter, a study unit parameter, a threshold parameter indicating a threshold value for advancement to an advanced difficulty level; and a batch size parameter indicating a maximum batch size for each level of difficulty.

In some embodiments, for example, the method includes: dynamically generating the first set of questions further based on a parameter indicating whether to check the threshold value per set of questions or per modality.

In some embodiments, for example, the method includes: dynamically generating the first set of questions further based on a level dependency parameter indicating whether or not to check the student's success in a previous difficulty level.

In some embodiments, for example, the method includes: dynamically generating the first set of questions further based on data from a student profile indicating, for at least one discipline, at least one of: a pedagogic strength of the student, and a pedagogic weakness of the student.

In some embodiments, for example, the method includes: for each difficulty level in a plurality of difficulty levels associated with said modality, checking whether or not the student's performance in said modality at said difficulty level is smaller than said threshold value; and if the checking result is negative, advancing the student to a subsequent, increased, difficulty level for said modality.

In some embodiments, for example, the method includes: advancing the student from a first modality to a second modality according to an ordered list of modalities for said student in a pedagogic discipline.

In some embodiments, for example, the method includes: presenting to the student a selectable option to receive a hint for at least one question of said second set of questions, based on a value of a parameter indicating whether or not to present hints to said student in said second set of questions.

In some embodiments, for example, the method includes: presenting to the student a question in said second set of question, the question including two or more numerical values generated pseudo-randomly based on number of digits criteria.

In some embodiments, for example, the method includes: presenting to the student two consecutive trials to correctly answer a question in said second set of questions, prior to presenting to the student a correct answer to said question.

In some embodiments, for example, the interactive game includes a game selected from the group consisting of: a memory game, a matching game, a spelling game, a puzzle game, and an assembly game.

In some embodiments, for example, the interactive game includes a combined list of vocabulary words, which is created based on: a first list of vocabulary words that the student mastered in a first time period ending at the creation of the combined list of vocabulary words, and a second list of vocabulary words that the student mastered in a second time period ending prior to the beginning of the first time period.

In some embodiments, for example, the method includes: creating said combined list of vocabulary words based on: the first list of vocabulary words sorted based on respective recycling counters, and the second list of vocabulary words sorted based on respective recycling counters.

In some embodiments, for example, approximately half of vocabulary words in the combined list are included in the first list, and wherein approximately half of vocabulary words in the combined list are included in the second list.

The term “student” as used herein includes, for example, a pupil, a minor student, an adult student, a scholar, a minor, an adult, a person that attends school on a regular or non-regular basis, a learner, a person acting in a learning role, a learning person, a person that performs learning activities in-class or out-of-class or remotely, a person that receives information or knowledge from a teacher, or the like.

The term “class” as used herein includes, for example, a group of students which may be in a classroom or may not be in the same classroom; a group of students which may be associated with a teaching activity or a learning activity; a group of students which may be spatially separated, over one or more geographical locations; a group of students which may be in-class or out-of-class; a group of students which may include student(s) in class, student(s) learning from their homes, student(s) learning from remote locations (e.g., a remote computing station, a library, a portable computer), or the like.

Some embodiments utilize Information and Computer Technology (ICT) to significantly enhance academic achievements of students in schools. A modified learning culture, a modified learning environment and a comprehensive approach are used, in association with features of Computer-Based Learning (CBL), to provide a holistic approach to teaching and learning. For example, research and experience in CBL contribute to understanding of the value, the importance and/or the need to utilize ICT in learning; the penetration of ICT into various aspects of life, specifically of young people, contributes to readiness for change and implementation of adaptive learning; evolving technologies contribute to availability of ICT, e.g., at affordable prices; realization of un-fitness of conventional education methods contributes to understanding of the importance of using new educational methods; and cultural changes, whereas social changes and economic changes (e.g., globalization, information society) present new requirements from school graduates. Accordingly, some embodiments harness the power of ICT to the educational arena, to provide C-Learning (namely, Comprehensive Learning, Collaborative Learning, and/or In-Class Learning).

Some embodiments, provide meaningful learning, for example, by utilizing learning objects and learning activities that are interactive, thereby encouraging the student to be actively involved in the learning process; attractive, thereby making the learning process a desired process from the student point-of-view; constructive, assisting knowledge building; adaptive, addressing personal needs of individual students; and relevant to the student's world. The individual learning is supported and assisted by an adaptive teaching/learning system, which selectively allocates and assigns various digital learning objects to students based on their individual skills, needs and past performance.

Some embodiments are adapted to accommodate to a new graduate profile, according to which a graduate is an active learner; an autonomous learner; able to continuously adapt to frequent changes; able to evaluate and criticize information and data; able to evaluate choices an choose among alternatives; able to set goals and determine priorities; able to learn by himself; able to cooperate and collaborate with colleagues; able to properly and wisely utilize the technical tools of the ICT environment; able to assess his own progress and performance; able to dynamically choose a learning strategy, and/or to dynamically initiate such learning strategy, according to needs at a particular situation.

Some embodiments are adapted to accommodate to changes in teachers' competencies, which include: guidance skills; knowledge building skills; ability to build skills and competencies of students; ICT literacy; ability to adapt the teaching process to learning needs; ability to select items (e.g., digital learning objects) from a repository, to create digital learning objects, to compose learning activities from learning objects, and to allocate learning activities or learning objects to students, to groups of students, or to a class; and ability to properly and wisely utilize the technical tools of the ICT environment. In some embodiments, for example, the teacher is able to “guide on the side” instead of “sage on the stage”.

Some embodiments provide a solution specifically tailored, designed and developed for schools (e.g., elementary schools) and school teachers, e.g., in contrast with solutions designed and developed for academic needs and users, or for corporate or business needs or users. Accordingly, some embodiments place the school and/or the teacher in the center of the educational system.

Some embodiments create relation and correlation between ICT advantages and the pedagogic goals set for knowledge, skills, and competencies in the curriculum. Some embodiments provide a comprehensive solution that takes into account substantially all the parties to education and all aspects associated with education, namely, teachers, students, parents, computers, curriculum, assessment, educational content, or the like. Accordingly, some embodiments provide a techno-pedagogy solution that allows a teacher to easily and/or efficiently teach in a classroom populated with students equipped with computers (e.g., desktop computers, laptop computers, portable computers, workstations, student terminals, or the like). Some embodiments thus include methodology and tools to provide the advantages of ICT to the pedagogic science, thereby allowing the teacher to perform his job (namely, to teach) at his work-space (namely, the classroom, and/or from home or other places from which the teacher can remotely connect to the teaching/learning system) utilizing the benefits of ICT.

Some embodiments provide a full comprehensive educational solution, which positions the teacher in the focus. Diversity, flexibility and modularity are taken into account, such that the teaching/learning system accommodates a variety of pedagogical approaches or teachers, teaching styles of teachers, ICT competencies of teachers, competencies of students, learning styles of students, and special needs of students. The teacher guides the process of knowledge building by the students; the teacher can choose to be a source of knowledge, and/or a coach for knowledge building.

Curriculum, goals and standards set by official agencies (e.g., Ministry of Education or Board of Education) may be utilized, may be adhered to, and may be a recommendation or a requirement for tagging of educational content elements; needs and priorities specific by users may be addressed; and a variety of pedagogic approaches may be used or supported. Some embodiments utilize an ICT system which is web-based, open, scalable, re-usable (e.g., utilizing Semantic Web principles, utilizing educational library services, or the like), and/or compliant with standards (e.g., international standards, learning outcome standards, or the like). In some embodiments, the teaching/learning system is implemented using open and/or scalable software platform or infrastructure. In some embodiments, educational content used by the teaching/learning system may be open for modification and/or expansion by users, e.g., further development or generation of educational content by the educational community.

In some embodiments, the teaching/learning system may be used by substantially all teachers in a school or in an education system, in contrast with sporadic use of computers by few pioneering teachers. For example, the teaching/learning system may be implemented as a user-friendly system which may be relatively easy to master and operate, including by teachers that are not ICT literate.

In some embodiments, the teaching/learning system allows personal, personalized, adaptive and/or differential learning, instead of uniform and/or average learning. In some embodiments, the teaching/learning system provides full-curriculum high-quality rich digital content, instead of low-quality and/or coincidental digital content.

In some embodiments, the teaching/learning system offers to teachers an initial selection of high-quality rich digital content, and allows expansion of the educational content by users and/or by third-party content providers.

In some embodiments, the teaching/learning system allows integrated assessment, ongoing assessment, continuous assessment, real-time assessment, alternative assessment, and/or assessment substantially un-noticeable by students, instead of occasional and/or solitary assessment events. For example, “in the classroom” integrated teaching, learning and assessment processes are used, and assessment may be integrated in substantially all learning activities. Alternative assessment includes one or more types of assessment in which students create a response to a question or task; for example, in contrast to traditional assessments, in which students select a response from a pre-provided group or list (e.g., multiple-choice questions, true/false questions, matching between items, or the like).

In some embodiments, the teaching/learning system allows students and teachers to be exposed to computers and/or utilize computers substantially anywhere and anytime, instead of a limited access to computers and/or limited utilization of computers in school by teachers and/or students.

In some embodiments, the teaching/learning system supports a comprehensive educational curriculum, instead of a partial curriculum, a sporadic portion of the curriculum, or only supplementary resources.

In some embodiments, the teaching/learning system allows classroom management by a teacher in substantially real time, for example, flow of learning activities; student/groups management; allocation of assignments; or the like.

In some embodiments, the teaching/learning system may require an initial one-time investment (e.g., an initial teachers preparation and ongoing, optional, update sessions), instead of numerous disjointed sessions of teachers preparation; for example, an intuitive approach allows teachers to rapidly understand and utilize the system, thereby attracting even teachers that are hesitant or relatively slow to adapt to new systems.

In some embodiments, the teaching/learning system allows teachers to save time and efforts, for example, in planning or preparing lessons (e.g., by utilizing lessons templates, pre-prepared lessons plans models for teaching scenarios, or the like), in creating tests or assessment tasks, in checking or marking or grading tests or assessment tasks, or the like. The teaching/learning system allows teaching and learning to become positive and enjoyable experiences.

In some embodiments, the teaching/learning system is used in conjunction with conservative teaching styles (e.g., blended teaching, or blending learning), in class and/or out of class. For example, in some embodiments, approximately 50 percent, or up to 50 percent, of the teaching/learning in the classroom are ICT-based activities, and the rest are conservative teaching/learning activities.

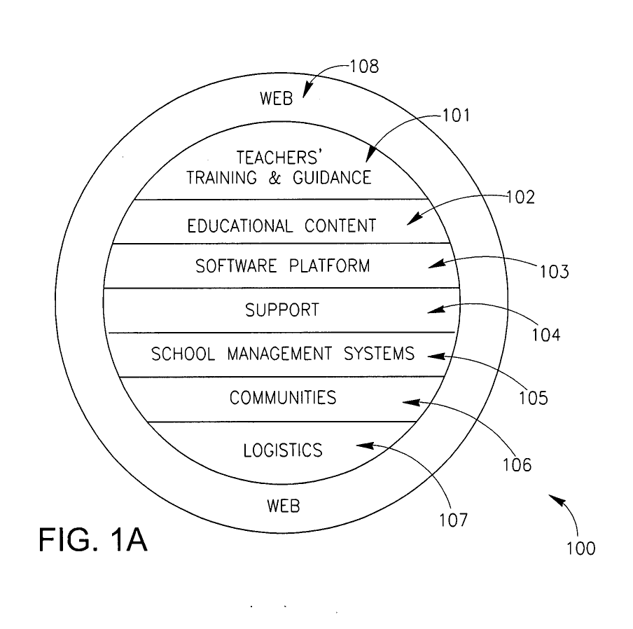

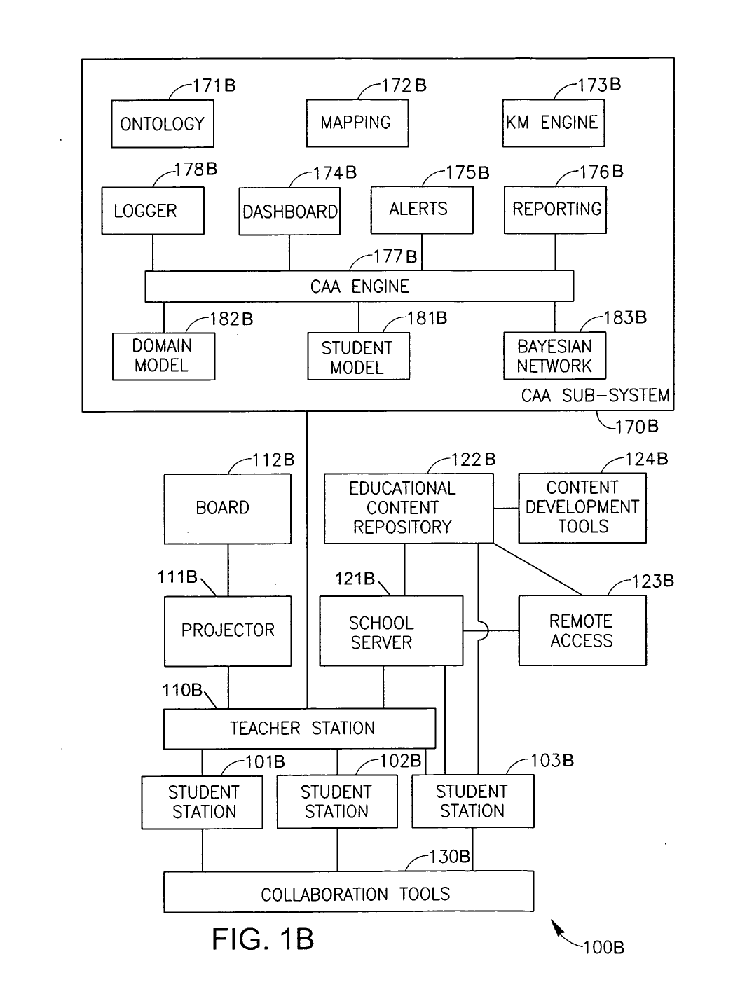

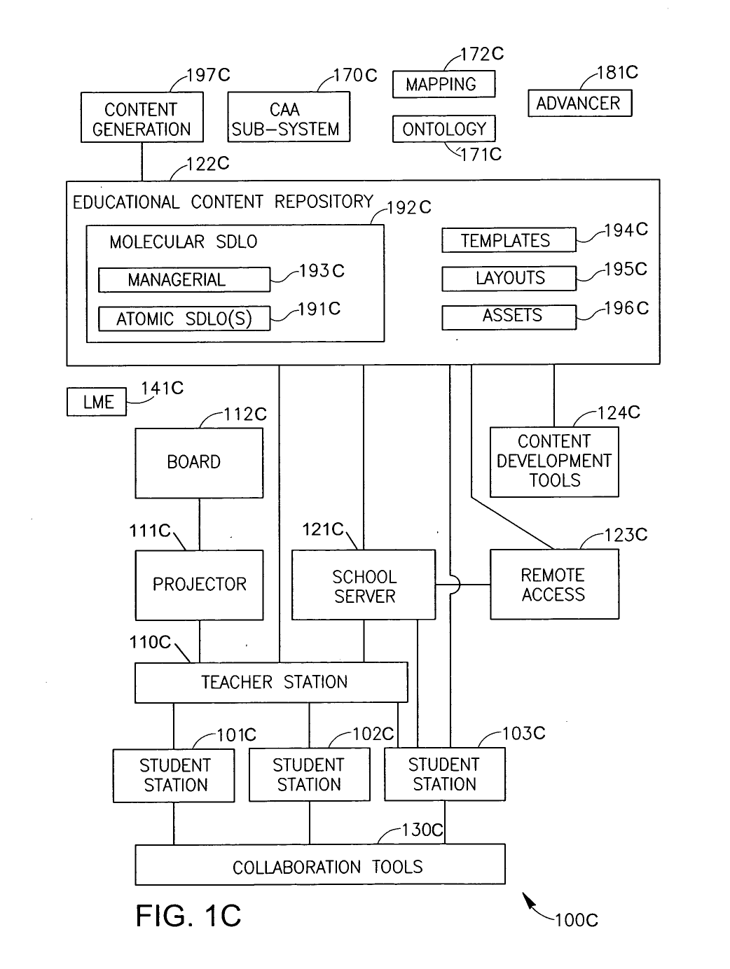

Reference is made to FIG. 1A, which is a schematic block diagram illustration of a teaching/learning system 100 in accordance with some demonstrative embodiments. System 100 may include one or more components, modules or layers, which may be implemented using software and/or hardware, optionally across multiple locations or using multiple devices or units.

A teachers' training and guidance module 101 is operable to train and guide teachers in utilizing the system 100, for example, using online help, a help-desk, seminars, workshops, tutorials, or the like.

An educational content module 102 includes digital content corresponding to partial or substantially complete curriculum. The educational content module 102 allows differential teaching/learning, for example, such that system 100 selectively presents a first educational content to a first student or group of students, and a second educational content to a second student or group of student. The differential teaching/learning is based, for example, on the progress or the relative progress of a student or a group of student, on the level or the relative level of a student or a group of student, on prior or ongoing assessments, or on other criteria. The differential teaching/learning addresses personal needs and/or personal abilities of a student or a group of students, allowing student self-pace learning while the teacher guides and monitors the activities and progress of students and/or groups of students.

In some embodiments, the differential teaching/learning may allow substantially each student (or group of students) to advance in his studies according to his specific needs, abilities, skills, knowledge, and preferred learning style. For example, different students in the same class may be assigned or allocated different learning objects or learning activities (e.g., substantially in parallel or in an overlapping time period), to accommodate the specific needs of various students. Additionally or alternatively, within the flow of a learning object, personalized feedback or support may be provided to the student, taking into account the specific needs or skills of the student, his prior performance and answers, his specific strengths and weaknesses, his progress and decisions, or the like. In some embodiments, portions of the content of educational learning objects may be automatically modified, removed or added, based on characteristics of the student utilizing the learning object, thereby providing to each student a learning object accommodating the student's characteristic and record of progress.

The differential teaching/learning may include differential support within a learning object or a learning activity. For example, system 100 may provide a first type or level of support (e.g., having more details) to a first type of students (e.g., students identified to have a difficulty in a certain topic), and may provide a second, different, type or level of support (e.g., having less details) to a second type of students (e.g., students identified to be proficient in a certain topic).

The differential teaching/learning may include differential, automated modification of educational content, within a learning object or a learning activity. For example, a learning object may present additional explanations to a student identified to have a difficulty in a particular topic, and may present less information (or may skip some explanations) with regard to a student identified to be proficient in that topic.

The differential teaching/learning may include differential learning activities, such that different students engage in different learning activities substantially in parallel, or in an overlapping time period. This may be achieved, for example, by efficiently utilizing a repository storing learning objects associated with various levels of difficulty, various time frames, various levels of complexity, or the like. The system may allow tagging of digital learning objects, in a way that identifies their potential roll in the learning process and correlation with relevant Standards and learning outcome requirements, thereby allowing efficient and smart selection for specific needs.

The differential teaching/learning may include differential assistance and differential fulfillment of special needs of students. For example, an audio narration or an audio/video tutorial may accompany a learning object when used by a first student who has difficulty in the relevant subject matter, whereas such narration or tutorial may be skipped or omitted when the learning object is used by a second student who is proficient in that subject matter.

The educational content module 102 allows adaptive teaching/learning, for example, such that system 100 modifies or re-constructs content presented to a student (or a group of students) based on identified weaknesses of that student or group, based on identified strengths of that student or group, based on a determined knowledge map of that student or group, or based on other criteria.

A software platform 103 allows planning, management and integration of teaching, learning and assessment and the related activities and content. A support module 104 (e.g., in-school support or remote support) provides support to one or more modules of system 100, for example, operational support, pedagogical support, and technical support: School management systems 105 include interface(s) between system 100 or components thereof and other school systems, for example, an attendance system, a grading system, a financial system, or the like. A communities module 106 allows publishing (e.g., bulletin boards, “blogs”, web-casting, “pod-casting”, or the like) and communications (e.g., electronic mails, instant messaging, chat, forums, or the like) among teachers, students, parents, administrative personnel, business entities associated with system 100 (e.g., providers or vendors of educational content), volunteers, or the like. A logistics module 107 includes school infrastructure utilized for implementing one or more components or functions of system 100, for example, hardware, software, maintenance services, or the like.

In some embodiments, optionally, system 100 may be implemented using a web 108, such that one or more (or substantially all) functions of teaching/learning are available through a web (e.g., the World Wide Web, the Internet, a global communication network, a Local Area Network (LAN), a Wide Area Network (WAN), an intranet, an extranet, or the like), optionally utilizing web services or web components (e.g., web browsers, plug-ins, web applets, or the like). In other embodiments, optionally, system 100 may be implemented as a non-web solution, for example, as a local or non-open system, as a stand-alone executable system, or the like.

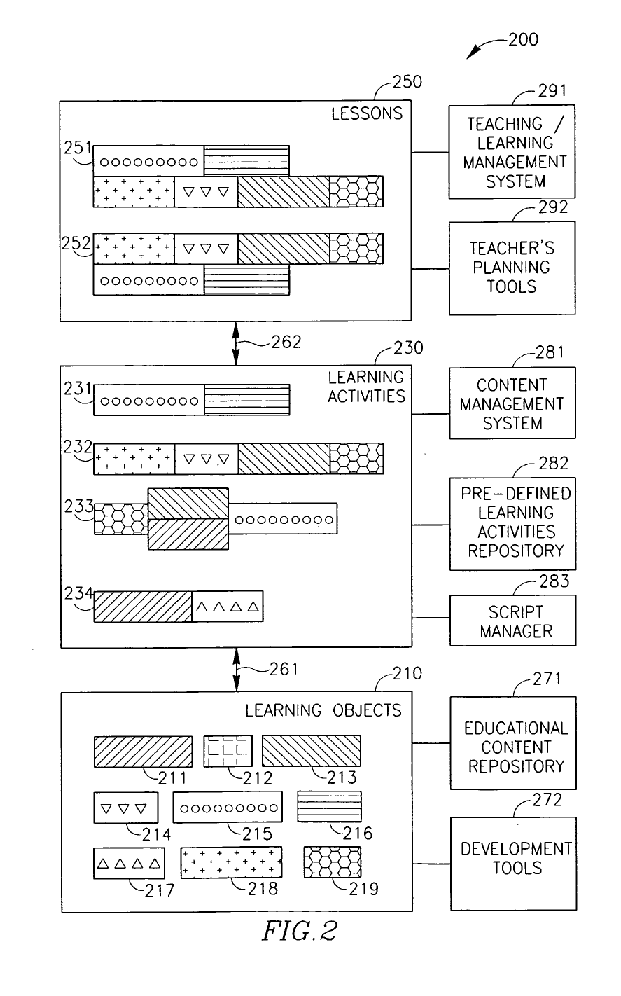

Reference is made to FIG. 2, which is a schematic block diagram illustration of a teaching/learning data structure 200 in accordance with some demonstrative embodiments. Data structure 200 includes multiple layers, for example, learning objects 210, learning activities 230, and lessons 250. In some embodiments, the teaching/learning data structure 200 may include other or additional levels of hierarchy; for example, a study unit may include a collection of multiple lessons that cover a particular topic, issue or subject, e.g., as part of a yearly subject-matter learning/teaching plan. Other or additional levels of hierarchy may be used.

Learning objects 210 include, for example, multiple learning objects 211-219. A learning object includes, for example, a stand-alone application, applet, program, or assignment addressed to a student (or to a group of students), intended for utilization by a student. A learning object may be, for example, subject to viewing, listening, typing, drawing, or otherwise interacting (e.g., passively or actively) by a student utilizing a computer. For example, learning object 211 is an Active-X interactive animated story, in which a student is required to select graphical items using a pointing device; learning object 212 is an audio/video presentation or lecture (e.g., an AVI or MPG or WMV or MOV video file) which is intended for passive viewing/hearing by the student; learning object 213 is a Flash application in which the student is required to move (e.g., drag and drop) graphical object and/or textual objects; learning object 214 is a Java applet in which the student is required to type text in response to questions posed; learning object 215 is a JavaScript program in which the student selects answers in a multiple-choice quiz; learning object 216 is a Dynamic HTML page in which the student is required to read a text, optionally navigating forward and backward among pages; learning object 217 is a Shockwave application in which the student is required to draw geometric shapes in response to instructions; or the like. Learning objects may include various other content items, for example, interactive text or “live text”, writing tools, discussion tools, assignments, tasks, quizzes, games, drills and exercises, problems for solving, questions, instruction pages, lectures, animations, audio/video content, graphical content, textual content, vocabularies, or the like.

Learning objects 210 may be associated with various time-lengths, levels of difficulty, curriculum portions or subjects, or other properties. For example, learning object 211 requires approximately twelve minutes for completion, whereas learning object 212 requires approximately seven minutes for completion; learning object 213 is a difficult learning object, whereas learning object 214 is an easy learning object; learning object 215 is a math learning object, whereas learning object 216 is a literature learning object.

Learning objects 210 are stored in an educational content repository 271. Learning objects 271 are authored, created, developed and/or generated using development tools 272, for example, using templates, editors, authoring tools, a step-by-step “wizard” generation process, or the like. The learning objects 210 are created by one or more of: teachers, teaching professionals, school personnel, pedagogic experts, academy members, principals, consultants, researchers, or other professionals. The learning objects 210 may be created or modified, for example, based on input received from focus groups, experts, simulators, quality assurance teams, or other suitable sources. The learning objects 210 may be imported from external sources, e.g., utilizing a conversion or re-formatting tools. In some embodiments, modification of a learning object by a user may result in a duplication of the learning object, such that both the original un-modified version and the new modified version of the learning object are stored; the original version and the new version of the learning object may be used substantially independently.

Learning activities 230 include, for example, multiple learning activities 231-234. For example, learning activity 231 includes learning object 215, followed by learning object 216. Learning activity 232 includes learning object 218, followed by learning objects 214, 213 and 219. Learning activity 233 includes learning object 233, followed by either learning object 213 or learning object 211, followed by learning object 215. Learning activity 234 includes learning object 211, followed by learning object 217.

A learning activity includes, for example, one or more learning objects in the same (or similar) subject matter (e.g., math, literature, physics, or the like). Learning activities 230 may be associated with various time-lengths, levels of difficulty, curriculum portions or subjects, or other properties. For example, learning activity 231 requires approximately eighteen minutes for completion, whereas learning activity 232 requires approximately thirty minutes for completion; learning activity 232 is a difficult learning activity, whereas learning activity 234 is an easy learning activity; learning activity 231 is a math learning activity, whereas learning activity 232 is a literature learning activity. A learning object may be used or placed at different locations (e.g., time locations) in different learning activities. For example, learning object 215 is the first learning object in learning activity 231, whereas learning object 215 is the last learning object in learning activity 233.

Learning activities 230 are generated and managed by a content management system 281, which may create and/or store learning activities 230. For example, browser interface allows a teacher to browse through learning objects 210 stored in the educational content repository (e.g., sorted or filtered by subject, difficulty level, time length, or other properties), and to select and construct a learning activity by combining one or more learning objects (e.g., using a drag-and-drop interface, a time-line, or other tools). In some embodiments, learning activities 230 can be arranged and/or combined in various teaching-learning-assessment scenarios or layouts, for example, using different methods of organization or modeling methods. Scenarios may be arranged, for example, manually in a pre-defined order; or may be generated automatically utilizing a script to define sequencing, branched sequencing, conditioned sequencing, or the like. Additionally or alternatively, pre-defined learning activities are stored in a pre-defined learning activities repository 282, and are available for utilization by teachers. In some embodiments, an edited scenario or layout, or a teacher generated scenario or layout, are stored in the teacher's personal “cabinet” or “private folder” (e.g., as described herein) and can by recalled for re-use or for modification. In some embodiments, other or additional mechanisms or components may be used, in addition to or instead of the learning activities repository 282. The teaching/learning system provides tools for editing of pre-defined scenarios (e.g., stored in the learning activities repository 282), and/or for creation of new scenarios by the teacher. For example, a script manager 283 may be used to create, modify and/or store scripts which define the components of the learning activity, their order or sequence, an associated time-line, and associated properties (e.g., requirements, conditions, or the like). Optionally, scripts may include rules or scripting commands that allow dynamic modification of the learning activity based on various conditions or contexts, for example, based on past performance of the particular student that uses the learning activity, based on preferences of the particular student that uses the learning activity, based on the phase of the learning process, or the like. Optionally, the script may be part of the teaching/learning plan. Once activated or executed, the script calls the appropriate learning object(s) from the educational content repository 271, and may optionally assign them to students, e.g., differentially or adaptively. The script may be implemented, for example, using Educational Modeling Language (EML), using scripting methods and commands in accordance with IMS Learning Design (LD) specifications and standards, or the like. In some embodiments, the script manager 283 may include an EML editor, thereby integrating EML editing functions into the teaching/learning system. In some embodiments, the teaching/learning system and/or the script manager 283 utilize a “modeling language” and/or “scripting language” that use pedagogic terms, e.g., describing pedagogic events and pedagogic activities that teachers are familiar with. The script may further include specifications as to what type of data should be stored or reported to the teacher substantially in real time, for example, with regard to students interactions or responses to a learning object. For example, the script may indicate to the teaching/learning system to automatically perform one or more of these operations: to store all the results and/or answers provided by students to all the questions, or to a selected group of questions; to store all the choices made by the student, or only the student's last choice; to report in real time to the teacher if pre-defined conditions are true, e.g., if at least 50 percent of the answers of a student are wrong; or the like.

Lessons 250 include, for example, multiple lessons 251 and 252. For example, lesson 251 includes learning activity 231, followed by learning activity 232. Lesson 252 includes learning activity 234, followed by learning activity 231. A lesson includes one or more learning activities, optionally having the same (or similar) subject matter.

For example, learning objects 211 and 217 are in the subject matter of multiplication, whereas learning objects 215 and 216 are in the subject matter of division. Accordingly, learning activity 234 (which includes learning objects 211 and 217) is in the subject matter of multiplication, whereas learning activity 231 (which includes learning objects 215 and 216) is in the subject matter of division. Furthermore, lesson 252 (which includes learning activities 234 and 231) is in the subject matter of math.

Lessons 250 may be associated with various time-lengths, levels of difficulty, curriculum portions or subjects, or other properties. For example, lesson 251 requires approximately forty minutes for completion, whereas lesson 252 requires approximately thirty five for completion; lesson 251 is a difficult lesson, whereas lesson 252 is an easy lesson. A learning activity may be used or placed at different locations (e.g., time locations) in different lessons. For example, learning activity 215 is the first learning object in learning activity 231, whereas learning object 215 is the last learning object in learning activity 233.

Lessons 250 are generated and managed by a teaching/learning management system 291, which may create and/or store lessons 250. For example, browser interface allows a teacher to browse through learning activities 230 (e.g., sorted or filtered by subject, difficulty level, time length, or other properties), and to select and construct a lesson by combining one or more learning activities (e.g., using a drag-and-drop interface, a time-line, or other tools). Additionally or alternatively, pre-defined lessons may be available for utilization by teachers.

As indicated by an arrow 261, learning objects 210 are used for creation and modification of learning activities 230. As indicated by an arrow 262, learning activities are used for creation and modification of lessons 250.

In some embodiments, a large number of learning objects 210 and/or learning activities 230 are available for utilization by teachers. For example, in one embodiment, learning objects 210 may include at least 300 singular learning objects 210 per subject per grade (e.g., for second grade, for third grade, or the like); at least 500 questions or exercises per subject per grade; at least 150 drilling games per subject per grade; at least 250 “live text” activities (per subject per grade) in which students interact with interactive text items; or the like.

Some learning objects 210 are originally created or generated on a singular basis, such that a developer creates a new, unique learning object 210. Other learning objects 210 are generated using templates or generation tools or “wizards”. Still other learning objects 210 are generated by modifying a previously-generated learning object 210, e.g., by replacing text items, by replacing or moving graphical items, or the like.

In some embodiments, one or more learning objects 210 may be used to compose or construct a learning activity; one or more learning activities 230 may be used to compose or construct a lesson 250; one or more lessons may be part of a study unit or an educational topic or subject matter; and one or more study units may be part of an educational discipline, e.g., associated with a work plan.

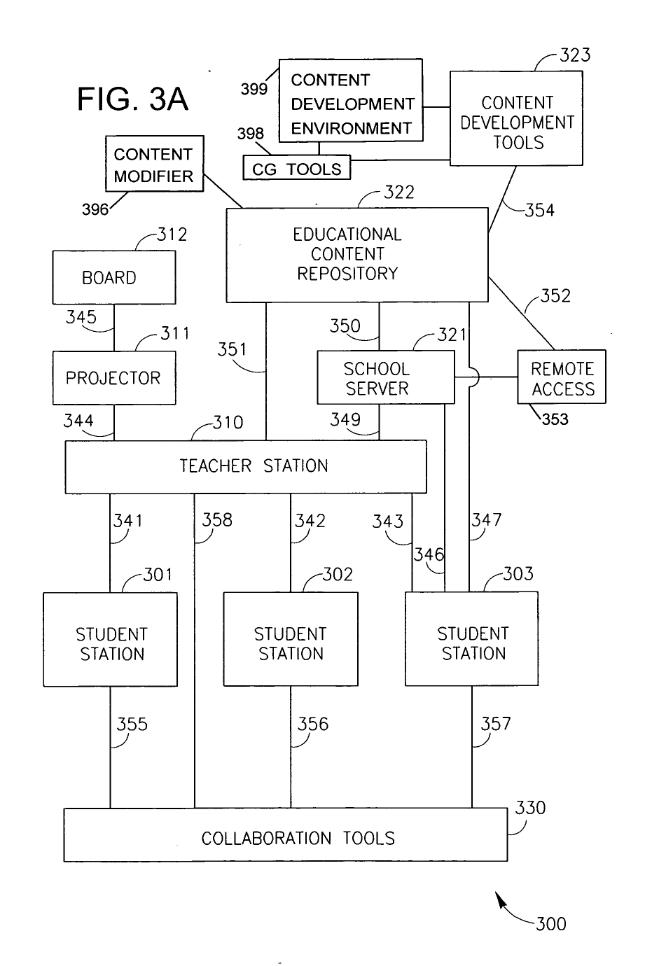

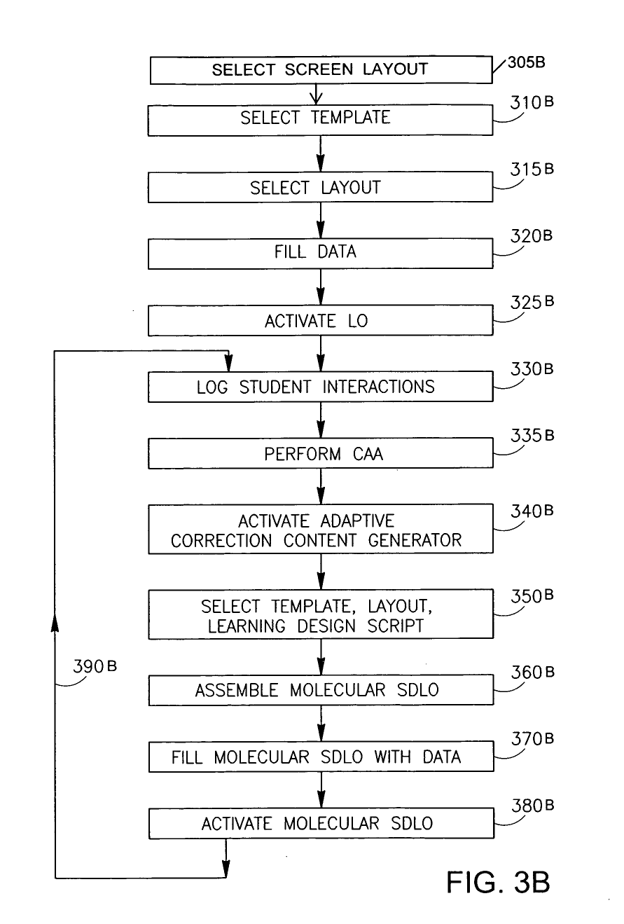

Reference is made to FIG. 3A, which is a schematic block diagram illustration of a teaching/learning system 300 in accordance with some demonstrative embodiments of the invention. Components of system 300 are interconnected using one or more wired and/or wireless links 341-358, e.g., utilizing a wired LAN, a wireless LAN, the Internet, or other communication systems.

System 300 includes a teacher station 310, and multiple student stations 301-303. The teacher station 310 and/or the student stations 301-303 may include, for example, a desktop computer, a Personal Computer (PC), a laptop computer, a mobile computer, a notebook computer, a tablet computer, a portable computer, a dedicated computing device, a general purpose computing device, or the like.

The teacher station 310 and/or the student stations 301-303 may include, for example: a processor (e.g., a Central Processing Unit (CPU), a Digital Signal Processor (DSP), a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller); an input unit (e.g., a keyboard, a keypad, a mouse, a touch-pad, a stylus, a microphone, or other suitable pointing device or input device); an output unit (e.g., a Cathode Ray Tube (CRT) monitor or display unit, a Liquid Crystal Display (LCD) monitor or display unit, a plasma monitor or display unit, a screen, a monitor, one or more speakers, or other suitable display unit or output device); a memory unit (e.g., a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units); a storage unit (e.g., a hard disk drive, a floppy disk drive, a Compact Disk (CD) drive, a CD-ROM drive, a Digital Versatile Disk (DVD) drive, or other suitable removable or non-removable storage units); a communication unit (e.g., a wired or wireless Network Interface Card (NIC), a wired or wireless modem, a wired or wireless receiver and/or transmitter, a wired or wireless transmitter-receiver or transceiver, a Radio Frequency (RF) communication unit or transceiver, or other units able to transmit and/or receive signals, blocks, frames, transmission streams, packets, messages and/or data; the communication unit may optionally include, or may optionally be associated with, one or more antennas, e.g., a dipole antenna, a monopole antenna, an omni-directional antenna, an end fed antenna, a circularly polarized antenna, a micro-strip antenna, a diversity antenna, or the like); an Operating System (OS); and other suitable hardware components and/or software components.

The teacher station 310, optionally utilizing the projector 311 and the board 312, are used by the teacher to present educational subject matters and topics, to present lectures, to convey educational information to students, to perform lesson planning, to perform in-class lesson execution and management, to perform lesson follow-up activities or processes (e.g., review students performance, review homework, review quizzes, or the like), to assign learning activities to one or more students (e.g., on a personal basis and/or on a group basis), to conduct discussions, to assign homework, to obtain the personal attention of a student or a group of student, to perform real-time in-class teaching, to perform real-time in-class management of the learning activities performed by students or groups of students, to selectively allocate or re-allocate learning activities or learning objects to students or groups of students, to receive automated feedback or manual feedback from student stations 301-303 (e.g., upon completion of a learning activity or a learning object; upon reaching a particular grade or success rate; upon failing to reach a particular grade or success rate; upon spending a threshold amount of attempts or minutes with a particular exercise, or the like), or to perform other teaching and class management operations.

In some embodiments, the teacher station 310 is used to perform operations of teaching tools, for example, lesson planning, real-time class management, presentation of educational content, allocation of differential assignment of content to students (e.g., to individual students or to groups of students), differential assignment of learning activities or learning objects to students (e.g., to individual students or to groups of students), adaptive assignment of content or learning activities or learning objects to students (e.g., based on their past performance in one or more learning activities, past successes, past failures, identified strengths, identified weaknesses), conducting of class discussions, monitoring and assessment of individual students or one or more groups of students, logging and/or reporting of operation performed by students and/or achievements of students, operating of a Learning Management System (LMS), managing of multiple learning processes performed (e.g., substantially in parallel or substantially simultaneously) by student stations 301-303, or the like. In some embodiments, the system may be implemented as Digital Teaching Platform (DTP).

The teacher station 310 may be used in substantially real time (namely, during class hours and while the teacher and the students are in the classroom), as well as before and after class hours. For example, real time utilization of the teacher station includes: presenting topics and subjects; assigning to students various activities and assignments; conducting discussions; concluding the lesson; and assigning homework. Before and after class hours utilization include, for example: selecting and allocating educational content (e.g., learning objects or learning activities) for a lesson plan; editing content elements; guiding students; assisting students; responding to students questions; assessing work and/or homework of students; and reporting. In some embodiments, the teacher station 110 may include a Teacher Content Editor, which may allow the teacher to modify and/or create digital learning objects, to modify workflow of a digital learning object, or to perform other modifications to educational content, optionally in real-time during class or after class.

The student stations 301-303 are used by students (e.g., individually such that each student operates a station, or that two students operate a station, or the like) to perform personal learning activities, to conduct personal assignments, to participate in learning activities in-class, to participate in assessment activities, to access rich digital content in various educational subject matters in accordance with the lesson plan, to collaborate in group assignments, to participate in discussions, to perform exercises, to participate in a learning community, to communicate with the teacher station 310 or with other student stations 301-303, to receive or perform personalized learning activities, or the like. In some embodiments, the student stations 301-303 include software components which may be accessed remotely by the student, for example, to allow the student to do homework from his home computer using remote access, to allow the student to perform learning activities or learning objects from his home computer or from a library computer using remote access, or the like.

The teacher station 310 is connected to, or includes, a projector 311 able to project or otherwise display information on a board 312, e.g., a blackboard, a white board, a curtain, a smart-board, or the like. The teacher station 310 and/or the projector 311 are used by the teacher, to selectively project or otherwise display content on the board 312. For example, at first, a first content is presented on the board 312, e.g., while the teacher talks to the students to explain an educational subject matter. Then, the teacher may utilize the teacher station 310 and/or the projector 311 to stop projecting the first content, while the students use their student stations 301-303 to perform learning activities. Additionally, the teacher may utilize the teacher station 310 and/or the projector 311 to selectively interrupt the utilization of student stations 301-303 by students. For example, the teacher may instruct the teacher station 310 to send an instruction to each one of student stations 301-303, to stop or pause the learning activity and to display a message such as “Please look at the Board right now” on the student stations 301-303. Other suitable operations and control schemes may be used to allow the teacher station 310 to selectively command the operation of projector 311 and/or board 312.

The teacher station 310, as well as the student stations 301-303, may be connected with a school server 321 able to provide or serve digital content, for example, learning objects, learning activities and/or lessons. Additionally or alternatively, the station 310, as well as the student stations 301-303, may be connected to an educational content repository 322, either directly (e.g., if the educational content repository 322 is part of the school server 350 or associated therewith) or indirectly (e.g., if the educational content repository 322 is implemented using a remote server, using Internet resources, or the like). Content development tools 323 are used, locally or remotely, to generate original or new education content, or to modify or edit or update content items, for example, utilizing templates, editors, step-by-step “wizard” generators, packaging tools, sequencing tools, “wrapping” tools, authoring tools, or the like.

In some embodiments, a remote access sub-system 353 is used, to allow teachers and/or students to utilize remote computing devices (e.g., at home, at a library, or the like) in conjunction with the school server 321 and/or the educational content repository 322.

In some embodiments, the teacher station 310 and the student stations 301-303 may be implemented using a common interface or an integrated platform (e.g., an “educational workstation”), such that a log-in screen request the user to select or otherwise input his role (e.g., teacher or student) and/or identity (e.g., name or unique identifier).

In some embodiments, system 300 performs ongoing assessment of students performance based on their operation of student stations 301-303. For example, instead of or in addition to conventional event-based quizzes or examinations, system 300 monitors the successes and the failures of individual students in individual learning objects or learning activities. For example, the teacher utilizes the teacher station 310 to allocate or distribute various learning activities or learning objects to various students or groups of students. The teacher utilizes the teacher station 310 to allocate a first learning object and a second learning object to a first group of students, including Student A who utilizes student station 301; and the teacher utilizes the teacher station 310 to allocate the first learning object and a third learning object to a second group of students, including Student B who utilizes student station 302.

System 300 monitors, logs and reports the performance of student based on their operation of student stations 301-303. For example, system 300 may determine and report that Student A successfully completed the first learning object, whereas Student B failed to complete the second learning object. System 300 may determine and report that Student A successfully completed the first learning object within a pre-defined time period associated with the first learning object, whereas Student B completed the second learning object within a time period longer than the required time period. System 300 may determine and report that Student A successfully completed or answered 87 percent of tasks or questions in a learning object or a learning activity, whereas Student B successfully completed or answered 45 percent of tasks or questions in a learning object or a learning activity. System 300 may determine and report that Student A appears to be “stuck” or lingering on a particular exercise or learning object, or that Student B did not operate the keyboard or mouse for a particular time period (e.g., two minutes). System 300 may determine and report that at least 80 percent of the students in the first group successfully completed at least 75 percent of their allocated learning activity, or that at least 50 percent of the students in the second group failed to correctly answer at least 30 percent of questions allocated to them. Other types of determinations and reports may be used.

System 300 generates reports at various times and using various methods, for example, based on the choice of the teacher utilizing the teacher station 310. For example, the teacher station 310 may generate one or more types of reports, e.g., individual student reports, group reports, class reports, an alert-type message that alerts the teacher to a particular event (e.g., failure or success of a student or a group of students), or the like. Reports may be generated, for example, at the end of a lesson; at particular times (e.g., at a certain hour); at pre-defined time intervals (e.g., every ten minutes, every school-day, every week); upon demand, request or command of a teacher utilizing the teacher station; upon a triggering event or when one or more conditions are met, e.g., upon completion of a certain learning activity by a student or group of students, a student failing a learning activity, a pre-defined percentage of students failing a learning activity, a student succeeding in a learning activity, a pre-defined percentage of students succeeding in a learning activity, or the like.

In some embodiments, reports or alerts may be generated by system 300 substantially in real-time, during the lesson process in class. For example, system 300 may alert the teacher, using a graphical or textual or audible notification through the teacher station 310, that one or more students or groups of students do not progress (at all, or according to pre-defined mile-stones) in the learning activity or learning object assigned to them. Upon receiving the real-time alert, the teacher may utilize the teacher station 310 to further retrieve details of the actual progress, for example, by obtaining detailed information on the progress of the relevant student(s) or group(s). For example, the teacher may use the teacher station 310 to view a report detailing progress status of students, e.g., whether the student started or not yet started a learning object or a learning activity; the percentage of students in the class or in one or more groups that completed as assignment; the progress of students in a learning object or a learning activity (e.g., the student performed 40 percent of the learning activity; the student is “stuck” for more than sixty seconds in front of the third question or the fourth screen of a learning object; the student completed the assigned learning object, and started to perform an optional learning object), or the like.

In some embodiments, teaching, learning and/or assessment activities are monitored, recorded and stored in a format that allows subsequent searching, querying and retrieval. Data mining processes in combination with reporting tools may perform research and may generate reports on various educational, pedagogic and administrative entities, for example: on students (single student, a group of students, all students in a class, a grade, a school, or the like); teachers (a single teacher, a group of teachers that teach the same grade and/or in the same school and/or the same discipline); learning activities and related content; and for conducting research and formative assessment for improvement of teaching methodologies, flow or sequence of learning activities, or the like.

In some embodiments, data mining processes and analysis processes may be performed, for example, on knowledge maps of students, on the tracked and logged operations that students perform on student stations, on the tracked and logged operations that teachers perform on teacher stations, or the like. The data mining and analysis may determine conclusions with regard to the performance, the achievements, the strengths, the weaknesses, the behavior and/or other properties of one or more students, teachers, classes, groups, schools, school districts, national education systems, multi-national or international education systems, or the like. In some embodiments, analysis results may be used to compare among teaching and/or learning at international level, national level, district level, school level, grade level, class level, group level, student level, or the like.

In some embodiments, the generated repots are used as alternative or additional assessment of students performance, students knowledge, students classroom behavior (e.g., a student is responsive to instructions, a student is non-responsive to instructions), or other student parameters. In some embodiments, for some assessment events, information items (e.g., “rubrics”) may be created and/or displayed, to provide assessment-related information to the teacher or to the teaching/learning system; the assessment information item may be visible to, or accessible by, the teacher and/or the student (e.g., subject to teacher's authorization). The assessment information item may include, for example, a built-in or integrated information item inside an assessment event that provides instructions to the teacher (or the teaching/learning system) on how to evaluate an assessment event which was executed by the student. Other formats and/or functions of assessment information items may be used.

Optionally, system 300 generates and/or initiates, automatically or upon demand of the teacher utilizing the teacher station 310 (or, for example, automatically and subject to the approval of the teacher utilizing the teacher station 310), one or more correction cycles, “drilling” cycles, additional learning objects, modified learning objects, or the like. For example, system 300 determines that Student A solved correctly 72 percent of the math questions presented to him; that substantially all (or most of) the math questions that Student A solved successfully are in the field of multiplication; and that substantially all (or most of) the math questions that Student A failed to solved are in the field of division. Accordingly, system 300 may report to the teacher station 310 that Student A comprehends multiplication, and that Student A does not comprehend (at all, or to an estimated degree) division. Additionally, system 300 adaptively and selectively presents content (or refrain from presenting content) to accommodate the identified strengths and weaknesses of Student A. For example, system 300 may selectively refrain from presenting to Student A additional content (e.g., explanations and/or exercises) in the field of multiplication, which Student A comprehends. System 300 may selectively present to Student A additional content (e.g., explanations and/or exercises) in the field of division, which Student B does not yet comprehend. The additional presentation (or the refraining from additional presentation) may be performed by system 300 automatically, or subject to an approval of the teacher utilizing the teacher station 310 in response to an alert message or a suggestion message presented on the teacher station 310.

In some embodiments, multiple types of users may utilize system 300 or its components, in-class and/or remotely. Such types of users include, for example, teachers in class, students in class, teachers at home or remotely, students at home or remotely, parents, community members, supervisors, managers, principals, authorities (e.g., Board of Education), school system administrator, school support and help-desk personnel, system manager(s), techno-pedagogic experts, content development experts, or the like.

In some embodiments, system 300 may be used as a collaborative Learning Management System (LMS) or Digital Teaching Platform (DTP), in which teachers and students utilize a common system. For example, system 300 may include collaboration tools 330 to allow real-time in-class collaboration, e.g., allowing students to send or submit their accomplishments or their work results (or portions thereof) to a common space, from which the teacher (utilizing the teacher station 310) selects one or more of the submission items for projection, for comparison, or the like. The collaboration tools 330 may optionally be implemented, for example, using a collaboration environment or collaboration area or collaboration system. The collaboration tools 330 may optionally include a teacher-moderated common space, to which students (utilizing the student stations 301-303) post their work, text, graphics, or other information, thereby creating a common collaborative “blog” or publishing a Web news bulletin or other form of presentation of students products. The collaboration tools 330 may further provide a collaborative workspace, where students may work together on a common assignment, optionally displaying in real-time peers that are available online for chat or instant messaging (e.g., represented using real-life names, user-names, avatars, graphical items, textual items, photographs, links, or the like).

In some embodiments, dynamic personalization and/or differentiation may be used by system 300, for example, per teacher, per student, per group of students, per class, per grade, or the like. System 300 and/or its educational content may be open to third-party content, may comply with various standards (e.g., World Wide Web standards, education standards, or the like). System 300 may be a tagged-content Learning Content Management System (LCMS), utilizing Semantic Web mechanisms, meta-data, and/or democratic tagging of educational content by users (e.g., teachers, students, experts, parents, or the like).

System 300 may utilize or may include pluggable architecture, for example, a plug-in or converter or importer mechanism, e.g., to allow importing of external materials into the system as learning objects or learning activities or lessons, to allow rapid adaptation of new types of learning objects (e.g., original or third-party), to provide a blueprint or a template for third-party content, or the like.

System 300 may be implemented or adapted to meet specific requirements of an education system or a school. For example, in some embodiments, system 300 may set a maximum number of activities per sequence or per lesson; may set a maximum number of parallel activities that the teacher may allocate to students (e.g., to avoid a situation in which the teacher “loses control” of what each student in the class is doing); may allow flexible navigation within and/or between learning activities and/or learning objects; may include clear, legible and non-artistic interface components, for easier or faster comprehension by users; may allow collaborative discussions among students (or student stations), and/or among one or more students (or student stations) and the teacher (or teacher station); and may train and prepare teacher and students for using the system 300 and for maximizing the benefits from its educational content and tools.

In some embodiments, a student station allows the student to access a “user cabinet” or “personal folder” which includes personal information and content associated with that particular student. For example, the user cabinet may store and/or present to the student: educational content that the student already viewed or practiced; projects that the student already completed and/or submitted; drafts and work-in-progress that the student prepares, prior to their completion and/or submission; personal records of the student, for example, his grades and his attendance records; copies of tests or assignments that the student already took, optionally reconstructing the test or allowing the test to be re-solved by the student, or optionally showing the correct answers to the test questions; lessons that the student already viewed; tutorials that the student already viewed, or tutorials related to topics that the student already practiced; forward-looking tutorials, lectures and explanations related to topics that the student did not yet learn and/or did not yet practice, but that the student is required to learn by himself or out of class; assignments or homework assignments pending for completion; assignments or homework assignments completed, submitted, graded, and/or still in draft status; a notepad with private or personal notes that the student may write for his retrieval; indications of “bookmarks” or “favorites” or other pointers to learning objects or learning activities or educational content which the student selected to mark as favorite or for rapid access; or the like.

In some embodiments, a teacher station allows the teacher (and optionally one or more students, via the student stations) to access a “teacher cabinet” or “personal folder” (or a subset thereof, or a presentation or a display of portions thereof), which may, for example, store and/or present to the teacher (and/or to students) the “plans” or “activity layout” that the teacher planned for his class; changes or additions that the teacher introduced to the original plan; presentation of the actually executed lesson process, optionally including comments that the teacher entered; or the like.

Reference is made to FIG. 1B, which is a schematic block diagram illustration of a teaching/learning system 100B in accordance with some demonstrative embodiments. Components of system 100B are interconnected using one or more wired and/or wireless links, e.g., utilizing a wired LAN, a wireless LAN, the Internet, and/or other communication systems.

System 100B includes a teacher station 110B, and multiple student stations 101B-103B. The teacher station 110B and/or the student stations 101B-103B may include, for example, a desktop computer, a Personal Computer (PC), a laptop computer, a mobile computer, a notebook computer, a tablet computer, a portable computer, a dedicated computing device, a general purpose computing device, a cellular device, or the like.

The teacher station 110B and/or the student stations 101B-103B may include, for example: a processor (e.g., a Central Processing Unit (CPU), a Digital Signal Processor (DSP), a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller); an input unit (e.g., a keyboard, a keypad, a mouse, a touch-pad, a stylus, a microphone, or other suitable pointing device or input device); an output unit (e.g., a Cathode Ray Tube (CRT) monitor or display unit, a Liquid Crystal Display (LCD) monitor or display unit, a plasma monitor or display unit, a screen, a monitor, one or more speakers, or other suitable display unit or output device); a memory unit (e.g., a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units); a storage unit (e.g., a hard disk drive, a floppy disk drive, a Compact Disk (CD) drive, a CD-ROM drive, a Digital Versatile Disk (DVD) drive, or other suitable removable or non-removable storage units); a communication unit (e.g., a wired or wireless Network Interface Card (NIC) or network adapter, a wired or wireless modem, a wired or wireless receiver and/or transmitter, a wired or wireless transmitter-receiver or transceiver, a Radio Frequency (RF) communication unit or transceiver, or other units able to transmit and/or receive signals, blocks, frames, transmission streams, packets, messages and/or data; the communication unit may optionally include, or may optionally be associated with, one or more antennas or sets an antennas; an Operating System (OS); and other suitable hardware components and/or software components.

The teacher station 110B, optionally utilizing a projector 111B and a board 112B, may be used by the teacher to present educational subject matters and topics, to present lectures, to convey educational information to students, to perform lesson planning, to perform in-class lesson execution and management, to perform lesson follow-up activities or processes (e.g., review students performance, review homework, review quizzes, or the like), to assign learning activities to one or more students (e.g., on a personal basis and/or on a group basis), to conduct discussions, to assign homework, to obtain the personal attention of a student or a group of student, to perform real-time in-class teaching, to perform real-time in-class management of the learning activities performed by students or groups of students, to selectively allocate or re-allocate learning activities or learning objects to students or groups of students, to receive automated feedback or manual feedback from student stations 101B-103B (e.g., upon completion of a learning activity or a learning object; upon reaching a particular grade or success rate; upon failing to reach a particular grade or success rate; upon spending a threshold amount of attempts or minutes with a particular exercise, or the like), or to perform other teaching and/or class management operations.

In some embodiments, the teacher station 110B may be used to perform operations of teaching tools, for example, lesson planning, real-time class management, presentation of educational content, allocation of differential assignment of content to students (e.g., to individual students or to groups of students), differential assignment of learning activities or learning objects to students (e.g., to individual students or to groups of students), adaptive assignment of content or learning activities or learning objects to students (e.g., based on their past performance in one or more learning activities, past successes, past failures, identified strengths, identified weaknesses), conducting of class discussions, monitoring and assessment of individual students or one or more groups of students, logging and/or reporting of operation performed by students and/or achievements of students, operating of a Learning Management System (LMS), managing of multiple learning processes performed (e.g., substantially in parallel or substantially simultaneously) by student stations 101B-103B, or the like. In some embodiments, some operations (e.g., logging operations) may be performed by a server (e.g., LMS server) or by other units external to the teacher station 110B, whereas other operations (e.g., reporting operations) may be performed by the teacher station 110B.

The teacher station 110B may be used in substantially real time (namely, during class hours and while the teacher and the students are in the classroom), as well as before and after class hours. For example, real time utilization of the teacher station includes: presenting topics and subjects; assigning to students various activities and assignments; conducting discussions; concluding the lesson; and assigning homework. Before and after class hours utilization include, for example: selecting and allocating educational content (e.g., learning objects or learning activities) for a lesson plan; guiding students; assisting students; responding to students questions; assessing work and/or homework of students; managing differential groups of students; and reporting.

The student stations 101B-103B are used by students (e.g., individually such that each student operates a station, or that two students operate a station, or the like) to perform personal learning activities, to conduct personal assignments, to participate in learning activities in-class, to participate in assessment activities, to access rich digital content in various educational subject matters in accordance with the lesson plan, to collaborate in group assignments, to participate in discussions, to perform exercises, to participate in a learning community, to communicate with the teacher station 110B or with other student stations 101B-103B, to receive or perform personalized learning activities, or the like. In some embodiments, the student stations 101B-103B may optionally include or utilize software components which may be accessed remotely by the student, for example, to allow the student to do homework from his home computer using remote access, to allow the student to perform learning activities or learning objects from his home computer or from a library computer using remote access, or the like. In some embodiments, student stations 101B-103B may be implemented as “thin” client devices, for example, utilizing an Operating System (OS) and a Web browser to access remotely-stored educational content (e.g., through the Internet, an Intranet, or other types of networks) which may be stored on external and/or remote server(s).

The teacher station 110B is connected to, or includes, the projector 111B able to project or otherwise display information on a board 112B, e.g., a blackboard, a white board, a curtain, a smart-board, or the like. The teacher station 110B and/or the projector 111B may be used by the teacher, to selectively project or otherwise display content on the board 112B. For example, at first, a first content is presented on the board 112B, e.g., while the teacher talks to the students to explain an educational subject matter. Then, the teacher may utilize the teacher station 110B and/or the projector 111B to stop projecting the first content, while the students use their student stations 101B-103B to perform learning activities. Additionally, the teacher may utilize the teacher station 110B and/or the projector 111B to selectively interrupt the utilization of student stations 101B-103B by students. For example, the teacher may instruct the teacher station 110B to send an instruction to each one of student stations 101B-103B, to stop or pause the learning activity and to display a message such as “Please look at the Board right now” on the student stations 101B-103B. Other suitable operations and control schemes may be used to allow the teacher station 110B to selectively command the operation of projector 111B and/or board 112B.

The teacher station 110B, as well as the student stations 101B-103B, may be connected with a school server 121B able to provide or serve digital content, for example, learning objects, learning activities and/or lessons. Additionally or alternatively, the teacher station 110B, as well as the student stations 101B-103B, may be connected to an educational content repository 122B, either directly (e.g., if the educational content repository 122B is part of the school server 121B or associated therewith) or indirectly (e.g., if the educational content repository 122B is implemented using a remote server, using Internet resources, or the like). In some embodiments, system 100B may be implemented such that educational content are stored locally at the school, or in a remote location. For example, a school server may provide full services to the teacher station 110B and/or the student stations 101B-103B; and/or, the school server may operate as mediator or proxy to a remote server able to serve educational content.

Content development tools 124B may be used, locally or remotely, to generate original or new education content, or to modify or edit or update content items, for example, utilizing templates, editors, step-by-step “wizard” generators, packaging tools, sequencing tools, “wrapping” tools, authoring tools, or the like. In some embodiments, the content development tools 124B may be implemented as a Content Generation Environment (CGE) having one or more Content Generation (CG) tools. In some embodiments, the teacher station 110 may include a Teacher Content Editor, which may allow the teacher to modify and/or create digital learning objects, to modify workflow of a digital learning object, or to perform other modifications to educational content, optionally in real-time during class or after class.

In some embodiments, a remote access sub-system 123B is used, to allow teachers and/or students to utilize remote computing devices (e.g., at home, at a library, or the like) in conjunction with the school server 121B and/or the educational content repository 122B.

In some embodiments, the teacher station 110B and the student stations 101B-103B may be implemented using a common interface or an integrated platform (e.g., an “educational workstation”), such that a log-in screen request the user to select or otherwise input his role (e.g., teacher or student) and/or identity (e.g., name or unique identifier).

In some embodiments, system 100B performs ongoing assessment of students performance based on their operation of student stations 101B-103B. For example, instead of or in addition to conventional event-based quizzes or examinations, system 100B monitors the successes and the failures of individual students in individual learning objects or learning activities. For example, the teacher utilizes the teacher station 110B to allocate or distribute various learning activities or learning objects to various students or groups of students. The teacher utilizes the teacher station 110B to allocate a first learning object and a second learning object to a first group of students, including Student A who utilizes student station 101B; and the teacher utilizes the teacher station 110B to allocate the first learning object and a third learning object to a second group of students, including Student B who utilizes student station 102B.

System 100B monitors, logs and reports the performance of students based on their operation of student stations 101B-103B. For example, system 100B may determine and report that Student A successfully completed the first learning object, whereas Student B failed to complete the second learning object. System 100B may determine and report that Student A successfully completed the first learning object within a pre-defined time period associated with the first learning object, whereas Student B completed the second learning object within a time period longer than the required time period. System 100B may determine and report that Student A successfully completed or answered 87 percent of tasks or questions in a learning object or a learning activity, whereas Student B successfully completed or answered 45 percent of tasks or questions in a learning object or a learning activity. System 100B may determine and report that Student A successfully completed or answered 80 percent of the tasks or questions in a learning object or a learning activity on his first attempt and 20 percent of tasks or questions only on the second attempt, whereas Student B successfully completed or answered only 29 percent on the first attempt, 31 percent on the second attempt, and for the remaining 40 percent he got the right answer from the student station (e.g., after providing incorrect answers on three attempts). System 100B may determine and report that Student A appears to be “stuck” or lingering on a particular exercise or learning object, or that Student B did not operate the keyboard or mouse for a particular time period (e.g., two minutes). System 100B may determine and report that at least 80 percent of the students in the first group successfully completed at least 75 percent of their allocated learning activity, or that at least 50 percent of the students in the second group failed to correctly answer at least 30 percent of questions allocated to them. Other types of determinations and reports may be used.

System 100B generates reports at various times and using various methods, for example, based on the choice of the teacher utilizing the teacher station 110B. For example, the teacher station 110B may generate one or more types of reports, e.g., individual student reports, group reports, class reports, an alert-type message that alerts the teacher to a particular event (e.g., failure or success of a student or a group of students), or the like. Reports may be generated, for example, at the end of a lesson; at particular times (e.g., at a certain hour); at pre-defined time intervals (e.g., every ten minutes, every school-day, every week); upon demand, request or command of a teacher utilizing the teacher station; upon a triggering event or when one or more conditions are met, e.g., upon completion of a certain learning activity by a student or group of students, a student failing a learning activity, a pre-defined percentage of students failing a learning activity, a student succeeding in a learning activity, a pre-defined percentage of students succeeding in a learning activity, or the like.

In some embodiments, reports or alerts may be generated by system 100B substantially in real-time, during the lesson process in class. For example, system 100B may alert the teacher, using a graphical or textual or audible notification through the teacher station 110B, that one or more students or groups of students do not progress (at all, or according to pre-defined mile-stones) in the learning activity or learning object assigned to them. Upon receiving the real-time alert, the teacher may utilize the teacher station 110B to further retrieve details of the actual progress, for example, by obtaining detailed information on the progress of the relevant student(s) or group(s). For example, the teacher may use the teacher station 110B to view a report detailing progress status of students, e.g., whether the student started or not yet started a learning object or a learning activity; the percentage of students in the class or in one or more groups that completed as assignment; the progress of students in a learning object or a learning activity (e.g., the student performed 40 percent of the learning activity; the student is “stuck” for more than three minutes in front of the third question or the fourth screen of a learning object; the student completed the assigned learning object, and started to perform an optional learning object), or the like.

In some embodiments, teaching, learning and/or assessment activities are monitored, recorded and stored in a format that allows subsequent searching, querying and retrieval. Data mining processes in combination with reporting tools may perform research and may generate reports on various educational, pedagogic and administrative entities, for example: on students (single student, a group of students, all students in a class, a grade, a school, or the like); teachers (a single teacher, a group of teachers that teach the same grade and/or in the same school and/or the same discipline); learning activities and related content; and for conducting research and formative assessment for improvement of teaching methodologies, flow or sequence of learning activities, or the like.

In some embodiments, data mining processes and analysis processes may be performed, for example, on knowledge maps of students, on the tracked and logged operations that students perform on student stations, on the tracked and logged operations that teachers perform on teacher stations, or the like. The data mining and analysis may determine conclusions with regard to the performance, the achievements, the strengths, the weaknesses, the behavior and/or other properties of one or more students, teachers, classes, groups, schools, school districts, national education systems, multi-national or international education systems, or the like. In some embodiments, analysis results may be used to compare among teaching and/or learning at international level, national level, district level, school level, grade level, class level, group level, student level, or the like.

In some embodiments, the generated repots are used as alternative or additional assessment of students performance, students knowledge, students learning strategies (e.g., a student is always attempting trial and error when answering; a student is always asking the system for the hint option), students classroom behavior (e.g., a student is responsive to instructions, a student is non-responsive to instructions), or other student parameters. In some embodiments, for some assessment events, information items (e.g., “rubrics”) may be created and/or displayed, to provide assessment-related information to the teacher or to the teaching/learning system; the assessment information item may be visible to, or accessible by, the teacher and/or the student (e.g., subject to teacher's authorization). The assessment information item may include, for example, a built-in or integrated information item inside an assessment event that provides instructions to the teacher (or the teaching/learning system) on how to evaluate an assessment event which was executed by the student. Other formats and/or functions of assessment information items may be used.

Optionally, system 100B generates and/or initiates, automatically or upon demand of the teacher utilizing the teacher station 110B (or, for example, automatically and subject to the approval of the teacher utilizing the teacher station 110B), one or more student-adapted correction cycles, “drilling” cycles, additional learning objects, modified learning objects, or the like. In view of data from of the students' record of performance, system 100B may identify strengths and weaknesses, comprehension and misconceptions. For example, system 100B determines that Student A solved correctly 72 percent of the math questions presented to him; that substantially all (or most of) the math questions that Student A solved successfully are in the field of multiplication; and that substantially all (or most of) the math questions that Student A failed to solved are in the field of division. Accordingly, system 100B may report to the teacher station 110B that Student A comprehends multiplication, and that Student A does not comprehend (at all, or to an estimated degree) division. Additionally, system 100B adaptively and selectively presents content (or refrain from presenting content) to accommodate the identified strengths and weaknesses of Student A. For example, system 100B may selectively refrain from presenting to Student A additional content (e.g., hints, explanations and/or exercises) in the field of multiplication, which Student A comprehends. System 100B may selectively present to Student A additional content (e.g., explanations, examples and/or exercises) in the field of division, which Student B does not yet comprehend. The additional presentation (or the refraining from additional presentation) may be performed by system 100B automatically, or subject to an approval of the teacher utilizing the teacher station 110B in response to an alert message or a suggestion message presented on the teacher station 110B.

In some embodiments, if given the appropriate permission(s), multiple types of users may utilize system 100B or its components, in-class and/or remotely. Such types of users include, for example, teachers in class, students in class, teachers at home or remotely, students at home or remotely, parents, community members, supervisors, managers, principals, authorities (e.g., Board of Education), school system administrator, school support and help-desk personnel, system manager(s), techno-pedagogic experts, content development experts, or the like.

In some embodiments, system 100B may be used as a collaborative Learning Management System (LMS), in which teachers and students utilize a common system. For example, system 100B may include collaboration tools 130B to allow real-time in-class collaboration, e.g., allowing students to send or submit their accomplishments or their work results (or portions thereof) to a common space, from which the teacher (utilizing the teacher station 110B) selects one or more of the submission items for projection, for comparison, or the like. The collaboration tools 130B may optionally be implemented, for example, using a collaboration environment or collaboration area or collaboration system. The collaboration tools 130B may optionally include a teacher-moderated common space, to which students (utilizing the student stations 101B-103B) post their work, text, graphics, or other information, thereby creating a common collaborative “blog” or publishing a Web news bulletin or other form of presentation of students products. The collaboration tools 130B may further provide a collaborative workspace, where students may work together on a common assignment, optionally displaying in real-time peers that are available online for chat or instant messaging (e.g., represented using real-life names, user-names, avatars, graphical items, textual items, photographs, links, or the like).

In some embodiments, dynamic personalization and/or differentiation may be used by system 100B, for example, per teacher, per student, per group of students, per class, per grade, or the like. System 100B and/or its educational content may be open to third-party content, may comply with various standards (e.g., World Wide Web standards, education standards, or the like). System 100B may be a tagged-content Learning Content Management System (LCMS), utilizing Semantic Web mechanisms, meta-data, tagging content and learning activities by concept-based controlled vocabulary, describing their relations to educational and/or disciplinary concepts, and/or democratic tagging of educational content by users (e.g., teachers, students, experts, parents, or the like).

System 100B may utilize or may include pluggable architecture, for example, a plug-in or converter or importer mechanism, e.g., to allow importing of external materials or content into the system as learning objects or learning activities or lessons, to allow smart retrieval from the content repository, to allow identification by the LMS system and the CAA sub-system, to allow rapid adaptation of new types of learning objects (e.g., original or third-party), to provide a blueprint or a template for third-party content, or the like.

System 100B may be implemented or adapted to meet specific requirements of an education system or a school. For example, in some embodiments, system 100B may set a maximum number of activities per sequence or per lesson; may set a maximum number of parallel activities that the teacher may allocate to students (e.g., to avoid a situation in which the teacher “loses control” of what each student in the class is doing); may allow flexible navigation within and/or between learning activities and/or learning objects; may include clear, legible and non-artistic interface components, for easier or faster comprehension by users; may allow collaborative discussions among students (or student stations), and/or among one or more students (or student stations) and the teacher (or teacher station); and may train and prepare teacher and students for using the system 100B and for maximizing the benefits from its educational content and tools.

In some embodiments, a student station 101B-103B allows the student to access a “user cabinet” or “personal folder” which includes personal information and content associated with that particular student. For example, the “user cabinet” may store and/or present to the student: educational content that the student already viewed or practiced; projects that the student already completed and/or submitted; drafts and work-in-progress that the student prepares, prior to their completion and/or submission; personal records of the student, for example, his grades and his attendance records; copies of tests or assignments that the student already took, optionally reconstructing the test or allowing the test to be re-solved by the student, or optionally showing the correct answers to the test questions; lessons that the student already viewed; tutorials that the student already viewed, or tutorials related to topics that the student already practiced; forward-looking tutorials, lectures and explanations related to topics that the student did not yet learn and/or did not yet practice, but that the student is required to learn by himself or out of class; assignments or homework assignments pending for completion; assignments or homework assignments completed, submitted, graded, and/or still in draft status; a notepad with private or personal notes that the student may write for his retrieval; indications of “bookmarks” or “favorites” or other pointers to learning objects or learning activities or educational content which the student selected to mark as favorite or for rapid access; or the like.

In some embodiments, the teacher station 110B allows the teacher (and optionally one or more students, if given appropriate permission(s), via the student stations) to access a “teacher cabinet” or “personal folder” (or a subset thereof, or a presentation or a display of portions thereof), which may, for example, store and/or present to the teacher (and/or to students) the “plans” or “activity layout” that the teacher planned for his class; changes or additions that the teacher introduced to the original plan; presentation of the actually executed lesson process, optionally including comments that the teacher entered; or the like.

System 100B may utilize Computer-Assisted Assessment or Computer-Aided Assessment (CAA) of performance of student(s) and of pedagogic parameters related to student(s). In some embodiments, for example, system 100B may include, or may be coupled to, a CAA sub-system 170B having multiple components or modules, e.g., components 171B-177B. In some embodiments, CAA sub-system 170B may be an add-on to system 100B, or to other techno-pedagogic or educational systems, in which the CAA sub-system 170B is given access to a database storing students' assessment data (e.g., automated assessment using a computerized system, or manual assessment as assessed and noted by teachers).

An ontology component 171B includes a concept-based controlled vocabulary (expressed using one or more languages) encompassing the system's terminological knowledge, reflecting the explicit and implicit knowledge present within the system's learning objects. The ontology component 171B may be implemented, for example, as a relational database including tables of concepts and their definitions, terms (e.g., in one or more languages), mappings from terms to concepts, and relationships across concepts. Concepts may include educational objectives, required learning outcomes or standards and milestones to be achieved, items from a revised Bloom Taxonomy, models of cognitive processes, levels of learning activities, complexity of gained competencies, general and subject-specific topics, or the like. The concepts of ontology 171 may be used as the outcomes for CAA and/or for other applications, for example, planning, search/retrieval, differential lesson generation, or the like.

A mapping and tagging component 172B indicates mapping between the various learning objects or learning entities (e.g., stored in the educational content repository 122B) to the ontology concepts (e.g., knowledge elements) reflecting the pedagogic values of these learning entities. The mapping may be, for example, one-to-one or one-to-many. The mapping may be performed based on input from discipline-specific assessment experts.

A knowledge map engine 173B receives multiple types of inputs: information about the activities of the student (e.g., answers to questions, the difficulty level of each question, the time it took to complete various tasks, the location where different tasks were performed); the mappings between the activities performed by the student and the knowledge elements that these activities contribute to; and a model (e.g., a “required knowledge map”) of the knowledge elements and capabilities that the student is expected to master within a given learning unit, including the possible relationships between such elements. The knowledge map engine 173B utilizes these inputs to establish an “acquired knowledge map” estimating, at any given point in time, the degree to which the student mastered each of the required knowledge elements or capabilities. The knowledge map engine 173B may use graphical models of belief propagation to build a model of the knowledge map of the student, and may update this model over time, as information about more activities performed by the student becomes available.

The knowledge map engine 173B may perform and/or allow, for example: a way to glean and incorporate expert knowledge into the system, in the form of prior probabilities and relationships between properties to be assessed; the relationships between observed learning outcomes and related competencies or skills; assessment of properties that are not directly observable; multi-dimensional assessment; a natural measure of assessment accuracy, given by the standard deviation of the distribution function for each assessed variable; and ability to detect the most probable causes for student deficient performance. Furthermore, with time and the accumulation of information about student activities, the model becomes more and more accurate at assessing the student's knowledge. The model may, over time, serve as an accurate tool for assigning grades to the students knowledge and learning abilities, as well as directing the course of learning, for example, by finding areas where the student needs additional help in form of explanations, training, exercising, or the like.

A dashboard component 174B may include a customizable interface used as a base for providing CAA. The dashboard 174B uses data mining algorithms to allow a comprehensive view of students activities, teachers activities and classes activities, as well as skills and achievements; including the ability to drill down for a detailed view of every entity in the system. The dashboard 174B may be used by teachers, students, principals, and parents, and may be tailored to serve the specific needs of its different users. The dashboard 174B may be used to display information via graphs, alerts, and reports. In some embodiments, the dashboard 174B may be implemented as part of the teacher station 110B, as part of a student station 101B-103B, as a component available to remote users via the remote access sub-system 123B, as a stand-alone component, or the like.

An alerts engine 175B includes a customizable alert generator able to notify the teacher's station 110B of extreme student assessment-related behavior, or of student assessment-related behavior that meets pre-defined criteria or is above or below pre-defined threshold values. In some embodiments, the alerts may be viewed directly from the dashboard 174B, and may be linked to relevant reports.

A reporting engine 176B includes a customizable reporting system used for providing user-specific detailed assessment-related information. The reports may be accessed directly via the dashboard 174B and/or by drilling down into specific alerts.

A CAA engine 177B may build and update a student model 181B in order to track a student's knowledge and capabilities relative to a domain model 182B, namely, a specification of required or desired knowledge and capabilities within a given domain. The CAA engine 177B may receive as input multiple types of data: the required or desired knowledge map; mapping of tasks performed by the student to knowledge and capabilities represented in the knowledge map; information about the performed tasks, for example, task parameters (e.g., type, difficulty level) and performance metrics (e.g., correct or incorrect answer, number of attempts, time spent on task).

In some embodiments, the required or desired knowledge map may be a proper subset of concepts from the ontology 171B representing the different elements of knowledge (e.g., facts, capabilities, or the like) relevant to a given domain. The domain may be, for example, a subject taught in a particular grade within a particular school system. The ontology 171B may include, for example, a concept-based multilingual controlled vocabulary covering concepts relevant to a pedagogic system, as well as their concomitant terms and relationships across concepts. Concepts may include, for example: curricular concepts; concepts derived from a required “official” curriculum or syllabus; outcome concepts, reflecting concepts used for tagging atoms within the system's learning objects and linked to curricular concepts; and components of fine granularity which combine to form outcome concepts.

The CAA engine 177B may maintain and update the student model 181B as a Pedagogic Bayesian Network (PBN) 183B, for example, an algorithmic construct that allows estimation of and inference about multiple random (or pseudo-random) variables having multiple dependencies.

For example, in the student model 181B, hidden variables may correspond to knowledge elements, capabilities, or similar variables which are to be assessed. The student model 181B may further accommodate variables corresponding to higher-level entities, for example, cognitive state of the student (e.g., alertness or boredom). Observable variables in the student model 181B may correspond, for example, to information about performed tasks.

Although portions of the discussion herein may relate, for demonstrative purposes, to a Bayesian Network or to a Pedagogic Bayesian Network (PBN), some embodiments may utilize other types of models or networks, statistically evolving models, models based on relational concept mapping, models for estimation of hidden variables based on observable variables, or the like.

In some embodiments, learning entities may belong to a class or a group from an ordered hierarchy; for example, ordered from the larger to the smaller: discipline, subject area, topic, unit, segment, learning activity, activity item (e.g., Molecular SDLO described herein), atom (e.g., Atomic SDLO described herein), and asset. Other suitable hierarchies may be used.

Reference is made to FIG. 1C, which is a schematic block diagram illustration of a teaching/learning system 100C in accordance with some demonstrative embodiments of the invention. One or more of the components in FIG. 1C may generally correspond to one or more respective components in FIG. 1A and/or FIG. 1B.

The educational content repository 122C may store learning objects, learning activities, lessons, or other units representing educational content. In some embodiments, the educational content repository 122C may store atomic Smart Digital Learning Objects (Atomic SDLOs) 191C, which may be assembled or otherwise combined into Molecular Smart Digital Learning Objects (Molecular SDLOs) 192C.

Each Atomic SDLO 191C may be, for example, a unit of information representing a screen to be presented to a student within an educational task. Each Molecular SDLO 192C may include one or more Atomic SDLOs 191C. The Atomic SDLOs 191C may be able to interact among themselves, and/or to interact with a managerial component 193C which may further be included, optionally, in Molecular SDLO 192C. In some embodiments, the interaction or performance of a student within one Atomic SDLO 191C (e.g., a screen) of a Molecular SDLO 192C may affect the content and/or characteristics of one or more other Atomic SDLO 191C (e.g., one or more other screens) of that Molecular SDLO 192C.

In some embodiments, the educational content repository 122C may further include templates 194C, layouts 195C, and assets 196C from which educational content items may be dynamically generated, automatically generated, semi-automatically generated (e.g., based on input from a teacher), or otherwise utilized in creation or modification or educational content.

In some embodiments, each Atomic SDLO 191C, as well as templates 194C, layouts 195C and assets 196C, may be concept-tagged based on a pre-defined ontology. For example, an ontology component 171C includes a concept-based controlled vocabulary (expressed using one or more languages) encompassing the system's terminological knowledge, reflecting the explicit and implicit knowledge present within the system's learning objects. The ontology component 171C may be implemented, for example, as a relational database including tables of concepts and their definitions, terms (e.g., in one or more languages), mappings from terms to concepts, and relationships across concepts. Concepts may include educational objectives, required learning outcomes or standards and milestones to be achieved, items from a revised Bloom Taxonomy, models of cognitive processes, levels of learning activities, complexity of gained competencies, general and subject-specific topics, or the like. The concepts of ontology 171C may be used as the outcomes for CAA and/or for other applications, for example, planning, search/retrieval, differential lesson generation, or the like.

A mapping and tagging component 172C indicates mapping between the various learning objects or learning entities (e.g., stored in the educational content repository 122C) to the ontology concepts (e.g., knowledge elements) reflecting the pedagogic values of these learning entities. The mapping may be, for example, one-to-one or one-to-many. The mapping may be performed based on input from discipline-specific assessment experts.

In some embodiments, the concept-tagging of templates 194C and layouts 195C for skills and competencies allows the teacher, as well as automated or semi-automated wizards and content generation tools, to perform smart selection of these elements when generating a piece of educational content to serve in the learning process. The tagging may include, for example, tagging for contribution to skill and competencies, tagging for contribution to topic and factual knowledge, or the like.

Given the ontology 171C, the tagging of all components and students' knowledge map (e.g., as continuously drawn by the CAA sub-system 170C) may be performed in conjunction with SDLO rules and in accordance with a pedagogic schema. The schema, or other learning design script, defines the flow or progress of the learning activity from a pedagogical point of view. The SDLO specification defines the relations and interaction between SDLOs in the system.

In accordance with SDLO architecture, learning objects are composed of Atomic SDLOs 191C that communicate between themselves and with the LMS and create a Molecular SDLO 192C able to report all students' interactions within or between Atomic SDLOs 191C to other Atomic SDLOs 191C and/or to the LMS. The assembly of Atomic SDLOs 191C is governed by a learning design script, optionally utilizing the managerial component 193C of the Molecular SDL 192C, which may be pre-set or fixed or conditional (e.g., pre-designed with a predefined path, or develops according to student interaction). In some embodiments, Atomic SDLO 191C may by itself be assembled by a learning design script from assets 196C (e.g., multimedia items and/or textual content).

In some embodiments, a content generation module 197C (e.g., which may optionally be part of the content development tools 124C or other content generation environment or wizard) may assist the teacher to create educational content answering students need as reflected by the CAA sub-system 170C, using tagged templates 194C, layouts 195C and assets 196C. The Atomic SDLO 191C or the Molecular SDLO 192C may be the building block; a conditional learning design script may be used as the “assembler”; and a wizard tool helps the teacher in writing the design script. In some embodiments, the content generation wizard may be implemented as a fully automated tool.

For demonstrative purposes, some Atomic SDLOs 191C and Molecular SDLOs 192C are discussed herein; other suitable combinations may be used in conjunction with some embodiments.

For example, a learning activity may be implemented using a Molecular SDLO 192C which combines two Atomic SDLOs 191C presented side by side, thereby presenting and narrating the text that appears on a first side of the screen, in synchronization with pictures or drawings that appear on a second side of the screen. The images are presented in the order of the development of the story, thereby providing the relevant hints for better understanding of the text. The synchronization means, for example, that if the student commands the student station 101C to “go back”, or “rewinds” the narration of the text, then the images accompanying the text similarly “goes back” or “rewinds” to fit the narration flow.

In another demonstrative example, a “drag and drop” matching question may be implemented as a Molecular SDLO 192C. For example, two lists are presented and the student is asked to drag an item from a first list to the appropriate item on the second list. Alternatively, textual elements may be moved and/or graphically organized: the student is asked to mark text portions on one part of the screen, and to drag them into designated areas marked in the other part of the screen. The designated areas are displayed parallel to the text, and are titled or named in a way that describes or hints what part of the text is to be placed in them. The designated areas may optionally be in a form of a question that asks to place appropriate parts of the text as answers, or in the form of a chart that requires putting words or sentences in a specific order, thereby checking the student's understanding of the text. When the student finishes, the system may check the answers and may provide to the student appropriate feedback. Correct answers are marked as correct, while incorrect answers may receive “hints” in form of “comments” or in the text itself by highlighting paragraphs, sentences or words that point the student to relevant parts of the text.

In other demonstrative embodiments, a Molecular SDLO 192C may present an exercise in which the student is asked to fill in blanks. When the student clicks on a blank, the “live text” module (described herein) highlights the entire sentence with the blanks to be filled. If the student cannot type the required words, he may choose to open a “word bank” that presents him with several optional words. The student may then drag the word of his choice to fill in the blank. The “live test” module checks the student's answers and provides supportive feedback. Correct word choices are accepted as correct answers even if they differ from the words used in the original text, and may be marked with a smiley-face. Incorrect answers may get feedback relevant to the type of mistake; for example, misspelled words may trigger a feedback which specifies “incorrect spelling”, whereas grammatical errors may trigger a feedback indicating “incorrect grammar”. Entirely incorrect answers may offer the student to use the “word-bank” and may provide a hint, or may refer the student to re-read the text.

In another demonstrative example, a learning activity asks the student to broaden the text by filling-in complete sentences that show her understanding or interpretations (e.g., describing feelings, explanations, observations, or the like). The blank space may dynamically expand as the student types in her own words. The “live text” module may offer assistance, for example, banks of sentences beginnings, icons, emoticons, or the likes.

In some embodiments, completion questions or open questions may be answered inside the live text portion of the screen, for example, by opening a “free typing” window within the live text or using an external “notepad” outside the live text portion of the screen. For example, the student may be asked a question or assigned a writing assignment; if she needs help, she may activate one or more assistance tools, e.g., lists that suggest words or ideas to use, or a wizard that presents pictures, diagrams or charts that describe the text to clarify its' structure or give ideas for the essay in form of a “story-board”. Upon performing of the filling-in operation, the completion operation, or the typing in response to an “open” question, the student selects a “submit” button in order to send his input to the system for checking and feedback.

In another demonstrative example, a Molecular SDLO 192C may be used for comparing two versions of a story or other text, that are displayed on the screen. Highlighting and marking tools allow the teacher or the student to create a visual comparison, or to “separate” among issues or formats or concepts. In some learning activities, marked elements may be moved or copied to a separate window (e.g., “mark and drag all the sentences that describe thoughts”). Optionally, marking of text portions for comparison may be automatically performed by the linguistic navigator component (described herein), which may highlight textual elements based on selected criteria or properties (e.g., adjectives, emotions, thoughts).

In some embodiments, the student is presented with an activity item, implemented as a Molecular SDLO 192C, including a split screen. Half of the screen is presenting an Atomic SDLO 191C showing a piece of text (story, essay, poem, mathematic problem); and the other half of the screen is presenting another Molecular SDLO 192C including a set or sequence of Atomic SDLOs 191C that correspond to a variety of activities, offering different types of interactions that assist the learning process. The activity item may further include: instructions for operation; definitions of step by step advancing process to guide students through the stages of the activity; and buttons or links that call tools, wizard or applets to the screen (if available).

The different Atomic SDLOs 191C that are integrated into a Molecular SDLO 192C may be “interconnected” and can communicate data and/or commands among themselves. For example, when the student performs in one part of the screen, the other part of the screen may respond in many ways: advancing to the next or previous screen in response to correct/incorrect answers; showing relevant information to the student choices; acting upon students requests; or the like.

The different Atomic SDLOs 191C may further communicate data and/or commands to the managerial component 193C which may modify the choice of available screens or the behavior of tools. The Molecular SDLOs 192C may communicate data to the various modules of the LMS such as the CAA sub-system 170C and/or its logger component, its alert generator, and/or its dashboard presentations, as well as to the advancer 181C.

In some embodiments, for example, in an activity in the language arts, one part of the screen may present to the student the text that is the base for the learning interactions, and the other part may provide a set of screens having activities and their related learning interactions. The student is asked to read the text, and when he indicates that he is done and ready to proceed, the other part of the screen will offer a set of Atomic SDLOs 191C, for example, guiding choice questions, multiple choice questions, matching or other drag-and-drop activities, comparison tasks, closes, or the like.

The questions may be displayed beside the text or story, and are utilized to verify the student's understanding of the text or to further involve the student in activities that enhance this understanding. If the student makes a wrong choice or drags an element to a wrong place, the system may highlight the relevant paragraph in the text, thereby “showing” or “hinting” him where to read in order to find the correct answer. If the student chooses a wrong answer for a second time the system may highlight the relevant sentence within the paragraph, focusing him more closely to the right answer. Alternatively, the system may offer the student “smart feedback” to assist him in finding the answer or hints in a variety of formats, for example, audio representation, pictures, or textual explanations. If a third incorrect answer is chosen by the student, the correct answer is displayed to him, for example, on both parts of the screen; in the multiple choice questions area, the correct answer may be marked, and in the text area the correct or relevant word(s) may be highlighted.

At any stage of the activity, the student may call for the available tools, for example, marking tools, a dictionary, a writing pad, the linguistic navigator (described herein), or other tools, and use them before or during answering the questions or performing the task.

When finished with any part of a task, question or assignment, the student may ask the system to check his answers and get feedback. An immediate real-time assessment procedure may execute within the Molecular SDLO 192C, and may report assessment results to the student screen as well as to managerial component 193C which in turn may offer the student one or more alternative Atomic SDLOs 191C that were included (e.g., as “hidden” or inactive Atomic SDLOs 191C) in the Molecular SDLO 192C and present them to the student according to the rules of the predefined pedagogic predefined schema. For example, if the student fails certain type of activities, he may be offered other types of activities; if the student is a non-reader then she may get the same activity based on narrated text and/or pictures; if the student fails questions that indicate problems in understanding basic issues, he may be re-routed to fundamental explanations; if his answers indicate lack of skills, then he may get exercises to strengthen them; or the like.

When the student's basic understanding of the text is verified, he is assigned more advanced or complicated tasks. These may include, for example, manipulation of the original text, comparison or differentiation between texts, as well as “free-text” or open writing tasks.

One or more of the activity screens may offer open questions or ask for an open writing assignment. A writing area may be opened for the student, and the assisting tools may further include word-banks, opening sentences banks, flow-diagrams, and/or story-board style pictures. In case of open questions or writing assignments, the student may submit his work to the teacher for evaluation, assessment and comments. The teacher's decision may be used by the managerial component 193C and may be entered as a change parameter to the pedagogic schema.

The pedagogic schema may indicate or define the activity as a pre-test or as a formal summative assessment event (post-test). In this case, some (or all) of the assisting tools or forms of feedback may be made unavailable to the student.

In some embodiments, for example, in a mathematics activity, one part of the screen may include the situation or the event that is the base for the learning interactions or for the problem to be solved (e.g., an animated event or a drawing or a textual description); whereas the other part of the screen may include a set or a sequence of Atomic SDLOs 191C having activities, tasks, and learning interactions (e.g., problem solving, exercises, suggesting the next step of action, offering a solution, reasoning a choice, or the like).

Any part of the activity may be a mathematic interaction tool; it may be the main area of activity, instead of the “live text” in the case of language arts. For example, a geometry board may allow drawing of geometric shapes, or another mathematic applet may be used as required by the specific stage of the curriculum (e.g., an applet that allows manipulation of bars to investigate size comparison issues; an applet that serves for graphic presentation of parts of a whole; an applet that serves graphical presentations of equations). These applets may be divided into two parts: a first part that displays the task goals, instructions and optionally its rubrics; and a second part that serves as the activity area and allows performing of the task itself (e.g., manipulating shapes, drawing, performing mathematic operations and transactions). Other Atomic SDLOs 191C may be presented beside the mathematic interaction tool, and they may present guiding questions or may offer a mathematics editor to write equations and solve them. The student may utilize available tools (e.g., calculators or applets), or may request demonstrative examples.

Student's answers may be used, for example, for assessment; to provide feedback and/or hints to the student; to transfer relevant data to the managerial component 193C; to amend the pedagogic schema; to modify the choice of alternative Atomic SDLOs 191C from within the Molecular SDLO 192C, thereby presenting new activities to the student.

Reference is made to FIG. 3B, which is a schematic flow-chart of a method of automated or semi-automated content generation, in accordance with some demonstrative embodiments. Operations of the method may be used, for example, by system 100 of FIG. 1A, and/or by other suitable units, devices and/or systems.

In some embodiments, the method may include, for example, selecting a screen layout (bock 305B).

In some embodiments, the method may include, for example, selecting a template based on (tagged) contribution to skills and components (block 310B). In some embodiments, multiple templates may be selected, for example, to construct a multi-atom screen.

In some embodiments, the method may include, for example, selecting a layout (block 315) and filling it with data contributing to topic and factual knowledge (block 320B). The resulting learning object may be activated (block 325B).

In some embodiments, the method may include, for example, logging the interactions of a student who performs the digital learning activity (block 330B).

In some embodiments, the method may include, for example, performing CAA to assess the student's knowledge (block 335B). For example, the student's progress is compared to, or checked in reference to, the required learning outcome or the required knowledge map.

This may include, optionally, generating a report or an alert to the teacher's station based on the CAA results.

In some embodiments, the method may include, for example, activating an adaptive correction content generation tool or wizard (block 340B).

In some embodiments, the method may include, for example, selecting a template, a layout, and a learning design script (block 350B). This may be performed, for example, by the content generation tool or wizard.

In some embodiments, the method may include, for example, assembling a Molecular SDLO (block 360B), e.g., from one or more Atomic SDLOs.

In some embodiments, the method may include, for example, filling the Molecular SDLO with data contributing to topic and factual knowledge (block 370B), e.g., optionally taking into account the CAA results. The molecular SDLO may be activated (block 380B).

In some embodiments, the method may include, for example, repeating the operations of blocks 330B and onward (arrow 390B).

Referring back to FIG. 1c, system 100C may utilize educational content items that are modular and re-usable. For example, Atomic SDLO 191C may be used and re-used for assembly of complex Molecular SDLO 192C; which in turn may be used and re-used to form a learning unit or learning activity; and multiple learning units or learning activities may form a course or a subject in a discipline.

In some embodiments, rich tagging (e.g., meta-data) attached to or associated with each Atomic SDLO 191C and/or each Molecular SDLO 192C may allow, for example, re-usability, flexibility (“mix and match”), smart search and retrieve, progress monitoring and knowledge mapping, and adaptive learning tasks assignment.

In some embodiments, educational content items may be based on template 194C and layouts 195C and may thus be interchangeable for differential learning. Instances may be created from a “mold”, which uses structured design(s) and/or predefined model(s), and controls the layout, the look-and-feel and the interactive flow on screen (e.g., programmed once but used and re-used many times). Optionally, singular educational content items may be used, after being tailor-made and developed to serve a unique or single learning event or purpose (e.g., a particular animated clip or presentation).

In some embodiments, an Atomic SDLO 191C corresponds to a single screen presented to the student; whereas a Molecular SDLO 192C (or an “activity item”) may include a set of multiple context-related content objects or Atomic SDLOs 191C. Optionally, a ruler or bar or other progress indicator may indicate the relative position or progress of the currently-active Atomic SDLO 191C within a Molecular SDLO 192C during playback or performance of that Molecular SDLO 192C (e.g., indicating “screen 3 of 8” when the third Atomic SDLO 191C is active in a set of eight Atomic SDLOs 191C combined into a Molecular SDLO 192C).

In some embodiments, content items may have a hierarchy, for example: discipline, subject area, topic, unit, segment, learning activity, activity item (e.g., Molecular SDLO 192C), atom (e.g., Atomic SDLO 191C), and asset. Each activity item may correspond to a High-Level Task (HLT) which may include one or more Atomic SDLO 191C and/or one or more Molecular SDLO 192C (e.g., corresponding to tasks). Each Molecular SDLO 192C, in turn, may include one or more Atomic SDLOs 191C. In some embodiments, other types of hierarchy may be used, for example, utilizing HLT, tasks, sub-tasks, tasks embedded within other tasks, Atomic SDLOs 191C included within tasks or sub-tasks, or the like. In some embodiments, a HLT may include other combinations of atomic educational content items and/or tasks. In some embodiments, a HLT may correspond to a digital learning object which communicates with the LMS and manages the screens that are displayed to the student.

In some embodiments, the system may be adapted for utilization by different types of users, for example: (a) content developer or content generator, who has all the described functions available to him, or most of them according to his functional rights or authorization level (e.g., being an Instructional Designer, or Techno-Pedagogue, or Content Producer); (b) content editor (e.g., a teacher) who may have limited options or functions of the system (e.g., may be able to do changes such as replacing assets or data, but may not be able to change behavioral definitions); (c) content user (e.g., a student) who may not modify content directly, but may influence the content and may indirectly cause changes to the educational content by different interactions that trigger predefined automated behavior, causing the system to follow rules set by the content developer; (d) content certifier, for example, a person who certifies content created by a user or by a third party. Other suitable types of users may utilize the system.

In some embodiments, for example, the content development tools 323 of FIG. 3A may include, or may be associated with, or may be implemented as, a content development environment 399 and/or one or more CG tools 398. These components may include multiple modules, for example: a content developer module; a content editor module; an automatic adaptive module (placed in the DTP/LMS); and a content certifier module. In some embodiments, optionally, the content editor module may be implemented as extension of the teacher station. Some embodiments may include placement of the CGE in the development or production section of the system; publishing of generated content (e.g., not only saving) to the published content repository; and the repository from where the DTP or LMS calls LOs into the curriculum or lesson plan.

In some embodiments, “TE” may indicate a Template Editor which may be a CGT that its focus is a specific template of the learning system. “P&D” may indicate Parameters and Data. “P&D Form” may indicate parameters and data form, into which the user may enter parameters and data, typically having one form per atom; the form contains a specific editor, which is defined per template. “Content” as used herein may include, for example, the entire instance defined by the tool; and/or the content part of the instance, as opposed to the presentation part; and may include data and parameters. “Atom” may include an instance of an atom template. “Screen” may include the display of a number of elements together; for example, an Atom may be in one screen. “Container” may be an object that exists in the present implementation, which controls all the Atoms and Screens. “LO” may indicate a Learning Object, namely, a container with its descendant Atoms; and may also be referred to as an Instance or a System Instance. “Student Instance” may include an instance of the learning system which has interacted with a student, and has specific data from the interaction with the student. “AI” may be an Activity Item, an element referenced from the curriculum; for example, an Office application, a URL, or an LO (for example, a SWF application, a Shockwave application, a Flash application). “Asset” may be an audio and/or visual and/or graphical element which, when added to an atom template, results in an atom (although other elements, such as parameters, may be needed to create an atom). “LCT” may indicate a Layout Catalog Tool. “Main Atom”, in the context of a task (a screen with an applet and accompanying atoms) may be the main atom is the applet. “Additional Atoms”, in the context of a screen, may be atoms that have floating layouts. “Single Atom” or “One-Atom Screen” may include a screen that is occupied by a single atom that covers the entire screen real estate. “Multi-Atom Screen” may be a screen that is composed of several atoms, and may be referred to as a Task. In some embodiments, a multi-atom screen may be a Task; in other embodiments, a multi-atom screen may not be a Task, for example, a multi-atom screen focusing on presentation of information items, and optionally not requiring or involving interaction or response. “Task” may be a pedagogical entity with defined didactical objectives; the basic building block contained in a Task is an Atom; since there is logic to dividing a task into sub-tasks, a Task may also contain other Tasks; a sub-task is also a Task. “Interactive Task” or Reactant Task or Inter-Reactive Task may indicate that some or all of the atoms of a task may be able to interact with each other, namely, to transfer input and generate output, be exposed together, and/or have any other type of interaction. “Applet” may include a system template, which has a sandbox area and a set of tools for the student to use; the applet may typically be accompanied by atoms that provide information and guidance regarding the task, and in some cases may interact with the applet.

“Interactive Atom” indicates an atom that may provide output or receive input to or from another atom; typically an interactive atom may send or receive information to or from an applet. In some embodiments, a “Task” may be a general term for a multi-atom screen.

In some embodiments, the system may create LO screens with a single atom only. In other embodiments, the system may allow users to generate LOs via the CGT with screens that are encompassed of several atoms. Furthermore, the users may associate atoms that interact together and define the interaction type.

In some embodiments, the content generator may create multi atom screens for an LO created in the CGT. The pedagogical team and GUI may provide a task catalog with all the available tasks per discipline. The pedagogical team and GUI may provide a “screen layout” catalog for each of the available tasks. The pedagogical team and GUI may also provide an alternative assets repository.

In some embodiments, LO Mapping area is on the left side of the screen, and displays the hierarchy of the LO. The hierarchy has three levels: (a) LO—top of the tree; only one; (b) Screen—children of LO, number is unlimited; and (c) Atom—child of Screen (in the simple case, each Screen has one Atom child; in Multi-Atom, each screen has a number of Atom children). In some embodiments, each screen generated in the CGT will be assigned with a unique ID; screen will be tagged in the tree as <Screen N>. An “Add screen” button will change its functionality into an “Add atom” button when the user had selected the screen type to be “Multi-atom” or Task and later selects a screen layout. Selecting a basic type screen will result in the automated addition of one and only atom to the screen. The “Add new atom” button will be disabled after a single atom has been added to the “Single atom” screen. The user will be able to add a new screen at this point. In multi atom or task screens, the active element is an atom, not a screen; CGT will add the new atom to the screen that is the active atom's parent.

In some embodiments, CGT has a “Duplicate” button. When the active tree element is the screen, clicking the “Duplicate” button will replicate the screen and its children atoms with any parameters and data that have been defined. The new screen and its atom will be displayed on the LO Mapping. When the active tree element is an atom, clicking the “Duplicate” button will replicate the atom with all the relevant parameters and data. This procedure will take place on the tree yet the duplicated atom will be kept in the non assigned atoms bank. When a screen is the active element, the “Move Up” and “Move Down” buttons on the tool bar will be enabled. Pressing these buttons will cause the screen to be moved up or down in the order of the screens. Atoms may be handled differently. If there is no screen or only one screen, the buttons are disabled. If the active screen is the first, the up button will be disabled. If the active screen is the last, the down button will be disabled. The delete button will change its functionality according to hierarchy of the selected tree node; by selecting the appropriate node the user will be able to delete the LO, the Screen or the atom respectively. In some embodiments, the first applet in the task screen may not be deleted; and, in the single atom screen, the user may not delete the atom, only the screen. In some embodiments, if the user clicks the “Delete” button, CGT will ask for confirmation. If confirmed, the presently active screen will be deleted, atoms included; and the previous screen will become the active screen. Focus will turn to the screen used to be second if the first screen is the one to be deleted. In some embodiments, deletion of an atom in the context of the multi atom screen or a task screen may result in a change of the exposure order or the design of the panel in which the atom was situated. The subsequent atoms may shift according to the orientation of the panel. In case the orientation is vertical, the atom will shift up. In case the panel orientation is horizontal, the atom will shift to the left or to the right according to the selection of navigation direction.

In some embodiments, the following data may be displayed in the popup of selecting layout: Field Name; Layout Name; Layout Direction. In some embodiments, three types of Layout may be used: (a) Layout for a Single atom that occupies the screen; the atom will be defined as a full screen atom; (b) Screen Template—a framework for atom placement; and (c) Screen and Atom Layout—predefined layouts that provide specifications for placement and the code of the atoms layout (e.g., a Screen and Atom Layout may have more pre-defined settings or information, relative to only a Screen Template). In some embodiments, each screen layout template, and Screen and atom layout, may have a unique code that may be generated in the CGT. The user may be able to view all three types of layouts as thumbnails, and filter the provided layouts according to the specification of screen template and atom size. The user may be able to filter the screen template layouts according to the main applet that may reside within a certain section of the screen template.

In some embodiments, the system may utilize Pedagogic Meta Data. For example, the CGT allows comprehensive tagging of all content elements (LOs, Tasks, Atoms, or the like with pedagogic meta-data. Some tagging may describe the content element correlation with (and adherence to) one or more standards set by education authorities (e.g., National core standards, or State specific requirements). Some tagging may describe the relevancy of the content element to the method of learning (e.g., individual, in pairs, in small groups). Some tagging may describe the level of difficulty of the content in a specified learning context. Some tagging may describe the assessment rubrics for assessing the student response and parameters for grading it. The tagging may serve search and retrieval of content elements for assembling LOs for any set goal of lesson (or learning flow), whether manually or automated. The tagging may also be used for research or statistical purposes; for example, to determine what percentage of executed LOs were executed individually or in pairs; what percentage of executed LOs were such that adhere to pedagogical standards; or the like.

In some embodiments, screen metadata may resemble the atom metadata. The metadata for the screen may be inherited from the LO (in terms of association, not physical inheritance). In some embodiments, a screen and atom “Search/Import” function may be used. For example, in order to allow the user to search screens, a screen and its atom may be considered as an entity, and all the data regarding the screen and its atoms may be saved in the CGT database. The screen layout template code and the layout code for screen atoms may be stored in the database for search purposes. The screen and its atom may inherit the metadata of the LO, thus allowing the search of the screen or the atom using the same search parameters of the LO. Search results for screens (including atoms) or atoms may be presented as thumbnails. A user may be able to search a screen by template type. Import of a screen may be evoked from the LO level for the screen and from the screen level for the atom; in both cases, a search window for screen or atom will open. In some embodiments, LO Metadata that may be inherited by the screen may include, for example: Production ID; LO name; Topic; Region; Grade Level; Subject Area; Production batch file ID; Production batch file name; Status; Stage; Updated by; Updated on; or the like.

In some embodiments, automation in content building may be used; for example, as demonstrated in FIG. 3B. For example, an entirely automated or semi-automated process may be used through the utilization of automated content generation application (or semi-automated, by the use of step-by-step wizards). This may be achieved through proper concept-tagging of all (or most, or some) content building blocks, and by using a form or questionnaire or other suitable structure for definition of the aims of the LO to be developed, a form or questionnaire which may be efficiently filled-out by the user. The tagging may include, for example, tagging for contribution to skill and competencies, tagging for contribution to topic and factual knowledge, or the like. Based on the aims/goals definition, the system may select and assemble: (a) templates and layouts suitable for enhancing the defined skills and competencies, and perform a smart selection of other elements (e.g., atoms, or applets) needed for generating the piece of educational content to serve the defined learning process; and according to the tagging, suitable atoms may also be selected and placed in the template. (b) Filling the atoms with suitable assets, selected from the assets repository based on definition of topic or subtopic to be taught, and selecting the proper assets based on the tagging of these assets.

In some embodiments, the preview button may change its functionality according to the LO tree hierarchy level. At the LO level the play button will function as a play LO button, namely it will play the LO from start to end, “End screen” included. In case the user will select the screen level, the preview button will function as a screen preview button. In case the screen is a single atom screen, the screen and atom preview may be the same. The user may be able to preview a single atom by selecting the specific atom at the tree and clicking the preview button.

In some embodiments, a “Validate” button may allow the user to perform validation. If the active element is an atom, validation may be done on the currently active atom. If the active element is a screen, validation may be done on the currently active screen. If the active element is the LO, validation may be done on the entire LO. In some embodiments, a screen will not play if one of its atoms is critically invalid. When the “Validate” button is clicked or upon preview, the following validation may be performed on all the atoms in the active screen: (a) All assets are defined and available in the repository; (b) All mandatory parameters have been defined; (c) there is no inconsistency between definitions entered in the form and definitions derived from the layout. If validation fails, the CGT will pop-up a screen with the validation errors. The screen is a modal window and has a close button to close it. CGT will mark the screen as invalid. In some embodiments, the error message may provide the following information: At which level the error occurs, namely whether the invalid element is in the LO, the screen or at the atom level; In which tab the error occurred; What was the field the error was found in; A description of the error. In some embodiments, validation performed before packaging may validate all screens. On error, the display may be as above. Upon any change to the screen, validations before preview/play, save or package may be preformed again. In some embodiments, an LO with atoms that were not assigned to a screen may not be package-able—the user may remove these atoms following the alert “Not all atoms were assigned to a screen; remove these atoms before you package the LO”; however, saving may be allowed.

In some embodiments, in multi atom handling, the CGT may allow the user to determine that two or several atoms may interact (have Input/Output relations).

In some embodiments, the user clicks the “New Screen” button to open the “Add new screen” wizard. By clicking the “New screen” button, the user will create a new screen node in the LO tree. This window may pop-up once the user clicked the “New screen button”. The user may select a screen type; the default may be “Single atom screen”. The user may be presented with three screen type options: (a) Single atom—An atom layout that occupies the entire screen; (b) Simple Multi atom—a screen that may encompass several atoms of the same template, or a combination of several atoms of different templates; in this case no main applet is selected; and (c) Task—A multi atom screen, dedicated to one main applet and several satellite atoms. In some embodiments, single atom screen will be selected as a default. The user may select an LO Template from the list of thumbnails; the list of supported LO templates may be configurable to allow the dynamic update of the template pool. In some embodiments, the user selects a single atom layout filtered according to the desired template type.

In some embodiments, the user may see the layouts in accordance with the selection of LO template in the previous window. The layouts may be represented as thumbnails. Layouts may be filtered according to the “Subject area” language settings (e.g., left-to right (LTR) or right-to-left (RTL)).

In some embodiments, the user may customize the layout. For example, following the selection of the layout, the user may navigate to the layout customization window, or may close the window in case the template is not permissive of layout customization.

In some embodiments, the user may select the (non-applet driven) multi atom screen. The user may select a screen layout. For example, the user may be presented with thumbnails representing possible screen layouts, with different panel arrangements. Later on, the user may define the atom layouts that will appear in each panel. Some of the layouts may be predefined specifying the placement of the atoms and their layouts.

In some embodiments, the system may allow selection of screen type or task type, in an applet driven screen. For example, the user may select the applet-driven screen; and the user may select the main applet for the screen. An icon may represent each LO task template (applet). The listed templates (LO templates) may be configurable to allow the dynamic update of the template pool. The list of templates may be applet oriented. The list of applet templates may be updated dynamically.

In some embodiments, the user may select an empty screen layout that correlates with the selected main applet. The user may select an empty screen layout that was filtered according to the main applet selected in the previous screen. The presented screen layout may already define the layout of the main applet or applets; there may be more than one applet in the screen, for example, two Live-Text atoms. Layouts may be filtered according to the “Subject area” language settings. For example in case an applet has both LTR and RTL layouts, the user may select layouts with appropriate directionality according to the selection of subject area.

In some embodiments, once the user selected the desired template and closed the screen layout selection window, the screen layout may be presented at the “Screen setup” tab. In case the user selected an applet task, the applet layout was already selected in the wizard—and any additional atoms may be of non-applet templates. In some embodiments, the user may not change screen layout.

In some embodiments, for a multi-atom screen, the user may click the “Add atom” button. Upon clicking the “New atom” button, the “New Atom” wizard will open. The user may select an area for atom placement. For example, upon clicking the “Add Atom” button, the user may be presented with the screen layout he selected by the screen layout selection process. The user may select a zone in which the process of atom placement will begin. Each atom layout may have a specified directionally (e.g., RTL and LTR). The atom layouts may be filtered according to their directionality in correlation to the navigation direction of the LO (defined by the subject area settings). In some embodiments, orientation of the panel may be saved as meta-data or may be inferred from the Height to Width ratio. For example, in case the orientation is horizontal, the exposure sequence of the atoms may be LTR or RTL, top to bottom. In case the orientation of panel is vertical, the exposure of the atoms may be top to bottom, LTR or RTL. Placement direction may be correlative to the selected screen layout (based on the navigation direction as defined by the subject area settings). For example, navigation direction LTR may translate to LTR placement and exposure direction of the atoms; whereas navigation direction RTL may translate to RTL placement and exposure direction of the atoms. A visual indication may appear in the screen template layout indicating the directionality of the panel in correlation to the LO.

In some embodiments, each zone may include one or more atoms. The size and orientation of the zone may filter the applicable atom layouts. In some embodiments, certain LO templates may not share the same screen; a configurable list may be kept to allow the CGT to filter out these templates.

In some embodiments, the user selects the atom template; for example, only one per round of atom placement. The user may select atom layout for the atoms; the layouts may be filtered from 1 to N, such that the smallest layouts will be up and the largest will be down. The height and width of each atom layout may be stored as metadata.

In some embodiments, the user may customize the layout in case the template supports layout customization. The user may repeat the action of adding atoms, until all the desired atoms have been added in some embodiments, the system may determine that the area has no more room for atoms. In case the user attempt to add another atom to a zone that had been completely filled with atoms, an alert may indicate that the panel is full and that the atom may not be fitted in now (optionally, it may be fitted in later). The system may also handle the user attempting to add an exceeding atom or change (or replace) the atom layout. In some embodiments, the user may select the atom layout when adding an exceeding atom or replacing layout; and the user may customize the layout when adding an exceeding atom or replacing layout. In some embodiments, the user may swap an atom from the screen with an atom selected from a bank or repository of atoms. In some embodiments, atoms that did not fit in the panel may be represented by an icon in an “Exceeding Atoms” pane; and may also have a different representation in the tree. By selecting the atom in the atom bank, the panel which corresponds to the atom size may be marked (highlighted). When the user selects an atom in the screen setup pane or atom bank, the relevant atom node may be marked (highlighted) in the tree. In some embodiments, the system may show an atom layout graphical object (e.g., JPEG image) representing each atom upon mouse over. In some embodiments, atoms may be placed only in panels that fit their size.

In some embodiments, the user may swap the atoms from the screen and the “Exceeding atom” pane. By clicking the atom in the “Exceeding atom” pane, the region into which the atom can fit will be highlighted. In case this atom is equal to N atoms in size, insertion of this atom will result in replacement of several atoms. The user may add a new screen with an appropriate screen template layout, and later move the exceeding atoms into the new screen. The addition or replacement of the exceeding atoms may be allowed only to panels with appropriate sizes. The atoms that will be moved to another screen may also be transferred to the “Exceeding atoms panel”. If the user attempts to package an LO in which not all the atoms were assigned to a screen, the user may be alerted that “Not all atoms were assigned to a screen, remove these atoms before you package the LO”.

In some embodiments, a multi atom screen may allow interactivity and ordering; and the sequence of atom exposure may be presented on the atoms themselves (namely, on their representations). For example, the order of appearance of atoms may be reflected on the atoms as they are numbered from 1 to N. In some embodiments, the user may group multiple atoms to be exposed together, by checking their checkbox and clicking the group button, so that several atoms may be exposed as a group.

In some embodiments, a content item (e.g., an atom) may be associated with an Exposure ID parameter, to indicate the order or the timing in which the content item is to be displayed on the screen. In some embodiments, the Exposure ID may utilize sequencing, such that an item having a sequence ID of “4” is to be exposed after an item having a sequence ID of “3”; and such that several items, each one having an Exposure ID of “6”, are to be presented together or substantially simultaneously. In some embodiments, the Exposure ID may include, or may be structured to utilize, other type of information; for example, absolute data or relative data or set-off data (e.g., expose a certain atom 28 seconds after initiation of the screen, or 12 seconds after exposing another particular atom; or 14 seconds after a pre-defined condition or interaction occurs). In some embodiments, the Exposure ID or other sequencing parameter may indicate a Direction of Exposure (e.g., left to right, top to bottom). Other suitable exposure schemes may be used.

In some embodiments, the logic of exposing atoms may be, for example: The first to N atom may be exposed together at a first sequence appearance. In some embodiments, the following atoms may be exposed sequentially, and may not be grouped. In some embodiments, the user group atoms that do not have an “Exposure ID” of zero, namely, only atoms that are adjacent to the first atom may become a group. In some embodiments, each atom may be associated with an Exposure ID. In some embodiments, non-interactive atoms may not follow interactive atoms. In some embodiments, the user is alerted in case of an attempt to expose two atoms together in which the first is interactive and the second is non-interactive, or to group non consecutive atoms. In some embodiments, the interactive atom list may be configurable. In some embodiments, the “group” button may change its functionality to “ungroup”, to allow a user to un-group atoms.

In some embodiments, the user may rearrange the atoms in the panel. For example, the user may change the location of the atoms by selecting the atom and directing it to the new location, using drag and drop. The relocation may follow rules, for example: The atom that previously occupied that position will shift according to the selected exposure directionality. In case the directionality is top to bottom, the atom will be shift down. In case the directionally is LTR, the atom will shift to the right. In case the directionality is RTL, the atom will shift to the left. The replacement in the location of the atom may be limited to the panel in which the atom was placed, namely, the user may not drag atoms in between panels. In some embodiments, the user may not relocate atoms in case he grouped several atoms; he may ungroup atoms first, relocate and then regroup if allowed by the grouping rules. In some embodiments, the new order may not be reflected in the tree.

In some embodiments, the system may allow the user to change the selected atom layout or template. For example, for changing of layout in single atom screen: the user may click the “Select layout” button and select a different layout. The user will be alerted that he may lose existing content. To replace the layout of an atom, the user may select the atom node on the LO tree and may click the “Select layout” button in the layout tab. The panel in which the atom resides may be selected to allow the replacement of the previous layout to one with the same width (vertical panel) or height (horizontal panel). In case the layout was larger than the previous, it may cause existing atoms to be moved to the “exceeding atoms” bank. In some embodiments, the user may be alerted that “When you change the layout, you may lose existing content”, and that “Any subsequent atoms that may not fit in, will be transferred to the exceeding atoms bank”.

In some embodiments, the system may allow Copy, Cut and Paste of atoms. For example, the user selects an item in the LO tree and clicks the “copy to” button, or the “move to” button. In some embodiments, a “copy to” or “move to” dialog may be opened and used, to allow the user to select destination (e.g., for an atom—a screen; for a screen—the LO). Similar, or other, methods may be used to allow the user to move or copy atoms and/or screens. In some embodiments, an atom added to a screen yet will not be assigned to a specific place; but rather, this atom will be found in the atoms bank.

In some embodiments, the system may allow to delete a screen or an applet atom in a task screen. In some embodiments, the user may not be able to delete the first applet in a screen; the delete button may be disable and may include a tooltip, such as “Main applet may not be deleted”. With regard to deletion of an atom in a single atom screen, the user may only delete the screen, but the user may not be able to delete the atom; the “delete” may be disabled, with a tooltip indicating “To remove this atom, delete this screen”.

In some embodiments, Applet templates may not be included in the Single atom screen.

In some embodiments, the system may handle navigation direction and layout directionality. For example, in case the user changed, while attempting to preview the screen or LO or by clicking the validation button, the system may indicate that this state is invalid (Layout directionality and Navigation direction are not aligned); and the layout may be changed according to the current navigation direction.

In some embodiments, the Atom layout may be too large for the selected panel, and a warning may be generated. For example, the user may attempt to add a new atom, yet the panel is full, and thus an alert is generated. In case the panel is full, the user may be alerted that the added atom will be placed in the exceeding atoms bank (which may include, in some embodiments, up to a maximum number of atoms, e.g., five). In case the panel is not full and the user progressed to the layout selection stage, and then selected a layout that will take more than the available space, the user may be alerted; and the atom may be placed in the exceeding atoms bank.

In some embodiments, navigation direction validation may be used. For example, the CGT may allow the user to navigate to the atom by double-clicking the atom in the screen setup panel. In some embodiments, the system may replace atom layout when inserting an atom from the bank. For example, the user may insert an atom to a panel which does not fit its size; and the user may continue to the change layout screen.

In some embodiments, the user may swap the atoms from the screen and the “Exceeding atoms” pane. For example, by clicking an atom in the “Exceeding atoms” pane, the region into which the atom can fit will be highlighted. In case this atom is equal to N atoms in size, insertion of this atom may result in replacement of several atoms. The user may voluntarily drag atoms from the screen to the atom bank. In case the user dragged the atom and placed it on top of the atom(s) in the panel, the atoms may be removed. In case the user placed the atoms above the first atom (not on top) or in between, and the insertion of this atom may cause the panel to be overloaded, then the GUI behavior of the atoms may indicate that the panel is full; and the user may then remove an atom and replace it with the desired atom(s). If the user decides to insert a misfit atom into a panel, a message may ask the user whether he would like to change the atom layout in order to fit in this atom. If the user confirms, the user may be taken to the “change atom layout” wizard. In some embodiments, the “group” button may be disabled as long as a single atom is marked; and may be enabled once two or more atoms are selected.

In some embodiments, relocation of one or more atoms that belong to a group may break that group. In some embodiments, in a multi atom screen, only the last atom in a group of atoms exposed together may have active Guidance tab, and Feedback and Advancing tab. In some embodiments, the user may replace or change the screen background provided by the subject area theme; a “replace default screen background” checkbox may be disabled by default, and may be enabled by the user. In some embodiments, the user may replace the end screen background provided by the subject area theme; a “replace default end screen background” checkbox may be disabled by default, and may be enabled by the user. When a “Replace different background” checkbox is checked, the user can replace the background for this screen. In some embodiments, a role management for background approval may be incorporated.

In some embodiments, CGT is a tool to allow Pedagogues and Techno-Pedagogues to produce content for the schools without having to use Content Feeding services. CGT may allow teachers to produce content. It allows building the content immediately after the “cracking” of a pedagogue problem is complete, and allows the confirmation of such “cracking”.

In some embodiments, “Task” may include a closed interaction that has a defined didactical rational/objective; a Task contains Atoms or other tasks. A “Highest Level Task” (HLT) may indicate the Task that communicates with the LMS, and has no Task siblings. “Atom” may include an instance of an atom template. “Screen” may be the display of one or more of elements together. “Container” may be an object that controls all the Atoms and screens; a container may be equivalent to an HLT whose children are all Atoms. “Learning Object” (LO) may be an HLT with all its descendants, namely Atoms and optionally Tasks. “Student Instance” may be a system instance, which has interacted with a student, and has specific data from the interaction with the student. “Activity Item” (AI) may be an element referenced from the curriculum; e.g., an Office application, a URL or hyperlink, or an LO (for example, a SWF application or applet).

The CGT may be used to create LOs, using: Existing assets; Existing Atom templates; an existing Task template (Container); Existing layouts for the Atoms and the Task. The CGT may support the process of creation, including storing and reuse. The final product of the CGT may be suitable for referencing from the curriculum. The CGT has two possible types of implementation: (a) Presentation Driven (PD), based on a WYSIWYG approach (“what you see is what you get), and is usually considered to be the preferred way to build graphical objects; (b) Data Driven (DD), an implementation which uses a form to enter data, which can then be displayed using a specific command.

The CGT may use a Task. The container used may be a simplified Task, in which all Atoms are children of the one and only Task, which is also the HLT. In some embodiments, Screens are under control of the Container. In some embodiments, the educational content and its presentation may be separated. For example, one Atom instantiated from a template has a question of the type “Text”, and another Atom has a question of the type “Image”. The distinction between “Image” and “Text” may be a part of the Atom's content (e.g., a parameter—the type of the question; and data—the actual text or picture). The Dynamic Layout may (at least partially) disconnect the presentation from the content, and enable changing data and parameters without having to choose a new layout.

In some embodiments, the CGT may support, for example: Open Question; MC/MMC Question; Matching Question; Completion Question; Memory Game; and other suitable types of questions.

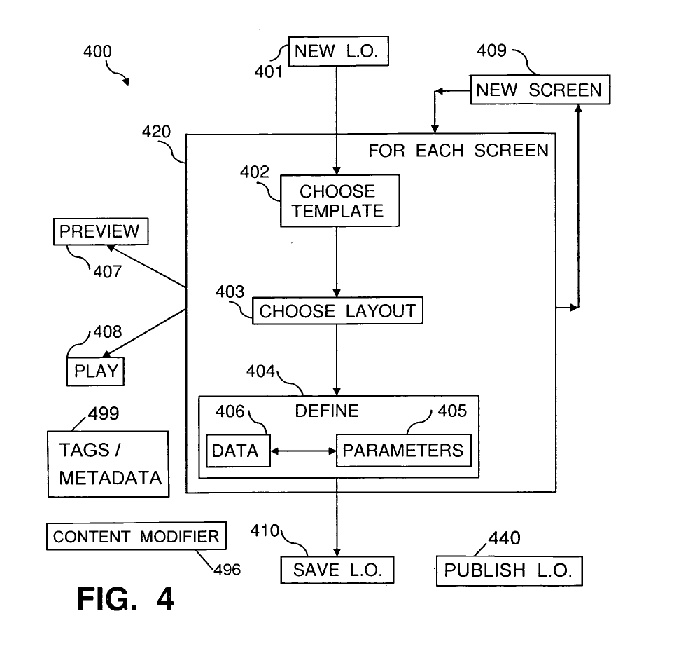

Reference is made to FIG. 4, which is a schematic illustration of a process 400 for creating a digital Learning Object (LO), in accordance with some demonstrative embodiments. For example, the user may select or instruct the CGT to create a new LO (401); then, a series of operations (420) may be performed per each screen of the LO being created; and the created LO (or the LO under development) may be saved (410). The creation process, per screen (420), may include: choosing a template (402); choosing a layout (403); and defining (404) the parameters (405) and the data (406). Optionally, one or more new screen(s) may be created or added (409) similarly, in the same LO; upon creating or adding a new screen, a layout for that screen may be selected. Each screen may be previewed (407) and/or played (408). The final LO may be saved (410), and may be published (440). Each component, element, or data item may be subject to tagging and/or may be associated with metadata (499). Other suitable operations may be used.

In some embodiments, the content development environment (or CG environment) may include content development tools (or CG tools). The content development environment may publish the educational content into a repository storing published content; and the repository may further store content from other sources (e.g., imported content from third parties, optionally certified to be in accordance with particular standards or to meet particular requirements). From that repository of published content, the DTP or LMS may call educational content items into the curriculum, may find them and retrieve them.

In some embodiments, the system may allow or provide automated spatial organization or adjustment of educational content items, or automated re-build of digital LOs, for different visual real-estate properties (for example, screen resolution, screen color-depth, screen orientation) due to difference among end-user stations or end-user devices (e.g., a desktop computer, a laptop computer, a netbook computer, a tablet computer, an iPad device, an iPhone device, an iPod Touch device, a smartphone, a mobile phone, a hand-held device, a PDA, an electronic book (e-book) reader device, or the like). For example, the system may utilize the automation capabilities of dynamic layouts, exposure order, rules of behavior (or pedagogic language) in order to re-render a digital LO that was developed for a certain screen properties, once the digital LO is in fact executed on another screen (e.g., a smaller screen having a lower resolution); or if the digital LO is to be executed within a smaller window of another application (e.g., if sold or transferred to a third party and executed in another LMS).

In some embodiments, for example, a digital LO may be originally designed to be executed on a large screen having a high resolution; but an automated process may adapt the digital LO to be executed properly on a small screen having a low resolution. In some embodiments, the smaller screen having the low resolution may not have sufficient space to display all the atoms, or all the screen elements, as originally intended. However, the system may analyze the pedagogic goals associated with the digital LO, as well as the parameters set by the content developer; and the system may thus re-arrange atoms (or screen elements) on the screen according to the screen constraints, while maintaining the same behavior rules. For example, a digital LO modifier or adapter module may automatically reduce font size; reduce space between elements; re-size or shrink multi-media windows and assets; and/or replace a first item on the screen with a second item (e.g., replace a first bitmap image of a boat, with a second, smaller, bitmap image of the same boat or of another boat). These operations may be performed by a content modifier module, for example, content modifier 396 of FIG. 3A, or content modifier 496 of FIG. 4, or a digital LO modifier, or a dynamic layout modifier, or other suitable component or module.

In some embodiments, if the above operations do not suffice for allowing display of all relevant elements on a single screen, then the digital LO modifier or adapter module may modify the order of appearance of items; for example: if some elements were intended to be displayed at once, side by side on a larger screen, then the digital LO modifier or adapter module may change the setting such that the items appear one after the other, or cascaded, or in floating windows, or in other structures). In some embodiments, the digital LO modifier or adapter module may divide or split the original screen into multiple successive screens, and may add buttons or links that allow going back and forth between the multiple screens, while maintaining the same pedagogic goals of the task.

In some embodiments, the system may be implemented as multiple systems, for example, a system of the operator, a system of the school district, a school-level system, or the like. In some embodiments, for example, the operator may maintain a system which may include, for example, a multimedia repository; a curricular components repository; a concepts ontology database; pedagogical metadata lists or database; a repository for curricular components; and optionally, a repository for third party content items. The operator's system may include a database of school profiles, and a distribution engine able to distribute educational content to school districts and/or to schools. Optionally, a school district may maintain a system which may be generally similar to the operator's system. Each school may maintain a system able to receive data from the school district and/or from the operator, the school system having similar components as well as local components (e.g., teacher's folder; lesson planning module). Optionally, a data center or content center may be used, storing the operator's content as well as User Generated Content (UGC), and having an interface allowing to search, retrieve, order, collaborate, and otherwise handle the educational content items. Other suitable implementations may be used.

In a PD implementation of the CGT, a new undefined LO is displayed. The user can (at any stage) request the opening of an existing LO. If relevant, CGT will request confirmation of loss of data from the current LO. If confirmed, or no confirmation needed, the requested LO will be displayed. This screen is opened when CGT is started, or a new instance is started. The screen is empty, except for displaying the elements that are defined at the level of the container (messages, buttons). The user may request to open a new screen, in the same instance. A new, empty screen is opened; previously defined screens maintain their present state, and user can return to them. User can navigate between the defined screens. The present screen can be deleted by pressing the “Delete Screen” button; CGT may request confirmation before deleting.

The first step in content generation may be the selection of the template. Once the template is selected, the CGT will enable the choosing of a one of the layouts of the template. Once the layout is chosen, the layout will be displayed, and the data can be entered into the fields displayed. In some embodiments, the CGT may define one template/layout on a screen; or more than one on a screen.

CGT displays a pull down menu from which the user can choose a template. CGT displays a pull down menu from which the user can choose a different template. Changing a template may cause loss of all data entered (except for data entered in fields which belong to Common Elements). The tool may warn about this and request confirmation before continuing. The tool interfaces to LCT. Using the LCT interface, the user chooses a layout. Pressing OK in CGT will cause the following actions to occur: (a) The interface with LCT will be closed; (b) The chosen layout will be displayed on the screen, with the ability of the user to enter data in all fields which can receive data

In some embodiments, data entered in the previous layout may be transferred to the new layout. If this cannot be done (e.g., previous layout had 5 answers entered and new layout only has place for 4), the CGT may warn and request confirmation before continuing. Parameters which are presently defined in the layout and do not belong to the presentation may be extracted and displayed on the parameter form; they will be read-only. As an option to selecting a template, the user may browse in the CGT repository and select an Atom that has been saved. If the Atom has only been partially defined, definition may continue from the point that it was stopped at.

In some embodiments, Content Feeding may include two parts: Data—includes text, images, movies, sounds, etc.; and Parameters—which is data that controls behavior of the template, such as number of attempts.

For template data, all data of the chosen template may be entered directly into the fields displayed from the layout. Each field knows the type of data that it expects, and will behave accordingly. This includes multi-lingual (e.g., Hebrew and English—or LTR and RTL). The user may type in the text directly, or use copy-paste. If there are constraints on the field from the layout (e.g., only digits, limit on the number of characters) CGT will enforce these constraints, and give the proper warning if the user tries to enter illegal text. The user will be able browse the file system of the defined repository to choose assets. The user can not enter assets that are not in the repository. If an asset catalog is present, the CGT may interface with it.

Each field which receives an asset has a definition for the type of asset that can be entered. CGT will enforce this definition, and give the proper warning if the user tries to enter an illegal asset. If a tool for asset requisition exists, CGT will interface with it. Alternatively, the user may fill out form to request a new asset. Optionally, if the asset does not exist, and has to be ordered, CGT will place a dummy asset in the field.

Template Parameters may modify the behavior of the atom. All parameters of the chosen template will be available to the user to enter. There are various attributes of the parameters, which are defined in the template along with defining the parameters. CGT will relate as follows: A parameter can be mandatory or optional; a parameter may have a default value; the value of a parameter may affect: (a) Other parameters (possibly making the other parameter relevant or irrelevant; possibly changing the legal values for the parameter); (b) Content fields (possibly making the field relevant or irrelevant).

At any point in defining the template content, the user can change to a tab where the parameters can be defined, and can return to the content screen. CGT will mark the mandatory parameter fields (there is also an effect on saving). CGT will display the default value (for parameters that have a default) at the opening of the parameter screen. If no default value exists, but this template has been used previously in the LO, the previous value will appear when opening the parameter screen. CGT will enable/disable or hide/show parameters according to the dependencies between them. CGT will erase or replace parameter values that have become illegal due to the dependency. CGT will enable/disable or hide/show content fields according to the dependencies on parameters; a warning may show what has changed due to the change in the parameter. CGT will erase or replace content values that have become illegal due to the dependency; a warning may show what has changed due to the change in the parameter. Each time one of the above is activated, CGT will save the present state of parameters/content before the change. If the user returns the parameter to the previous value, CGT will reset the changed values.

Some templates (such as Live Text) may have utilities which are used to define data. If a template has a utility to define data, CGT will be able to use the utility, and then store the data with the rest of the LO.

CGT may handle Multiple Atoms on Screen (e.g., a Geo-Board with questions). Adding Atom with Layout: CGT will display a button “Add Atom”, similar to the description previously above. Deleting an Atom: the user chooses the atom and presses the Delete button. CGT asks for confirmation, and then removes the atom from the screen. Changing Template, Layout: In order to change a template or its layout, the user will choose which template/layout he wishes to change, and then CGT will activate the relevant function. Content Feeding: For all the feeding defined, CGT will enable the user to choose which template to feed. Layout Placement: The user can choose a layout and drag it to its proper place; it may be defined if dragging is free, fixed to a grid, or both options. Atom Sequence: the user will be able to mark on the screen the order of the Atoms' appearance.

Layout Placement: having more than one template on a screen is used in two situations: (a) Applets, with questions; (b) A Static template, on which other atoms are placed, for progressive exposure. In both cases, there is a full-screen layout (Applet or Static). The other Atoms have layouts which are not full screen—these are Floating. There should be a full screen Atom; the full screen layout may not be moved; only the Floating layouts may be moved.

Common Data: there are fields common to all screens which are under the control of the Task/Container (e.g., messages, feedbacks, guidance, etc.). Common Elements—Default: the data of common elements (text, assets) can be entered into any screen; the first time they are entered, the data becomes the default, and will appear in all screens. Common Elements—Override: in any screen, the user can change the value; this value will now be specific to this screen only. Common Elements—Change Default: in the case that a default has already been defined and the user wants to change it, the CGT will supply a button “Set Default”; when the user presses the button, all screens which did not specifically define a value will display the values from the present screen as a default.

Common Parameters: there are parameters which are defined at the Task level. Some of these parameters relate to the Task itself (navigation mode, screen transition) and some relate to the Atoms (attempts, check mode), and are defined in the Task for consistency (to ensure that all screens are the same) or convenience (so that the user will not have to define the same things over and over again). There may be logic controlled by the Task or LO (such as transferring data from one Atom to another, or flow based on student assessment).

For the Common Parameters, the CGT may define an area (tab, popup) where the user can define the values of these parameters. If any parameters have defaults, they will be displayed on entry to the screen the first time in the LO. Common Parameters—Override: If the parameter is actually an Atom parameter, and was defined in the Task for convenience only (and not for consistency), the parameter exists also in the parameter tab for each Atom, and can be overridden there.

CGT may supply an Undo button to undo the last change, or more than last change (e.g., a list of changes). CGT may supply a “Redo” button to redo the last undo (or multiple last undo actions).

CGT may include saving, for example, a Save button and a Save As button. When pressed: Validation will be performed; User will be prompted to enter a name, and then confirm; the system will automatically provide a unique id for the LO. Auto-Save: CGT will periodically automatically save the LO, in pre-defined time intervals.

In some embodiments, DD implementation of the CGT may be used.

Opening and LO Selection: upon starting CGT, a new undefined LO is displayed. For choosing an Existing LO: the user can (at any stage) request the opening of an existing LO. If relevant, CGT will request confirmation of loss of data from the current LO. If confirmed, or no confirmation needed, the requested LO will be displayed. Searching for LOs may be supported.

The opening screen is opened when CGT is started, or a new instance is started. The screen is empty, except for displaying the elements that are defined at the level of the container (messages, buttons). New Screen: The user requests to open a new screen, in the same instance; a new, empty screen is opened; previously defined screens maintain their present state, and the user can return to them. Changing Screens: the user can navigate between the defined screens. Deleting Screens: the present screen can be deleted by pressing the “Delete Screen” button; CGT will request confirmation before deleting.

Atom Template Selection may be the first step in CG. Once the template is selected, a form will be displayed, to enable entering of the data of the template. The definition of more than one template on a screen may be implemented similarly. Select template: the CGT displays a pull down menu from which the user can choose a template; after the template is selected, CGT will open a form to enter P&D. Change template: the CGT displays a pull down menu from which the user can choose a different template; changing a template causes loss of all data entered; the tool will warn about this and request confirmation before continuing; after confirmation, CGT will open a form to enter P&D. Atom Selection: as an option to selecting a template, the user can browse in the CGT repository and select an Atom that has been saved; if the Atom has only been partially defined, definition will continue from the point that it was stopped at.

Layout Selection: after choosing a template, the user chooses a Layout, on the P&D form. The tool interfaces to LCT; and using the LCT interface, the user chooses a layout. Pressing OK in CGT will cause the following actions to occur: (a) the interface with LCT will be closed; (b) the name of the layout and its picture will be displayed on the P&D form.

Matching Between Content and Layout: in some embodiments, certain parts of content (particularly parameters) may be defined in the layout, which is part of presentation. This can cause the following results: (a) The type of a question (image, text, etc.) is not the same in the content and the layout; (b) The content defines more answers than the layout knows how to display. CGT may thus coordinate Content and Layout: upon choosing a Layout, the CGT may: (a) check if there are any discrepancies between the layout and content already entered; (b) if there are discrepancies, CGT will warn (with a list of the discrepancies); (c) if the user confirms, the layout will be loaded; (d) in any case, CGT will update the form to reflect the definitions in the layout. Some of these steps may be performed, (a) if the user changed the layout after entering data; or (b) to allow the user to select the layout after defining some or all of the data.

Content Feeding may include two parts: Data—includes things like text, images, movies, sounds, etc.; and Parameters—this is data that controls behavior of the template, such as number of attempts. Both data and parameters may be entered on the same form.

For Template Data, each field knows the type of data that it expects, and will behave accordingly. When entering Text Data, the user will type in the text directly, or use copy-paste. When entering Asset Data, the user will be able browse the file system of the defined repository to choose assets; the user may not enter assets that are not in the repository; if an asset catalog exists, CGT will interface with it. There may be Limitations on Assets: for example, each field which receives an asset has a definition of what type of asset can be entered; the CGT will enforce this definition, and give the proper warning if the user tries to enter an illegal asset. If a tool for asset requisition is present, the CGT will interface with it (alternatively, the user may fill out form to request a new asset).

Template Parameters modify the behavior of the atom. All parameters of the chosen template will be available to the user to enter. There are various attributes of the parameters, which are defined in the template along with the parameters. CGT will relate as follows: A parameter can be mandatory or optional. A parameter may have a default value. The value of a parameter may affect: (a) Other parameters (Possibly making the other parameter relevant or irrelevant; Possibly changing the legal values for the parameter); (b) Data fields (Possibly making the field relevant or irrelevant; Possibly changing the legal values for the field). For Mandatory Fields, the CGT will mark the mandatory parameter fields. CGT will display the default value (for parameters that have a default) at the opening of the parameter screen. If no default value exists, but this template has been used previously in the LO, the previous value will appear when opening the parameter screen. For Parameter Dependencies, the CGT will enable/disable or hide/show parameters according to the dependencies between them. For Parameter Value Dependencies, the CGT will erase or replace parameter values that have become illegal due to the dependency. For Data Field Dependencies, the CGT will enable/disable or hide/show data fields according to the dependencies on parameters. For Data Value Dependencies, the CGT will erase or replace data values that have become illegal due to the dependency. A warning will show what has changed due to the change in the parameter. CGT may allow Redo on Parameters and Fields; for example, CGT will save the present state of parameters/data before the change; and if the user returns the parameter to the previous value, CGT will reset the changed values.

Some templates (such as Live Text) have utilities which are used to define data. If a template has a utility to define data, CGT will be able to use the utility, and then store the data with the rest of the LO.

In some embodiments, the CGT may support multiple Atoms on Screen. For example, when adding an atom, field for X and Y coordinates for the placement of atom(s) may be used; and sequence order field may be used to indicate the sequence order of an atom (e.g., using a numeric value). In some embodiments, the main atom may not be deleted, but only changed (the entire screen may be deleted); and the main atom also may not be “placed”.

In some embodiments, Atom Sequence is the order the atoms are displayed on the screen, in the case that progressive exposure is defined. In some embodiments, any number of Atoms can be displayed at the start (namely, an Exposure-ID parameter having a value of zero; or other, similar, type of Sequence-ID). After that, only one Atom may be exposed at a time. Therefore, CGT may check that no two atoms can have the same sequence number, unless the number is zero. In other embodiments, the CGT may allow two atoms to have the same Sequence-ID value, and they will be displayed or exposed together or substantially simultaneously.

For Common Data, there may be fields common to all screens which are under the control of the Task/Container (messages, feedbacks, guidance, etc.). Some of these can be overridden per atom/screen, but others may not. In addition, there may be data on the level of the entire LO. Data of common elements (text, assets) which relate to the LO, can be entered into one P&D form for the entire LO. In some embodiments, with regard to Common Elements of Atom which cannot be overridden, elements which relate to the Atom, but must be defined the same for all the Atoms, may appear only on the LO P&D form (no override). With regard to Common Elements of Atom which can be overridden (by a specific atom), such elements will appear on all of the P&D forms of all the atoms and will not appear on the LO P&D form. In some embodiments, some portions of data and/or parameters and/or settings may be hard-coded, or may be set such that they may not be overridden or modified; in other embodiments, some or all of the data and/or parameters and/or settings may be overridden or modified, for example, by a user of a certain type, or by a user having certain authorizations, or after requesting additional confirmation from the user (e.g., after presenting a warning notification), or if one or more conditions are met.

In some embodiments, CGT may support multilingual data, in metadata and all text fields. CGT may include a Spell Checker to perform spell checking on metadata and all text fields. CGT may include an XML Viewer, such that the user will be able to view XML files; for example, the XML files used in packaging, or internal XML files utilized by the CGT. In some embodiments, CGT may be server based, and may allow remote access from outside of the physical location of the server.

CGT may perform Validation on Preview/Play and Save. For example, upon a request to save or preview the LO, the CGT may perform validation. The actions for preview and save may differ, since a user may want to save in the middle of the definition. For example: (a) Validation that all assets of the template(s) are defined in the LO (for DD, this includes the layout); if fails in Preview/Play, then, preview/play if the user confirms (but for DD, if layout is missing, do not preview/play); if fails in Save, then warn, and save if the user confirms. (b) Validation that all defined assets are found in the repository (for DD, this includes the layout); if fails in Preview/Play, then warn, and preview/play if the user confirms (but for DD, if layout is missing, do not preview/play); if fails in Save, then warn, and save if the user confirms. (c) Validation that all mandatory parameters have been entered; if fails on Preview/Play, then warn, and preview/play if the user confirms; if fails on Save, then warn, and save if the user confirms. (d) Validation of consistency between types in the data and types in the layout (e.g., may not be needed in PD, since content was entered according to the layout); if fails in Preview/Play, then warn, and do not perform preview/play; if fails on Save, then warn, and save if the user confirms

In preview mode, CGT displays a screen with all its elements. The definition of how to display may differ between PD and DD. For Enter/Exit of Preview Mode, a toggle button on CGT may allow the user to change to Preview mode and back; in DD the form will be replaced by the preview. In some embodiments, validation of the present screen may be performed on Entering Preview Mode. When navigating from screen to screen in Preview Mode, the first time that a screen is entered, validation will be performed (e.g., first time in this session of preview; if the user toggles out of preview mode and then returns, validation will be done again). In some embodiments, Content Feeding may be disabled: during Preview Mode, P&D may not be entered or changed.

In the PD implementation, the preview is always there, since the user enters content directly onto the screen. The preview may include removal of graphical indications (such as symbols that indicate the order in progressive exposure), if these are defined, to make the screen look more like its real view.

The user will be able to play the instance; the instance will behave as if it were being played under the LMS, with all the logic that was defined. To enter Play Mode, a toggle button on CGT will enable user to play the instance from start to finish. Play will be done in a separate window. During play, CGT will be disabled, except for the toggle button to end the play. The CGT may validate on Entering Play Mode; the validation will be performed on all atoms/screens. Play mode may be terminated by un-toggling the button. If the play window can be exited using Operating System controls (e.g., closing the play window), then CGT will receive an event to un-toggle the button and enable itself (the CGT).

During CG, the user will be shown the mapping of the LO by screens. For example, in a section of the CGT, the user will see the screens as they have been defined up to now. CGT may display the LO Table Of Content (TOC) by Screens, and the templates (and assets) per each screen.

For compatibility purposes, any LO or Atom created by CGT will be available for reuse or editing: In any future version of CGT; On any future version of the template; On any change in layout or Presentation concept (such as Dynamic Layout); On any change in Task hierarchy.

For flexible addition of new capabilities, CGT may be implemented in such that adding or changing of: Templates, Layouts or Presentation concept (such as Dynamic Layout), or Scenario capabilities of the LO, will be easy to implement, and preferably will not necessitate re-testing of the entire tool.

The CGE, or the system in which the CGE is implemented, may include Access Control module(s). The actions which can be performed by a user may be limited depending on the user's role. For example: Pedagogues and Techno-Pedagogues can add and edit LOs; an LO can be changed only by its creator (or someone who belongs to the same discipline); Curriculum creators can only package; The LO can be viewed by any guest user; the LO can be published only by a user having “Publisher” Role; the LO can be edited by a teacher that was granted “LO Editor” Role; or the like.

Different stages in the process may require also specific roles. A work flow may be defined to support the production flow. From the time of its creation, an LO will always be at one point of the workflow. User can search for LOs by its state in the workflow.

Some embodiments may support Collaborative work in CG. In some embodiments, if an LO is opened by a user who has editing permissions, CGT will disallow another user with editing rights to also open the LO (or it will be opened as Read-Only, or only enable Save-As).

CGT may include a Statistical Reporting module, able to generate and publish statistical reports (some of which are based on the Metadata) on LOs, such as: type of templates used by LO or Discipline or Age-Group.

For storing of elements, all elements created in the CGT can be stored for use (package it for the LMS) or reuse (use as the base for a new element), whether completed (for use, reuse) or not completed (save work for tomorrow or later). The user can save an element only at the level of LO. Saving an LO saves all its children (e.g., Atoms). Saved Atoms can be retrieved independently of the parent LO. For the 1st time save is done to an LO (or during Save As), the CGT will allocate a unique ID for the LO being saved. The name of the LO is entered by the user on Save. The CGT will assign names to the children Atoms according to a pre-defined naming scheme, for example: <LO_Name>_screenNumber_numberInScreen. Metadata may be defined for any LO or Atom. The metadata may be saved with the element, and may be used for retrieval. In some embodiments, CGT may support Task Storing (Task has a hierarchal structure; some embodiments may support only a Task (Container) that has as its children all the atoms).

For element layers, the information in an LO can be divided into three parts: Content—the data and parameters; Presentation—where elements are place and how they appear; Flow—the logic of playing the LO. In some embodiments, the content is saved when the LO is saved. In some embodiments, it may be possible to save “templates” of presentation and flow, for subsequent reuse. For Presentation, the Layout is used; Layouts may not necessarily be created in CGT and therefore CGT may not save them for reuse; although the opposite may apply for Dynamic Layouts. As for Flow, what can be defined as flow (e.g., progressive exposure) may not necessarily require the ability to be saved as a template of flows, although other implementations may support saving and re-using a template of a flow (e.g., progressive exposure).

In some embodiments, the user may search and open an LO, or an Atom, according to their respective metadata. In some embodiments, the user may search for an LO based on a workflow state of the LO.

The user can request that an LO will be packaged in the format that is needed for insertion into the LMS. The place where the packaged LO is stored may be defined, A failure in validation may give a warning and abort the packaging. CGT may support other packing formats to allow export of content. Some embodiments may support import of external LOs; in some embodiments, they may be imported directly to the curriculum, or to the CGT for further editing.

In some embodiments, “TE” may indicate a Template Editor. “Content Item” may be a generic name for all entities that are being used as part of the studying experience: Segment, D/LA, AI, Task, and Atom; a CI can be reused. Content Items may have a Pedagogical Scheme that divides them into four main schemes. “Metadata” may include information about the template, designed to be used in various cases such as search or for gathering pedagogical or technical information before using the template. “Guidance” may indicate all prior data the student needs to work with the template. “Interaction” may indicate the main area of interaction between the student & the assignment; for example, students are presented with an activity in which they have to write or select a correct answer or answers, match objects, sort groups etc. “Feedback/Advancing” may indicate adaptive feedback based upon student achievements, advancing to next study phase adaptively—upon achievements, output of data to higher level CI or to an assessment/situations “machine”. “Checkable Templates” may include templates in which a checking mechanism exists and students are provided with a generic or adaptive feedback. “Tabs” (e.g., four tabs) may be used for various UI modules. “INF” may indicate an instruction and feedback window.

In some embodiments of CGT, a Questions and Answers (Q&A) template and a Game template (which, for example, may have been previously fed by a manual XML feeding process), may be adapted to a feeding generation tool. For example, Open Question; Completion Question; Matching Question; Multiple Choice; Memory Game; or the like. The process of transformation may include: (a) Breakdown of the current XML feeding components and mapping them according to the pedagogical scheme. (b) Assignment of the XML feeding components into functional (pedagogical) modules under one of the four pedagogical schemes. (c) Making a decision on whether the XML feeding component should be translated into a UI component and appear in the CGT feeding form, or should not be visible to the user. In the latter case, the functionality of the XML feeding component should be embedded into the UI behavior and the systems logic. The pedagogical rational should serve as a key factor in this process. It is noted that XML is utilized in the discussion herein for demonstrative purposes only; and other suitable modeling language or structures may be used, for example, to represent a description of a content item (as well as its objects, properties, and/or behavior) through a script; in some embodiments, a proprietary learning modeling language may be used, to describe the flow of content elements.

The pedagogical scheme of Metadata, Guidance, and Feedback/Advancing applies for all templates with some variation as dictated by the template type. The scheme applies for both the LO and the atom level. Nonetheless, small variation may occur between templates. These differences are manifested particularly in the Interaction scheme and in the Feedback & Advancing scheme. Moreover, Q&A templates may differ markedly from Game templates and each possesses unique functional modules.

In addition to the four pedagogical schemes tabs found in both the LO and the atom level, a fifth tab used for layout selection may be available at the atom level. Additional templates may be adapted to the CGT environment. Moreover, during the development process of new templates, not only the functional requirements of the template should be taken into consideration, but also the design of the templates content generation editor.

Some embodiments may include a CG-oriented TE, which utilizes a CG approach of clean forms: the feeding form may be simple, intuitive, and CG oriented. Table elements: many feeding parameters and components belong to the same pedagogical module and thus may be grouped together and appear in the same area in the form. The content generator acts in module-minded manner and should not be required to search and locate the feeding components.

Break down of complex states and relations: When a user comes across states that may compromise the simplicity of the workflow, the user may pinpoint the complicating factors and try to handle the complication by means of breaking down the overcomplicated process or even dissect the template to different template versions. In addition, the user may avoid states in which many dependencies are embedded into the editor

Visually flat forms: The feeding process requires the user to navigate between the tabs and therefore in most cases, the user will be able to find all the feeding form components in one level at each tab. However, certain functionalities may require an advanced mode of the form. For example, in the Matching Question, the users define advanced feedback rules in a popup window that allows them to select a combination of rules and rule components.

Adhere to simple and reusable modules: many Q&A templates share similar components such as questions, feedbacks and so forth. The user may identify such repetitive modules and reuse them in different template editors.

Quality assurance—introduce mechanisms to avoid mistakes such as predefined selection options and validation functions. For example in the Matching question, the users may be unable to write the answer numbers in the answer to target field. The users can select the answers within a popup window and the relevant answer per target will be presented as read only information in the relevant field.

In some embodiments, each TE may have a correlating configuration table that allows a flexibility of adding new parameters and list values with time. The user may try to adhere to look and feel of the current template editors and use GUI and UI elements that are common in the CGT. The user may avoid over dynamic states. Although the forms may be dynamic since, there is no need to overbear the user with unnecessary information.

Layouts related to each template that are designated to be CGT dependent may be built in such a way that modules each element to a specific feeding context. This method enables the CGT to “read” the layout and modify the feeding form according to the layouts determinants, and to functionally correlate elements that have a certain link such as answers fields and their correlating sound buttons. In addition, by hovering over the feeding field the user is able to locate its exact location in the layout, which is an ability that serves as a benefit to the CG process.

As for sound objects or narration: Another concept introduced in the CGT is the separation of sound elements (that are key elements in the layout and task, such as an audio type question), and audio files that accompany a textual or graphical object thus behaving like narration.

For functional modules, the CG approach may map each parameter and feeding component into a functional module. These modules are not just a collection of semi related parameters, but serve as distinct pedagogical modules, for example, question zone, parameters zone. In addition, the careful design of modules enables the reusability of elements between templates. Although they may appear as isolated UI components, these modules may be interconnected in the pedagogical perspective as well as in terms of the Ul behavior and the systems logic. In such cases, parameter settings in one module may affect the element content and state of the parameters in another module. In some cases, the relation between these modules may intercross between schemes and tabs. For example in the Matching Question, if the user selected activity type “Sorting”, then a set generating feature will appear in the Interaction tab; yet if the user selected activity type “Sequence”, then a sequence specific feedback table will appear in the Feedback and Advancing tab.

The metadata relates to information about the template, designed to be used for various purposes, such as, searching, or gathering pedagogical or technical information, before using the template. In some embodiments, the Metadata also incorporates functional parameters. The metadata may include two main modules: (a) LMS Metadata, e.g., functional aspects of the template such as the interface language; (b) CGT Metadata, e.g., information relevant to the atom in the context of the CGT, for example status and work stage. The Metadata may be common to both Q&A templates and Games. In the course of the TE design, authentic metadata and functional/parameters may be separated. Moreover, it may be possible to exclude functional parameters from the metadata tab.

The guidance pedagogical scheme relates to any prior data required in order to facilitate the student to work with the template. In other cases, the data may be exposed during the activity. There are several differences between the Instruction scheme of Q&A templates and of Game templates.

Q&A templates Guidance: There are three main modules in the Instruction scheme of Q&A templates, for example: Instruction; Clue & Help settings; Settings that relate only to Checkable templates. Both the Instructions module that relates to the INF, and the Clue Help settings, are common to checkable as well as for non-checkable templates. Another module relates to the progress in checkable templates.

Game templates Guidance: There are three main modules in the Instruction scheme of Game templates, for example: Instructions; Game Instruction and Game Help; Game difficulty levels. The instruction module is similar to that of Q&A templates and is part of the INF. Exclusive to game templates are the game instructions and game help modules, which are template dependent. For example, in the Memory game, students can click on a graphic object found in the screen that will provide them information for performing the interaction. In addition, a game template may include a module for game difficulty levels settings.

The interaction scheme relates to the main interface between the student & the assignment. The students are presented with an activity in which they have to write or select a correct answer or answers, match objects, sort groups or complete any other type of task according to the template. The functional modules of the interaction scheme may markedly differ between templates. Nevertheless, there are several key modules that we have identified that repeat one way or the other in the interaction scheme of the various templates.

For example, in the Q&A templates Interaction, one of the main modules of the interaction is the question. The question or questions are content-related guidance elements that are required for the intellectual action of the student. Not all assignments require a question. For example, the layout may dictate whether the CGT interaction form will display a question table. Although questions may not appear in the entire layout collection found in the system (based on the planned pedagogical assignment), when they do appear, the Question table will look substantially the same in all of the Q&A templates. Each question table may support more than one type of questions, e.g., question type Sound, question type Text and question type Image may all appear in a single table.

Similarly, for the Answers module, checkable templates may require a module that allows the content creator to define what the correct answers are and which are the distracters. The UI of this module may differ based on the template.

Some embodiments may utilize general parameters and/or template-specific parameters settings. Certain parameters that affect the interaction may be common to several templates; for example, the number of attempts in checkable templates. Some embodiments may identify these parameters and set them apart from template-specific parameters.

In a demonstrative Game templates Interaction, the memory game resembles to some extent the Matching question template. Nonetheless, there are certain distinctive features that differentiate the Q&A from the Games interaction scheme. In the game interaction scheme, we identified three main modules: Game settings, which resemble the template specific setting of the Q&A; Game objects, which resemble the answer bank and the targets of the Matching Question; and the game preview module that serves the unique requirements of the game templates.

In the game settings module, the content generator adjusts various game related parameters; such as, the use of timer, and the score for correct and for incorrect outcome. This module resembles the template specific parameters, yet they control more game related aspects.

Game objects: The main activity in the Game template involves an action of the student on Game objects that can take any graphic form, such as, clouds or cards that the student must match or select. Unlike a possible state in the Q&A template, where the number of questions, answers, targets and so forth are limited by the layout, most games are more permissive in that aspect. Although a minimal number of game objects is usually a prerequisite (and should be enforced by the UI and validation), the content generator may add additional game objects without any robust limitations, thus an “add object” tool may be used.

In some games, the game objects may be exposed to the student as one extended “shot” with many frames; and therefore, in order to preview all the game objects, one has to “play” all the frames of the game one after the other. A benefit to the content generator is the ability of the CGT to preview the associated game object(s), such as matching card pairs, without the need to play the entire scenario.

In the Q&A templates, the Feedback & Advancing scheme applies to parameters that dictate the flow of events within or between atoms. In addition, this scheme offers various options for generic as well as advanced feedbacks in checkable templates.

Atom-advancing settings determine the mode of advancing in-between atoms, and may appear in both checkable and non-checkable templates. In checkable templates, these settings may also determine the checking mode.

Some embodiments may include a feedback bank, a Feedback table, and advanced feedback rule wizard. In checkable templates, the students receive a response from system that correlates to their performance. In generic feedbacks, each feedback scenario of a checkable template is constituted of distinct and repetitive elements. The repetitive elements may be, for example, “all correct” or “all incorrect”. These elements may appear in the Completion template, Multiple Choice question, and in the Matching question. Therefore, a demonstrative feedback table that covers these elements may be used in all three template editors

Feedback bank: Generic feedback content may repeat in various cases, allowing to create a feedback bank. In such cases, the user may select an appropriate feedback to be presented in the feedback table. These feedbacks may be common to all three templates.

Non-generic feedbacks may include, for example: (a) Parameter driven: certain elements that constitute the template feedback scenario may depend on certain parameter(s), such as the “check button availability timing” in the Matching Question, that when set to “after one object is matched” dictates the presence of the “Part Right” element in the feedback table. (b) Groups: Certain elements are depending on functionalities such a partial answers group. For instance, in the completion question, each partial answer may be associated with a specific feedback. In such case, the feedback table may have additional rows correlating to the feedback of each group. (c) Specific rules for feedback.

A more advanced form of feedbacks may require the content generator to assign a feedback for a specific answer, or to determine what specific conditions or events will evoke the feedback. In such case, the system may provide the user with a popup window that allows creation of advanced feedback rules.

Game templates Feedback & Advancing: for example, in the Memory game, the Feedback and Advancing allows the content generator to set generic progress and feedback parameters. In other Game templates, the use of this tab may be expanded

The following two tables (denoted Table 1 and Table 2) demonstrate pedagogical schemes and the related modules, according to the type of template. Table 1 corresponds to a Q&A template; whereas Table 2 corresponds to a Game template.

TABLE 1

| Pedagogical | Function/Pedagogical | |
|---|---|---|
| Scheme | Module | Example |
| Metadata | System Metadata | Interface Language |
| | CGT Metadata | Status, Stage |
| Guidance | Q&A instructions | Instruction Text |
| | Q&A Clue and Help settings | Help URL address |
| | Q&A Checkable templates | Check button text |
| | only settings | |
| Interaction | Question | Question Text |
| | General settings | Number of attempts |
| | Template specific settings | Duplicate Answers in |
| | | Matching question |
| | Q&A answers and distracters | Answer text field |
| Feedback & | Atom advancing for checkable/ | Check mode, Continue |
| Advancing | non-checkable templates | Button text |
| | Q&A-Feedback bank | List of generic scenarios |
| | Q&A-Feedback table | Feedback text for non last |
| | | attempt |
| | Q&A-Advanced feedback | Specific feedback name |
| | rule wizard | |

TABLE 2

| Pedagogical | Function/Pedagogical | |
|---|---|---|
| Scheme | Scheme | Example |
| Metadata | System Metadata | Interface Language |
| | CGT Metadata | Status, Stage |
| Guidance | Instruction (similar to | Instruction Text |
| | Q&A instruction) | |
| | Game Instruction & Help | Text which appears when the |
| | | student clicks the Game Help |
| | | Icon “?” |
| | Game difficulty level | “Medium” |
| Interaction | Game Settings | Timer, points for correct answer |
| | Preview of game objects | Preview of pairs in the memory |
| | | game |
| | Game objects | Game Cards |
| Feedback & | Feedback & Advancing | Game Over feedbacks |
| Advancing | settings | |

Some embodiments may include dynamic layouts able to provide automatic flexible layout presentation adapted to changing data. For example, a Screen may include one or more Atoms; an Atom may include one or more Regions; a Region may include one or more Assets. A screen may include one or more elements of a wrapping interface, for example, located in the margins above and below the Atom. The dynamic layout may automatically change content data element or characteristics (such as font size, number of possible answers to a question); dynamic placement of Regions or Atoms (re-size or re-locate) and dynamic screen arrangement (such as resizing according to preset relative sizes of elements, presenting under rules of gradual appearance).

The Screen may be the whole display, containing at least one Atom wrapped inside Wrapping Interface presentation. The Atom may be a graphic presentation for a basic system atom. The Atom deals in the arrangement and style treatment of elements (content) on a region. Atom may contain regions (zones): at least one region, and up to five (or other number of) regions.

A Region inside Atom is a logic zone which contains a set of external properties to describe layout behaviors. For example, a Region may be a question region with order arrangement of right to left and object behavior for drop area. Assets may be UI element with external properties to describe the content (data) entity. The properties contain skin presentation and configuration for behavior.

A Static Asset is a type of content which can be display only in static size. The same asset may be produced with different sizes, and may be displayed other than in its default size, but may keep its proportion (for example, a JPEG image, or a bitmap-type image or applet). In contrast, a Flexible Asset—Type of content which can be flexible in the display, for example, by implementing 9-slice scaling structure. The asset refers to the possibility of scaling the asset proportion without distorting it (e.g., a Shockwave SWF applet, or a vector-based applet or image). An Asset Type may indicate the Type of content (e.g., Text, Sound).

The Wrapping Interface may include a layout entity, built up from static exhibited units (e.g., Navigation bar, INF). The Wrapping Interface may contain from one single exhibited unit to all kinds of units, and may display above, under and/or sides of the atom layout. The interface is wrapping the atom layout, and assembles the screen layout.

The Reference Resolution may be a base point for layout arrangement on the display; represented by an accessible parameter in the system configuration (e.g., default value of 1024 by 768 pixels).

Some embodiments may lay out objects according to predefined rules on screen; allowing presentation behaviors for data objects, and layout arrangement on screen. Some embodiments may support any existing layouts and assets with fixed location of elements, including new unique layouts with fixed location. Some embodiments may utilize different requirements for Screen layout, Atom layout, Region layout, and Assets.

Some benefits of the dynamic layouts may include, for example: reduce the number of layouts in the system; increase throughput and allow for scalability; reduce template production efforts; minimize the repetitive work; free GUI and CF resources for other tasks; capability to handle changes in a display size or in resolution.

Screen layout may be able to contain at least one atom, and may be able to contain all kinds of wrapping interface layouts with the atom layout. Screen layout may include the following definitions by an external parameters: Number of atom's in the screen; Units of wrapping interface to display; Wrapping Interface sizes and locations; Atom's size or proportion (e.g., one-third of the screen); Atoms Locations; Alignments of the Atoms; Indications for scrolling (fix real-estate or scroll). The Wrapping Interface is always part of the screen and is calculated in the screen real-estate. The size of Wrapping Interface may be calculated as zero (e.g., if no exhibited units to display). The Wrapping Interface may be able to move proportionality with screen ranges (increase and decrease). The number of atoms on screen may be validating, in case no scroll is defined, to fit the real-estate guidelines (for example, validation may include writing error messages into log). The Screen layout will be in relative location and not absolute location, in order to support changes in size or resolution.

Atom Layout may contain at least one region and up to (for example) five regions. Every region will be able to present its behavior on the atom layout. Assets are represented in Atom screen in mediation of a region. Atom will be able to automatically arrange regions, for example: Proportional arrangement as a default behavior; Fixed location due to unique request; Validate fixed location request (validation In this stage: write error message into log). The atom layout may include the following definitions through external parameters: Number of regions in the atom; Region's fixed or relative location; Region's size or proportion. Atom layout may contain external properties that will describe it. The properties may contain skin presentation and unique configuration for behaviors. Some embodiments may include flexibility in a quantity of skins in the screen, which can be replaced by specific region configuration. Regions may be overlapping inside atom layout. In some embodiments, there is no internal padding between zones (e.g., similar to HTML). Some embodiments may utilize Spacing between zones created from the internal spacing definitions of the objects from the zone ends. Some embodiments may isolate in schemas between layout, data and skin for Atom layout.

Region layout may include the following definitions through external parameters: Type (e.g., Question; Answer; Explanation); Minimum and Maximum size; Visibility. The GUI guideline may define grid of elements for each region, and the grid may include the following definitions: Reference points; Alignments; Minimum and Maximum distance between elements; Padding for the area. Assets may be arranged automatically in a vertical method inside region due to external parameter by maximal use of the region. Assets may be arranged automatically in a horizontal method inside region due to external parameter by maximal use of the region. Upon the above, Assets may be arranged by maximal use in the region area due to external predefined parameters, for example: Ability to increase or decrease the size of the present assets; Ability to increase or decrease the proportion of the present assets; Ability to arrange present assets with addition line/column; Ability to add scroll to a region in order to contain objects. Assets from all types may be presented in a region automatically in a vertical or horizontal method. Region layout may be able to display automatically combination of completely different assets in a vertical or horizontal method, or by fixed location due to external properties. Flexibility may be allowed in a quantity of assets in the region. The GUI guideline may describe maximum value for assets. The assets may be arranged in a region according to external fixed pre-defined location points for other unique requirements such as: a-symmetric; circle; regular positioning (manual, not automatic). Upon the above, every request for all kind of unique shapes (assets) shall be presented according to external pre-defined location points (e.g., Fixed objects location). Region layout may be able to display static assets. Region layout may be able to arrange static assets by maximal use of the region. The GUI guidelines may define different behavior for every region; behavior examples may be: store zone, give information zone, field of goals. The Region layout may include external predefined properties that will describe it. The properties may contain skin presentation and unique configuration for behavior. Flexibility may be provided in a quantity of skins in the region.

An asset may contain different types of content, for example: Text; Text and Sound; Sound; Images; Video; Animation; or the like. Every type of data may be defined and may be visual according to the following properties: Shape; Size; Styling; Skin; Is Visual. An asset may be able to behave due to external parameters, for example: Ability to change size on different actions such on-mouse; for Asset of type Text, ability to change content on different actions (such on-mouse Text color will change to Blue); Asset of type Picture may change size in different states; Asset of type Picture may be able to become transparent while dragging; Asset of type Text may be able to change style parameters (CSS), such as size, color, bold; Asset of type Text may be able to change alignment, location and direction; Asset of type Text may be able to change fonts and punctuating (e.g., in Hebrew) between text and Images; Asset of type Text may be able to read text with a CSS API; an Asset may be able to replace its content due to specific action (change Feedback, change Image). An Asset may be able to contain different states (e.g., static and interactive). Detailing States may include, for example, Dragged Elements and Pushed Elements (e.g., Buttons, Radio Buttons, Check Box, and Toggle Buttons). The change of state for an asset may be able to take place with transition; for example, increasing the size from 0 to 100 may be able to allow capability to stop at 30. Asset states transition may be able to play music, to change markers and other animation abilities. Asset may be able to change skins to other suitable UI graphics. In this case, changing size or proportion for asset may be due to external parameter; the default value for this parameter is no changing size and no proportion. In some embodiments, changing of asset's skin allows to change the size but does not change proportions (e.g., changing a text arranged within a rectangle having a proportion of 2 by 3, into a text arranged within an oval cloud having also a proportion of 2 by 3).

Some embodiments may allow efficient changing of screen size or resolution. For example, the following are external parameters for the system in order to use reference resolution: Current resolution; Indication for scrolling. Screen layout may be flexible to support different sizes of screens with larger size or resolution then the reference. Examples for the various sizes: system standard; student dependent; teacher dependent; classroom dependent; or the like. Change in a relative size of screen layout (increase or decrease) may not change layout proportion. Screen layout will be able to change real-estate when scrolling permits. In case the change (relative size) is for increase, then spacing between objects may increase in order to allow more assets. The GUI guideline may provide behavior cases table to change real-estate. An asset may contain flexibility in size and proportion while changing screen size or resolution: Flexible Assets may respond accordingly to change in size or resolution. As for Static Assets, in case that there are assets in different sizes in a repository: Region layout may be able to replace and display the suitable asset size in order to keep proportion according to the increase or decrease in size or resolution. In case that there is only default size for asset: Region layout may only change the proportion to the asset according to increase size/resolution.

For Backward Capabilities, the dynamic layout solution may not require exchange of old layouts, or other migration process. Layouts that needs migration may be handled by automatic increase of screen resolution of the layout, which will centralize the layout and only the background will increase.

In some embodiments, Dynamic Layouts may be implemented as follows: a template may be created, for example, a template of Multiple Choice questions. Optionally, for every type of question, one or more patterns may be mapped. The Template may be stored in a template repository, or in a templates and layouts repository. The user may select from such repository a template, and also a layout, according to the pattern that the user wishes to follow or utilize. Data and Parameters may be entered to match the template (e.g., three textual questions, six textual answers, one image, one animation, or the like). Optionally, the user may keep the default layout associated with the template; or may customize or modify the layout (e.g., by re-arranging elements within the asset container, using drag-and-drop operations, resize operations, or the like). Other suitable operations may be used.

In some embodiments, the system templates may be implemented as a techno-pedagogical engine. This engine is an application based upon pedagogical requirements and is meant to allow the student to achieve desired levels of proficiency in different skills and curriculum materials. The engine allows the pedagogical content developer to develop differential content according to students' unique level and needs. The content is then embedded into this engine and provides the student with user friendly learning interface. The templates can process various types of content and present it in various ways, using different visual layouts for the same template.

For example, the Multiple Choice Template can be used to present a textual question with four textual answers, or, using a different layout, it can be used to preset a question based upon a visual image combined with sound, and six other images as possible answers. All of the templates are provided within a unique container with advanced navigation abilities. The container also provides each template with the Instructions and Feedback module. This module provides a differential set of instructions, feedbacks and even hints for the student, as he/she studies, using each of the templates.

The Geoboard Template may be is an open workspace which encourages the student to do constructive problem solving. This is a powerful geometric template which contains four areas. The first one is the Work Grid: on this grid the student can manipulate different objects, draw lines and polygons, write text, measure objects and much more. The grid can also contain a background image or even a background animation in order to provide the student with the necessary contextual environment for significant and motivational learning. The second area is the Toolbox, which contains different tools that can be used by the student such as drawing tools, coloring tools, measurement tools, text box, mathematical expressions tool and others. The third area is a Foldable Objects Repository (Bank), which contains different visual objects for the student to place on the grid. The forth area is the External Atoms Zone. In this zone the student receives different work directions, answers different questions regarding his conclusions and more. The “atoms”, which contain the question and the directions, are gradually exposed to the student as he/she progresses with the work.

The Multi Fraction Template provides the student with up to four simulations of different visual representations of mathematical fractions. The student can zoom in into any specific representation, manipulate it and view the equivalent numeric representation. While working with this applet, the student receives different questions and directions in an area alongside the applet. The student can use the applet as a reflective tool to check his/her answers and thoughts before answering and receiving feedback for each question.

The Place Value Chart Template may be a way of organizing numbers (whole numbers and decimals) in an interactive chart. The chart will include multiple representations of the number. The applet enables the student to learn the place value of numbers (up to 10 digits) in various representations (whole number, breaking into digits, verbal etc). The applet's focus is on the following four subjects: (a) Additive property: the quantity represented by the whole numeral is the sum of the values represented by the individual digits; (b) Positional property: the quantities represented by the individual digits are determined by the positions that they hold in the whole numeral; (c) Base-ten property: the values of the positions increase in powers of ten from right to left; (d) Multiplicative property: the value of an individual digit is found by multiplying the face value of the digit by the value assigned to its position. This applet has a unique automatic mode in which the student provides one representation of the number and the chart automatically generates all other representations of the same number, including verbal and vocal representations.

The Number Line Template may be an interactive representation of a line in which the numbers are shown in specially marked points evenly spaced on a line. The numbers can be integers, regular fractions or decimals. It is used as an aid for teaching math. The number line is a tool which helps in the conceptual understanding of the world of numbers and operations. The tool has many advanced features: it allows the student to compare distances using interactive “jumping” figures, and the student can create his own number line, add notes to estimate the numbers and even answer checkable questions and receive feedback by dragging and dropping objects into the number line.

The Fraction Bar Template may allow the student to compare between up to five fractions. The template allows understanding of visual comparison. The template also provides a “Curtain” tool, which allows the student to try and estimate the difference between the fractions, prior to viewing the visual representation. This applet can be used as an aid tool for other templates, and in that way provide the student with a mind tool for his/her studies.

The Multiplication Applet Template may be a tool that helps the student to understand the meaning of the multiplication operation. The student will be able to visually see and model a multiplication exercise or a given situation or problem using different models. He will be able to compare the formal and visual representations of a multiplication math exercise.

The Cloze Template provides the student with the ability to fill fields that are scattered throughout a given text. The cloze also supports usage of mathematical word problems or of solving mathematical equations; as the empty fields can be checked for mathematical correctness according to specific conditions. The cloze can contain various objects both in the text itself and in the bank: images, sounds, words or mathematical expressions. The objects in the bank can be used once or duplicated, and the student can either drag and drop the object or write by himself inside the fields. The cloze provides differential and sensitive feedbacks, and provides unique feedback to partially-right answers (e.g., the student might have a spelling mistake but used the correct root of the word). The textual feedback is also adaptive and changes according to the percentage of total correct answers in the text.

The Performance Task Template may be a final task where the students are able to show what they have learned, and may be a culminating event of the unit. The task is based on the standards taught in the unit and is assessed with a rubric. Constructivist in nature, the Performance Task allows each individual student to demonstrate her highest level of achievement. This template provides the student with an open creative environment. The student may be required to create a visual project according to the goals and definitions of the lesson. The project might be a postcard, a newspaper, a letter or even a creative thinking skills project to create the student's own invention. The student is provided with a bank of visual, audio and textual objects. The student can drag the objects and drop them in specific designated locations. The student is also required to describe her work using free writing. The projects are then sent to the public gallery by the students and presented for classroom discussion by the teacher.

The Sorter Template allows an open (non checkable) sorting activity of different objects: words, sentences, math objects, images, sounds, letters and combinations. The students can sort the same objects in multiple ways (categories), and present their sorting decisions to the class by sending their sorter to the public gallery. The Sorter can be loaded with pre-determined given examples including: given objects in groups, given number of groups and categories, given group and/or category names. When sorting textual objects the students can also create their own new words and add them to the sorting.

The Live Text Template may be a constructive open textual workspace which gives the student a high level of interaction with written texts. The template consists of a scrollable text box with very advanced tools and capabilities. The student can highlight different parts of the text, such as letters, words, sentences or paragraphs—all in an intuitive way. The student can answer multiple choice questions within the text. This is done by clicking on the parts of the text which then function as possible answers. The student can also drag words or visual objects into the text from a bank. The student can drag words from the text into matching questions located alongside the text, and more. For all of these interactions, the student receives a global textual feedback, a local visual feedback, and a local feedback within the text (e.g., highlighting of one or more words or paragraphs or sentences). This helps the student to focus on the relevant part of the text necessary to answer the question. This template also provides advanced capabilities, such as “Hot Word”: when the student places the mouse upon a “hot” word, an expansion box is opened and provides the student with additional information regarding this specific word. This template also contains an advanced feature called “Linguistic Navigator”. This feature allows the teacher or the student to highlight and focus on different (predefined) parts of the text in the click of a button (e.g., the student clicks on “Emotions” and all of the words which indicate emotions will be highlighted within the text, such as, “happy”, “sad”, “anger”).

The Text Reader Template provides the student with an interactive text book. The student can read the text and flip the pages in the book. When necessary, the text can be narrated (e.g., using a text-to-speech engine or module) and each part of the text being narrated will be highlighted. This allows the students to improve their abilities to focus and understand the text.

The Puzzle Game Template may require the student to organize parts into their right order or place. The order can be determined by: visual information or definition of categories. For example, in a demonstrative puzzle related to math, the following table, denoted Table 3, may be presented to the student:

TABLE 3

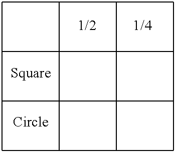

Next to the table, four graphic elements may be shown: (a) a half-filled circle; (b) a half-filled square; (c) a quarter-filled circle; (d) a quarter-filled square. The student may need to drag-and-drop each one of the four graphic elements, into its respective cell in the table.

The Memory Game Template may require the student to match pairs of cards (according to pre-defined criteria) based on memory. The type of matching is pre-defined for the whole game, and can include any combination between: texts, sounds and images. The game lets the student select a difficulty level (out of three possible levels), and measures the student's score (e.g., accuracy, number of attempts) and performance time.

The Matching Game Template may require the student to help a Knight to cross bridges on his way to the castle. In order to cross each bridge, the student needs to put in the bridge a series of stones, which are represented by cards matching the same criteria. The cards may contain texts, images or sounds. Upon failure the Knight falls from the bridge into the water and the student needs to try again. Upon success the Knight crosses the bridge and keeps progressing towards the castle. For example, the game may show to the student a prompt of two cards, “Happy” and “Sad”; and the student may need to find a matching relation (e.g., of two opposites), among a series of ten cards (e.g., “dog”, “banana”, “flower”, “cold”, hot”, “school”, or the like; where “cold” and “hot” are the required opposites).

The “Who I Am” Game Template may require the student to eliminate items by specific rules, and/or to select items by specific rules. A fortune teller is challenging the student to discover what item she is thinking of. At each stage she reveals a clue. The student eliminates all items that do not follow the rule. Each stage ends with the right answer (made by the student or presented by the computer). The game ends when the last item is left (the one that fits all the rules). For example, at first, the student is shown nine cards with numbers on them; and with the prompt “I am an even number”; the student has to eliminate odd numbers, or to keep only the even numbers, from those shown to him. The the student is shown the next clue, such as, “I am greater than six”, and again the student has to eliminate specific numbers or has to keep specific numbers; and so forth, until reaching a single number on the screen.

The Word search Game Template may be a game in which the goal is to find words within a bundle of letters. Game parameters can be set to match the student's level of proficiency. The content developer feeder controls the number of letters and words to search. The content developer may also control whether the words to search for will appear as visual/audio hints, or as fully spelled words.

The Spelling/Hangman Game Template may require the student to guess and spell a series of six words or phrases. After each correctly spelled word, a part of an image is built. Once successfully completing six consecutively correctly spelled words, the image is complete. For each word the student sees a set of empty letter spaces and must guess the word, based on a set of configured hints which can be in the image, voice or written form.

The Basic Atom Template may be the most basic and fundamental system template. It allows the presentation of different information types (Text, Images, Videos, Sounds, Graphs and Interactive animation), combined with instructions for the student.

The Multiple Choice (MTC)—Template asks a question and presents multiple answers. There might be one or more correct answer. Both the question and the answers can be provided in various representations and media: sound, text, image, animation and any combination thereof. In addition, every textual question or answer is usually provided with an optional sound button, which allows the student to hear a narration of the text. The structure of the screen, the size of the question and answers fields and the amount of possible answers are flexible and modifiable.

The Open Question Template may enhance free writing. The student is required to type text in a given field. The text is not checkable and is sent to the teacher for personal assessment. The text can be in various contexts and representations such as: notebook, comics, newspaper, etc.

The Matching Question Template provides the student with a bank of objects, which can contain text, images or sounds. The student is required to drag the objects from the bank and drop them in the correct places provided on the screen. This can be used for completing texts, arranging objects by order, completing a graphical representation, etc. The bank object can be duplicated or reduced (to make it easier for some students). When the student checks his/her answer, he/she is provided with a visual feedback for every object on the screen, while every object which was placed incorrectly returns to the bank. This allows the student to correct his/her mistake. In some embodiments, for example, the student may be required to drag phrases into a “cause” and a corresponding “effect” targets. For example, the student may need to drag the phrase “The girl was sad” and to drop it into an “effect” target, located next to a pre-written “cause” which indicates that “The balloon flew away”.

The Movie Menu Template provides the student with an interactive interface which allows him/her to play different movie clips of the lesson subjects. The student can select which movie to view and in a click of a button to switch to a different one.

The Math Editor Component can be used and embedded in various system templates (e.g., Cloze, Number Line, and others). The component provides the student with a user-friendly virtual keyboard for writing mathematical expressions. This component may also validate the correctness of the written number.

The Graphic Organizer Template is a tool that can be used by the student to represent information visually. The tool can be used for open assignments, such as creating a family tree or more didactic activities, such as representing cause and effect clauses based on a given text. The tool consists of a toolbar which the student can use to create and manage graphic objects such as basic shapes, lines and text. The tool's main area is a canvas on which the student can manipulate (add, resize, rotate, move, color etc.) the graphic objects. In addition, there is a bank from which the student can drag images placed by the content developer. The initial state of the graphic organizer can be set by the content developer; this enables the activities to be context driven and adaptive to the required level of difficulty.

The Random Exposure Template may be an interface for providing the student with pseudo-random data, generated from pre-defined textual/numerical bank. The student is provided with buttons in the middle of the screen. When the student presses each of the buttons, the button vanishes and the text behind the button revealed. This template encourages free writing, based upon randomly generated textual topics.

Other suitable templates may be used.

The terms “plurality” or “a plurality” as used herein include, for example, “multiple” or “two or more”. For example, “a plurality of items” includes two or more items.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device (e.g., BlackBerry (RTM), Palm (RTM) Treo (TM)), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), Global Positioning System (GPS), IEEE 802.11 (“Wi-Fi”), IEEE 802.16 (“Wi-Max”), ZigBee (TM), Ultra-Wideband (UWB), Global System for Mobile communication (GSM), 2G, 2.5G, 3G, Third Generation Partnership Project (3GPP), 3GPP Long Term Evolution (LTE), 3.5G, or the like. Some embodiments may be used in conjunction with various other devices, systems and/or networks.

The terms “wireless device”, “wireless computing device”, “mobile device” or “mobile computing device” as used herein include, for example, a device capable of wireless communication, a communication device or communication station capable of wireless communication, a desktop computer capable of wireless communication, a mobile phone, a cellular phone, a laptop or notebook computer capable of wireless communication, a PDA capable of wireless communication, a handheld device capable of wireless communication, a portable or non-portable device capable of wireless communication, or the like.

The terms “file”, “digital file”, “object”, or “digital object” include, for example, a digital item which is the subject of transferring or copying between a first device and a second device; a software application; a computer file; an executable file; an installable file or software application; a set of files; an archive of one or more files; an audio file (e.g., representing music, a song, or an audio album); a video file or audio/video file (e.g., representing a movie or a movie clip); an image file; a photograph file; a set of image or photograph files; a compressed or encoded file; a computer game; a computer application; a utility application; a data file (e.g., a word processing file, a spreadsheet, or a presentation); a multimedia file; an electronic book (e-book); a combination or set of multiple types of digital items; or the like.

The terms “social network”, “virtual social network”, or “VSN” as used herein include, for example, a virtual community; an online community; a community or assembly of online representations corresponding to users of computing devices; a community or assembly of virtual representations corresponding to users of computing devices; a community or assembly of virtual entities (e.g., avatars, usernames, nicknames, or the like) corresponding to users of computing devices; a web-site or a set of web-pages or web-based applications that correspond to a virtual community; a set or assembly of user pages, personal pages, and/or user profiles; web-sites or services similar to “Facebook”, “MySpace”, “Linkedln”, or the like.

In some embodiments, a virtual social network includes at least two users; in other embodiments, a virtual social network includes at least three users. In some embodiments, a virtual social network includes at least one “one-to-many” communication channels or links. In some embodiments, a virtual social network includes at least one communication channel or link that is not a point-to-point communication channel or link. In some embodiments, a virtual social network includes at least one communication channel or link that is not a “one-to-one” communication channel or link.

The terms “social network services” or “virtual social network services” as used herein include, for example, one or more services which may be provided to members or users of a social network, e.g., through the Internet, through wired or wireless communication, through electronic devices, through wireless devices, through a web-site, through a stand-alone application, through a web browser application, or the like. In some embodiments, social network services may include, for example, online chat activities; textual chat; voice chat; video chat; Instant Messaging (IM); non-instant messaging (e.g., in which messages are accumulated into an “inbox” of a recipient user); sharing of photographs and videos; file sharing; writing into a “blog” or forum system; reading from a “blog” or forum system; discussion groups; electronic mail (email); folksonomy activities (e.g., tagging, collaborative tagging, social classification, social tagging, social indexing); forums; message boards; or the like.

The terms “web” or “Web” as used herein includes, for example, the World Wide Web; a global communication system of interlinked and/or hypertext documents, files, web-sites and/or web-pages accessible through the Internet or through a global communication network; including text, images, videos, multimedia components, hyperlinks, or other content.

The term “user” as used herein includes, for example, a person or entity that owns a computing device or a wireless device; a person or entity that operates or utilizes a computing device or a wireless device; or a person or entity that is otherwise associated with a computing device or a wireless device.

In some embodiments, some or all of the components described herein may be enclosed in a common housing or packaging, and are interconnected or operably associated using one or more wired or wireless links. In other embodiments, components may be distributed among multiple or separate devices or locations.

Some embodiments may include, for example, a desktop computer, a laptop computer, a notebook computer, a tablet computer, a PDA device, a cellular phone, a mobile phone, a hybrid device (e.g., combining one or more cellular phone functionalities with one or more PDA device functionalities), a portable audio player, a portable video player, a portable audio/video player, a portable media player, a portable device having a touch-screen, a relatively small computing device, a non-desktop computer or computing device, a portable device, a handheld device, a “Carry Small Live Large” (CSLL) device, an Ultra Mobile Device (UMD), an Ultra Mobile PC (UMPC), a Mobile Internet Device (MID), a Consumer Electronic (CE) device, an “Origami” device or computing device, a device that supports Dynamically Composable Computing (DCC), a context-aware device, or the like.

Some embodiments may include non-mobile computing devices or peripherals, for example, a desktop computer, a Personal Computer (PC), a server computer, a printer, a laser printer, an inkjet printer, a color printer, a stereo system, an audio system, a video playback system, a DVD playback system a television system, a television set-top box, a television “cable box”, a television converter box, a digital jukebox, a digital Disk Jockey (DJ) system or console, a media player system, a home theater or home cinema system, or the like.

Some embodiments may utilize client/server architecture, publisher/subscriber architecture, fully centralized architecture, partially centralized architecture, fully distributed architecture, partially distributed architecture, scalable Peer to Peer (P2P) architecture, or other suitable architectures or combinations thereof.

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk—Read-Only Memory (CD-ROM), Compact Disk—Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A method of generating digital educational content, the method comprising:
(a) creating a digital learning object by:
receiving user selection of a template from a repository of templates of digital learning objects, the template representing a composition of one or more digital educational content elements within a screen;
receiving user selection of a layout from a repository of layouts of digital learning objects, the layout representing an on-screen arrangement of said one or more educational content elements within said screen;
receiving user input of data for said template;
receiving user input of parameters for said template;
inserting the user input of data into said template;
inserting the user input of parameters into said template;
receiving user input of meta-data for said template;
(b) applying said layout to said template containing therein (i) said user input of data and (ii) said user input of parameters and (iii) said user input of meta-data;
(c) storing said digital learning object in a repository of digital learning objects.

2. The method of claim 1, wherein receiving the user selection of the template comprises:
receiving the user selection of the template from a group comprising at least (a) a first template having a single atomic digital educational content element, and (b) a second template having two or more atomic digital educational content elements.

3. The method of claim 1, wherein inserting the user input of data comprises one or more operations selected from the group consisting of:
producing instructions for the digital educational content;
producing questions for the digital educational content;
producing possible answers for the digital educational content;
producing written feedback options with regard to correctness or incorrectness of the possible answers, for the digital educational content;
producing rubrics for assessment for the digital educational content;
producing a hint for solving the digital educational content;
producing an example helpful for solving the digital educational content;
producing a file helpful for solving the digital educational content;
producing a hyperlink helpful for solving the digital educational content;
providing a media file associated with the digital educational content;
providing an alternative modality for at least a portion of the digital educational content;
importing an instance of an under-development digital educational content from an in-work storage unit;
importing an instance of a published digital educational content from a storage unit for published content.

4. The method of claim 3, wherein the producing comprises performing an operation selected from the group consisting of:
writing;
copying;
pointing to an item in an assets repository.

5. The method of claim 1, wherein inserting the user input of parameters comprises one or more operations selected from the group consisting of:
producing metadata parameters;
producing pedagogic metadata parameters;
producing guidance parameters;
producing interactions parameters;
producing feedback parameters;
producing advancing parameters;
producing a parameter indicating a required student input as condition to advancing;
producing scoring parameters;
producing one or more rules for behavior of content elements on screen;
producing one or more rules indicating a behavior of a first on-screen content element in upon a user's interaction with a second on-screen content element;
producing parameters for a managerial component indicating one or more rules of handling a communication between two on-screen content elements.

6. The method of claim 1, wherein receiving the user selection of the layout comprises:
receiving the user selection of the layout from a group comprising at least: (a) a first layout in which two or more atomic digital educational content elements are arranged in a first arrangement; and (b) a second layout in which said two or more atomic digital educational content elements are arranged in a second, different, arrangement

7. The method of claim 1, further comprising:
modifying said layout in response to a user drag-and-drop input which moves one or more atomic digital educational content elements within said screen, to create a modified layout; and
applying the modified layout to said template.

8. The method of claim 1, further comprising:
modifying said template in response to a user input which adds an atomic digital educational content element into said screen, to create a modified template.

9. The method of claim 8, wherein said user input which adds said atomic digital educational content element into said screen comprises a user selection of a new atomic digital educational content element from a repository of atomic digital educational content elements available for adding into said template.

10. The method of claim 1, further comprising:
modifying said layout in response to a user input which resizes one or more atomic digital educational content elements within said screen, to create a modified layout; and
applying the modified layout to said template.

11. The method of claim 1, comprising:
setting one or more rules indicating an operational effect of a first on-screen content element on a second, different, on-screen content element.

12. The method of claim 1, comprising:
setting one or more rules indicating an operational effect of a user interaction on one or more content elements.

13. A computerized system for generation of digital educational content,
wherein the computerized system implemented using at least one hardware component,
wherein the computerized system comprises:
a template selection module to select a template for the digital educational content;
a layout selection module to select a layout for the digital educational content;
an asset selection module to select one or more digital atomic content items from a repository of digital atomic content items;
an editor module to edit a script, represented using a learning modeling language, the script indicating behavior of a first on-screen content element in response to one or more of: (a) user interaction; (b) action by a second on-screen content element.

14. The computerized system of claim 13, further comprising:
an asset organizer module to spatially organize one or more of the selected digital atomic content items.

15. The computerized system of claim 14, wherein the asset organizer module is to automatically (a) resize one or more of the selected digital atomic content items based on screen resolutions constraints, and (b) reorder one or more of the selected digital atomic content items based on pedagogical goals reflected in metadata associated with said one or more of the selected digital atomic content items.

16. The computerized system of claim 13, comprising:
a gradual exposure module to (a) initially expose on screen the first content element, and (b) subsequently expose on screen the second content element, based on a sequencing scheme associated with said first and second content elements.

17. The computerized system of claim 13, comprising:
a knowledge estimator to determine an educational need of a student, based on one or more of: (a) responses of the student in a pre-administered test; (b) a personal knowledge map which is associated with said student and is updated based on ongoing performance of said student;
an automated content builder to automatically create educational content tailored for said student, based on output of the knowledge estimator, by utilizing an automatically-selected template, an automatically-selected layout, educational data and parameters obtained from an assets repository.

18. The computerized system of claim 13, comprising:
a wizard module (a) to guide a content developer step-by-step through a process of creating educational content, (b) to show to said content developer only selectable options which are relevant in view of pedagogical goals and rules, and (c) to hide from said content developer options which are irrelevant in view of pedagogical goals and rules.

19. The computerized system of claim 18, wherein the pedagogical goals and rules are represented as metadata associated with education content items.

20. The computerized system of claim 13, comprising:
a flow control editor to define pedagogic rules for determining the behavior of an educational content element upon creation of a digital learning object based on a pedagogical need of a student.

21. The computerized system of claim 13, comprising:
a tagging module to create pedagogical metadata associated with educational content items; and
an asset retrieval module (a) to retrieve content elements from an assets repository; and (b) to place the retrieved content elements in a learning flow based on pedagogical meta-data, wherein the pedagogical metadata (i) indicates relevancy of said retrieved content elements to a pedagogical goal, and (ii) indicates suitability of said retrieved content elements to a pedagogical context.

22. The computerized system of claim 13, comprising:
a dynamic layout modifier module (a) to determine that a digital learning object was originally intended to be executed on a first screen having a first resolution; (b) to determine that the digital learning object is requested to be executed on a second screen having a second, smaller, resolution; (c) to re-construct the digital learning object by re-organizing educational content elements according to (i) the second resolution and (ii) one or more pedagogical rules for determining interactive behavior of one or more of the educational content elements.
